(19) United States
(12) Patent Application Publication
(10) Pub. No.: US 2026/0280289 A1
(43) Pub. Date: Sep. 17, 2026

(54) ELECTRICAL WIRING DEVICES, AND CIRCUITS AND SYSTEMS FOR AND METHODS OF IMPLEMENTING ELECTRICAL WIRING DEVICES

(71) Applicant: White Birch Solutions LLC, Wheaton, IL (US)

(72) Inventor: John Joseph King, Wheaton, IL (US)

(73) Assignee: White Birch Solutions LLC, Wheaton, IL (US)

(21) Appl. No.: 19/560,279

(22) Filed: Mar. 9, 2026

Related U.S. Application Data
(60) Provisional application No. 63/772,058, filed on Mar. 14, 2025.
(60) Provisional application No. 63/791,006, filed on Apr. 18, 2025.
(60) Provisional application No. 63/830,968, filed on Jun. 26, 2025.
(60) Provisional application No. 63/892,143, filed on Oct. 2, 2025.

(51) Int. Cl. H02J 3/007; H01H 9/54; H01R 13/70; H02G 3/08; H02J 13/10; H02J 13/34; H02J 105/12; H02J 105/40; H05B 47/135

(52) U.S. Cl. CPC H02J 3/007; H01H 9/54; H01R 13/70; H02G 3/083; H02J 13/10; H02J 13/34; H05B 47/135; H02J 2105/12; H02J 2105/40

(57) ABSTRACT

An electrical wiring device adapted to receive an input power signal and generate an output power signal is described. The electrical wiring device may comprise a base portion adapted to generate a DC signal for providing power to a load; and a signal adapter removably attached to the base portion; wherein the electrical wiring device is adapted to control the application of DC power to the load.

### TECHNICAL FIELD

An embodiment of the present invention relates generally to electrical wiring devices, and methods of implementing electrical wiring devices and signal adapters.

### BACKGROUND

Switches which control the application of power to a load, such as a light or a fan, are an important part of any residential or commercial building and can provide beneficial control of a load attached to the switch, such as timing control, motion detection, and dimming for example. As switches and outlets (commonly referred to receptacles) continue to advance, additional functionality may be available to a homeowner. However, replacing a switch or a receptacle can come with significant time and expense. For many homeowners who attempt to replace a switch or receptacle rather than have an electrician replace the switch or receptacle, the replacement may be time consuming or expensive, and the switch or receptacle may be improperly installed.

In the case of new construction, a purchaser of a home, or a builder in the case of a home that is built without input from a purchaser of the home, may not know where the different types of switches and receptacles should be initially placed. Further, it may not be until after living in the home for a period of time that a homeowner may have a better idea where certain types of switches and receptacles should be placed. The homeowner would then have to change some switches or receptacles and therefore incur additional time and effort, or additional time and expense if the homeowner relies upon an electrician, to change the devices. Homeowners may not appreciate the additional cost and time to make improvements to a home that they may have already invested considerable money and time in planning during the construction process. There may be additional costs of implementing certain types of switches.

Accordingly, circuits, devices, arrangements and methods that enable a user such as a homeowner or other building owner to easily and efficiently implement different switches and receptacles are beneficial.

### SUMMARY

An electrical wiring device having a base portion and a signal adapter, wherein the electrical wiring device is adapted to control the application of DC power to a lighting element.

### SUMMARY

An electrical wiring device adapted to receive an input power signal and generate an output power signal is described. The electrical wiring device may comprise a base portion adapted to generate a DC signal for providing power to a load; and a signal adapter removably attached to the base portion; wherein the electrical wiring device is adapted to control the application of DC power to the load.

Another electrical wiring device adapted to receive an input power signal and generate an output power signal may comprise a base portion comprises an outlet for receiving prongs of a plug; a signal adapter removably attached to the base portion; and an electrical interface for communication of AC signals and DC signals between the base portion and the signal adapter.

A method of implementing an electrical wiring device adapted to receive an input power signal and generate an output power signal is also described. The method may comprise generating, by a base portion, a DC signal for providing power to a load; receiving a signal adapter that is removably attached to the base portion; and controlling the application of DC power to the load.

### BRIEF DESCRIPTION OF THE DRAWINGS

FIG. 1 is a block diagram of a system 100 for implementing electrical wiring devices using one or both of both AC and DC currents.

FIG. 2 is another block diagram of a system for implementing electrical wiring devices using both AC current and DC current and providing AC to DC conversion devices that are mountable within a junction box.

FIG. 3 is another block diagram of a system for implementing electrical wiring devices using both AC current and DC current and providing AC to DC conversion in an electrical wiring device having a receptacle.

FIG. 4 is another block diagram of a system for implementing electrical wiring devices using both AC current and DC current and providing AC to DC conversion in an electrical wiring device having a switch.

FIG. 5 is another block diagram of a system for implementing electrical wiring devices using both AC current and DC current and providing AC to DC conversion in an electrical wiring device having a switch.

FIG. 6 is another block diagram of a system for implementing electrical wiring devices using both AC current and DC current providing AC to DC conversion in some of the electrical wiring devices having a switch.

FIG. 7 a flow chart showing a method of minimizing wiring requirements.

FIG. 8 is a left-side perspective view of an AC/DC converter device adapted to be attached to a junction box.

FIG. 9 is a right-side perspective view of an AC/DC converter device adapted to be attached to a junction box.

FIG. 10 is a block diagram of the AC/DC converter device of FIGS. 8 and 9.

FIG. 11 is a bottom left-side perspective view of an AC/DC converter device adapted having a DC input block.

FIG. 12 is a block diagram of the AC/DC converter device of FIG. 11.

FIG. 13 is a flow chart showing a method of implementing an AC/DC converter device.

FIG. 14 is a block diagram of the AC/DC converter device of FIG. 11 showing additional user interface elements.

FIG. 15 is another block diagram of the AC/DC converter device of FIG. 11 showing additional details of the AC/DC converter circuit.

FIG. 16 is another block diagram of the AC/DC converter device of FIG. 11 showing selectable AC/DC converter circuits.

FIG. 17 is a perspective view of an AC/DC converter device having a user interface comprising user selectable switches.

FIG. 18 is a perspective view of an AC/DC converter device having a user interface comprising a touchscreen user interface.

FIG. 19 is a flowchart showing a method of implementing an AC/DC converter device having a constant current circuit and a constant voltage circuit.

FIG. 20 is a left-side perspective view of an AC/DC converter device comprising a wireless communication circuit and a user interface adapted to be located behind a wall plate.

FIG. 21 is a left-side perspective view of an AC/DC converter device comprising a wireless communication circuit and a user interface adapted to extend through an opening of a wall plate.

FIG. 22 is a left-side perspective view of an AC/DC converter device comprising a switching element and a user interface adapted to extend through an opening of a wall plate.

FIG. 23 is a left-side perspective view of the AC/DC converter device of FIG. 20 having a movable cover.

FIG. 24 is a block diagram of an AC/DC converter device having a user interface.

FIG. 25 is a flow chart showing a method of implementing an AC/DC converter device having a user interface.

FIG. 26 is a left-side perspective view of a base portion adapted to receive signal adapter.

FIG. 27 is a right-side perspective view of a base portion adapted to receive signal adapter.

FIG. 28 is a right-side and bottom perspective view of a signal adapter configured to be electrically and mechanically coupled to the base portion.

FIG. 29 is a right-side and top perspective view of a signal adapter configured to be electrically and mechanically coupled to the base portion.

FIG. 30 is a left-side and top perspective view of a signal adapter configured to be electrically and mechanically coupled to the base portion.

FIG. 31 is a top perspective view of a signal adapter configured to be electrically and mechanically coupled to a base portion.

FIG. 32 is a cross-sectional view of a signal adapter electrically and mechanically coupled to a base portion.

FIG. 33 is a first cross-sectional view of a base and a signal adapter including the alignment of openings of a tamper resistance element with openings of a rear wall of the base.

FIG. 34 is a second cross-sectional view of a base and a signal adapter including the alignment of openings of a tamper resistance element with openings of a rear wall of the base.

FIG. 35 is a third cross-sectional view of a base and a signal adapter including the alignment of openings of a tamper resistance element with openings of a rear wall of the base.

FIG. 36 is a left-side perspective view of another base portion adapted to receive signal adapter.

FIG. 37 is a left-side and top perspective view of another signal adapter configured to be electrically and mechanically coupled to the base portion.

FIG. 38 is a block diagram of a base portion of an electrical wiring device having a plurality of AC and DC input connectors and DC output connectors.

FIG. 39 is a left-side perspective view of a base portion of an electrical wiring device having an electrical interface adapted to receive DC signals and a region for receiving a signal adapter.

FIG. 40 is a left-side perspective view of a base portion of an electrical wiring device having a signal adapter.

FIG. 41 is a block diagram of a signal adapter configured to be received by a base portion having an electrical interface adapted to receive DC signals.

FIG. 42 is a block diagram of an electrical wiring device having the base portion of FIG. 40 and the signal adapter of FIG. 41.

FIG. 43 is a flow chart showing a method of implementing an electrical wiring device having a base portion and a signal adapter.

FIG. 44 is a block diagram of a base portion of an electrical wiring device adapted to receive a signal adapter according to a full partition arrangement.

FIG. 45 is a block diagram of a base portion of an electrical wiring device adapted to receive a signal adapter according to a partial partition arrangement.

FIG. 46 is a top perspective view of a signal adapter configured to be implemented with a base portion and having an actuator adapted to engage a tamper resistant element and electrical connectors for AC and DC signals.

FIG. 47 is a cross-sectional view of a signal adapter attached to a base portion.

FIG. 48 is a block diagram of a base portion of an electrical wiring device having a region for receiving a signal adapter.

FIG. 49 is a block diagram of signal adapter adapted to be electrically coupled to a base portion of an electrical wiring device.

FIG. 50 is a block diagram of an electrical wiring device having the base portion of FIG. 48 and the signal adapter of FIG. 49.

FIG. 51 is a flow chart showing a method of implementing a base portion and a signal adapter electrically attached to the base portion.

FIG. 52 is a left-side perspective view of an electrical wiring device having a switching function.

FIG. 53 is a left-side perspective view of a detachable actuator element adapted to be coupled to the electrical wiring device of FIG. 52.

FIG. 54 is a left-side perspective view of the electrical wiring device of FIG. 52 having the detachable actuator element of FIG. 53.

FIG. 55 is a left-side perspective view of an electrical wiring device having a switching function.

FIG. 56 is a left-side perspective view of a detachable actuator element adapted to be coupled to the electrical wiring device of FIG. 55.

FIG. 57 is a left-side perspective view of the electrical wiring device of FIG. 56 having the detachable actuator element of FIG. 56.

FIG. 58 is a block diagram of an electrical wiring device having a mechanical switching function.

FIG. 59 is a block diagram of an electrical wiring device having an electrical switching function.

FIG. 60 is a flow chart showing a method of controlling AC and DC power to loads.

FIG. 61 is a left-side perspective view of a base of an electrical wiring device having a receptacle.

FIG. 62 is a right-side perspective view of a base of an electrical wiring device having a receptacle.

FIG. 63 is a left-side perspective view showing a front surface of a signal adapter.

FIG. 64 is a perspective view showing a rear surface of the signal adapter of FIG. 63.

FIG. 65 is a cross-sectional view showing the base portion of FIG. 61 of the electrical wiring device having the signal adapter of FIG. 63 taken at lines 65-65.

FIG. 66 is a cross-sectional view showing the base portion of FIG. 61 of the electrical wiring device having the signal adapter of FIG. 63 taken at lines 66-66.

FIG. 67 is a cross-sectional view showing the base portion of FIG. 61 taken at lines 67-67.

FIG. 68 is a cross-sectional view showing the base portion of FIG. 61 of the electrical wiring device having the signal adapter of FIG. 63 taken at lines 67-67.

FIG. 69 is another cross-sectional view showing the base portion of FIG. 61 taken at lines 69-69.

FIG. 70 is another cross-sectional view showing the base portion of FIG. 61 of the electrical wiring device having the signal adapter of FIG. 63 taken at lines 67-67.

FIG. 71 is a circuit diagram of a base portion of an electrical wiring device adapted to receive a signal adapter.

FIG. 72 is a circuit diagram of a signal adapter adapted to be electrically coupled to a base portion of an electrical wiring device.

FIG. 73 is a circuit diagram of a signal adapter adapted to be electrically coupled to a base portion of an electrical wiring device and having a switching operation for a receptacle of the signal adapter.

FIG. 74 is a circuit diagram of a signal adapter adapted to be electrically coupled to a base portion of an electrical wiring device and having user interface and input/output functions.

FIG. 75 is a circuit diagram of a signal adapter adapted to be electrically coupled to a base portion of an electrical wiring device and having a switching operation for a receptacle of the signal adapter and user interface and input/output functions.

FIG. 76 is a flow chart showing a method of implementing a electrical wiring device comprising a base having a receptacle and adapted to receive a signal adapter.

FIG. 77 is a circuit diagram of a base portion of an electrical wiring device adapted to receive a signal adapter and having an output port adapted to route a DC voltage signal to another electrical wiring device.

FIG. 78 is a circuit diagram of a signal adapter adapted to route a DC output signal to the output port of a base portion of the electrical wiring device.

FIG. 79 is a circuit diagram of a signal adapter adapted to route a DC output signal to the output port of a base portion of the electrical wiring device.

FIG. 80 is a circuit diagram of a signal adapter adapted to route a DC output signal to the output port of a base portion of the electrical wiring device and control an AC signal routed to an out.

FIG. 81 is a circuit diagram of a base portion of an electrical wiring device having a receptacle and controlling the application of a DC output signal to a DC output port.

FIG. 82 is a flow chart showing a method of implementing an electrical wiring device comprising a base portion having a DC output port and a receptacle.

FIG. 83 is a block diagram of a base portion of an electrical wiring device having a receptacle and a fault control circuit.

FIG. 84 is a flow chart showing a method of implementing a base portion of an electrical wiring device having a receptacle and a fault control circuit.

FIG. 85 is a left-side perspective view of a base portion of a electrical wiring device based upon a full partition arrangement and adapted to receive a signal adapter.

FIG. 86 is a right-side perspective view of the base portion of the electrical wiring device of FIG. 86.

FIG. 87 is a left-side perspective view of a signal adapter configured to be attached to a base portion.

FIG. 88 is a left-side perspective of the base portion of FIG. 85 attached to the signal adapter of FIG. 87.

FIG. 89 is a block diagram of the base portion of the electrical wiring device of FIG. 85.

FIG. 90 is a block diagram of a signal adapter configured to be attached to the base portion of FIG. 89 and comprising a switching circuit adapted to route a DC input signal to a DC output port.

FIG. 91 is a block diagram of a signal adapter configured to be attached to the base portion of FIG. 89 and comprising a switching circuit, an input/output (I/O) port and user interface (UI) elements.

FIG. 92 is a block diagram of a signal adapter configured to be attached to the base portion of FIG. 89 and comprising a switching circuit adapted to route a DC input signal to a DC output port and a communication circuit.

FIG. 93 is a block diagram of a signal adapter configured to be attached to the base portion of FIG. 89 and comprising a switching circuit, a communication circuit, a user interface, and an I/O port.

FIG. 94 is a flow chart showing a method of implementing an electrical wiring device adapted to receive a signal adapter in a full partition arrangement.

FIG. 95 is a right-side perspective view of an electrical wiring device having a switch actuator and adapted to receive a signal adapter in a partial partition arrangement.

FIG. 96 is a right-side perspective view of the electrical wiring device of FIG. 95.

FIG. 97 is a circuit diagram of a base portion of an electrical wiring device having a switch and adapted to operate without a signal adapter in a partial partition arrangement.

FIG. 98 is a block diagram of a signal adapter having a switching circuit for controlling the application of an output signal in response to a switching signal from a switch of a base portion of an electrical wiring device.

FIG. 99 is a block diagram of a signal adapter having a switching circuit and a signal control circuit and user interface for controlling the application of an output signal in response to a switching signal from a switch of a base portion of an electrical wiring device.

FIG. 100 is a block diagram of a signal adapter having a switching circuit and an input/output port for controlling the application of an output signal in response to a switching signal from a switch of a base portion of an electrical wiring device.

FIG. 101 is a block diagram of a signal adapter having a switching circuit and a communication circuit for controlling the application of an output signal in response to a switching signal from a switch of a base portion of an electrical wiring device.

FIG. 102 is a circuit diagram of base portion of an electrical wiring device having a switch and a signal adapter in a partial partition arrangement.

FIG. 103 is a flow chart showing a method of implementing an electrical wiring device having a base portion with a switch and a signal adapter for controlling the application of an output signal in response to a switching signal from a switch of a base portion of an electrical wiring device.

FIG. 104 is a circuit diagram of base portion of an electrical wiring device having a switch and adapted to receive a signal adapter in a partial partition arrangement.

FIG. 105 is a block diagram of a signal adapter having a switching circuit for controlling the application of an output signal in response to a switching signal from a switch of a base portion of an electrical wiring device.

FIG. 106 is a block diagram of a signal adapter having a switching circuit and a signal control circuit and user interface for controlling the application of an output signal in response to a switching signal from a switch of a base portion of an electrical wiring device.

FIG. 107 is a block diagram of a signal adapter having a switching circuit and an input/output port for controlling the application of an output signal in response to a switching signal from a switch of a base portion of an electrical wiring device.

FIG. 108 is a block diagram of a signal adapter having a switching circuit and a communication circuit for controlling the application of an output signal in response to a switching signal from a switch of a base portion of an electrical wiring device.

FIG. 109 is a circuit diagram of base portion of an electrical wiring device having a switch and adapted to receive a signal adapter in a partial partition arrangement.

FIG. 110 is a flow chart showing a method of implementing an electrical wiring device having a base portion with a switch and a signal adapter for controlling the application of an output signal in response to a switching signal from a switch of a base portion of an electrical wiring device.

FIG. 111 is a left-side perspective view of a base portion of an electrical wiring device adapted to receive a signal adapter and having a switch and switch actuator.

FIG. 112 is a right-side perspective view of the base portion of the electrical wiring device of FIG. 111.

FIG. 113 is a circuit diagram of the electrical wiring device of FIG. 111.

FIG. 114 is a block diagram of a signal adapter having an AC/DC adapter and a switching circuit for controlling the application of a DC output voltage signal.

FIG. 115 is a block diagram of a signal adapter of FIG. 115 having an input/output device.

FIG. 116 is a block diagram of a signal adapter of FIG. 115 having an input/output device and a user interface.

FIG. 117 is a block diagram of a signal adapter of FIG. 115 having an input/output device, a user interface and a communication circuit.

FIG. 118 is a flow chart showing a method of implementing a signal adapter an AC/DC adapter and a switching circuit for controlling the application of a DC output voltage signal.

FIG. 119 is a base portion of an electrical wiring device adapted to receive a signal adapter and having an actuator for engaging a switch.

FIG. 120 is a signal adapter adapted to be received by the base of FIG. 119.

FIG. 121 is a signal adapter adapted to be received by the base and comprising an actuator adapted engage the switch of the base portion of FIG. 119.

FIG. 122 is a flowchart showing a method of implementing the base portion of FIG. 119.

FIG. 123 is a left-side perspective view of an electrical wiring device.

FIG. 124 is a right-side perspective view of the electrical wiring device of FIG. 124.

FIG. 125 is a block diagram of the electrical wiring device of FIG. 123.

FIG. 126 is a flow chart showing a method of generating a DC output signal based upon an AC input signal received at an electrical wiring device.

FIG. 127 is a circuit diagram of a base portion of an electrical wiring device adapted to receive a signal adapter adapted to receive an AC signal and generate a DC signal.

FIG. 128 is a block diagram of a signal adapter adapted to be received by the base portion of an electrical wiring device.

FIG. 129 is a flow chart showing a method of implementing a signal adapter having an AC/DC converter circuit and an actuator for controlling the application of a DC output signal to an output of the electrical wiring device.

FIG. 130 is a block diagram of a base portion of an electrical wiring device having an AC/DC converter circuit.

FIG. 131 is a block diagram of a signal adapter adapted to be received by the base portion of the electrical wiring device of FIG. 130.

FIG. 132 is a flow chart showing a method of controlling the application of a DC signal applied to a load by a power adapted received by a base portion having an AC/DC converter circuit.

FIG. 133 is a system level diagram comprising a primary electrical wiring device coupled to control a load comprising a lighting element (LE) and a secondary wiring device adapted to communicate with the primary electrical wiring device over DC output signal lines of the primary electrical wiring device.

FIG. 134 is a flow chart showing a method of controlling the application of a DC signal to a load in response to a signal received over DC output signal lines.

FIG. 135 is a system level diagram comprising a primary electrical wiring device coupled to control a load and a secondary wiring device adapted to communicate with the primary electrical wiring device over a first set of DC output signal lines of the primary electrical wiring device and receive power over a second set of DC output signal lines.

FIG. 136 is a system level diagram comprising a primary electrical wiring device coupled to control a load and a remote electrical wiring device powered by a DC power signal and adapted to communicate with the primary electrical wiring device by way of a wireless communication signal and a remote device powered by a battery.

FIG. 137 is a flow chart showing a method of implementing an electrical wiring device adapted to communicate with one or more remote devices to control the application of DC power to a load.

FIG. 138 is a left-side perspective view of a base portion for receiving an DC/DC converter circuit or a signal adapter for switching a DC output signal to electrical connectors of a DC output and wireless signal transmission circuits.

FIG. 139 is a block diagram of a circuit implemented in a base portion of FIG. 138 having an AC/DC converter circuit and wireless signal transmission circuits.

FIG. 140 is a block diagram of a signal adapter adapted to be received by the base portion of FIG. 139 and wireless signal transmission circuits.

FIG. 141 is a flow chart showing a method of routing a DC signal received by a base portion and routed to a DC output.

FIG. 142 is a block diagram of an electrical circuit of a base portion having an electrical interface comprising contact elements adapted to transmit AC signals and wireless signal transmission circuits.

FIG. 143 is a block diagram of a signal adapter adapted to receive AC signals and wireless signal transmission circuits for receiving DC signals and to communicate with the base portion of FIG. 142.

FIG. 144 is a flow chart showing a method of implementing a base portion adapted to receive both AC signals and DC signals.

FIG. 145 is a block diagram of an electrical circuit of a base portion adapted to receive AC input signals and provide DC signals to a signal adapter by way of a wireless signal transmission circuit.

FIG. 146 is a flow chart showing a method of implementing a base portion that receives AC input signals and enables the transmission of power to a signal adapted by way of a wireless signal transmission circuit.

FIG. 147 is a perspective view of a base portion adapted to receive DC input signals and wireless signal transmission circuits for transmitting the DC input signals to a signal adapter.

FIG. 148 is a block diagram of a circuit for receiving DC input signals and wireless signal transmission circuits for transmitting the DC input signals to a signal adapter using wireless signal transmission circuits.

FIG. 149 is a block diagram of a signal adapter adapted to receive DC signals from a base portion using wireless signal transmission circuits and transmit DC signals and communication signals to electrical connectors of a base portion and configured to communicate with the circuit of FIG. 146.

FIG. 150 is a flow chart showing a method of receiving DC signals from a base portion using wireless signal transmission circuits and transmitting DC signals and communication signals to electrical connectors of a base portion.

FIG. 151 is a perspective view of a base portion of an electrical wiring device having an outlet and wireless signal transmission circuits for wireless signal communication between the electrical wiring device and a signal adapter and contact elements for routing AC signals.

FIG. 152 is a block diagram of a circuit for a base portion of an electrical wiring device having an outlet and wireless signal transmission circuits.

FIG. 153 is a block diagram of signal adapter having wireless signal transmission circuits and contact elements for receiving AC signals and adapted to be electrically coupled to the base portion of FIG. 151.

FIG. 154 is a flow chart showing a method of implementing a base portion of an electrical wiring device having an outlet and wireless signal transmission circuits.

FIG. 155 is a block diagram of a base portion of an electrical wiring device having an outlet and wireless signal transmission circuits for wireless signal communication between the electrical wiring device and a signal adapter.

FIG. 156 is a block diagram of an electrical circuit having wireless signal transmission circuits for transmitting signals to a signal adapter.

FIG. 157 is a block diagram of a signal adapter having wireless signal transmission circuits and adapted to be electrically coupled to the electrical circuit of the base portion of FIG. 156.

FIG. 158 is a flow chart showing a method of implementing an electrical wiring device having a base portion and a signal adapted configured to transmit wireless signals.

FIG. 159 is a perspective view of a base portion of an electrical wiring device adapted to receive a DC input signal and having a switch and wireless signal transmission circuits.

FIG. 160 is a block diagram of a circuit for implementing a base portion of an electrical wiring device adapted to receive a DC input signal and having a switch and wireless signal transmission circuits.

FIG. 161 is a block diagram of a signal adapter adapted to communicate DC signals using wireless signal transmission circuits and adapted to be coupled to the base portion of FIG. 159.

FIG. 162 is a flow chart showing a method of implementing a base portion of an electrical wiring device adapted to receive a DC input signal and having a switch and wireless signal transmission circuits.

FIG. 163 is a perspective view of a base portion of an electrical wiring device adapted to receive an AC signal and having a switch and wireless signal transmission circuits.

FIG. 164 is a block diagram of a circuit for implementing a base portion of an electrical wiring device adapted to receive an AC signal and having a switch and wireless signal transmission circuits.

FIG. 165 is a block diagram of a signal adapter adapted to receive an AC signal and having wireless signal transmission circuits and adapted to be coupled to the base portion of FIG. 163.

FIG. 166 is a flow chart showing a method of implementing a base portion of an electrical wiring device adapted to receive an AC signal and having a switch and wireless signal transmission circuits.

FIG. 167 is a perspective view of a base portion of an electrical wiring device having an AC/DC transformer and wireless signal transmission circuits.

FIG. 168 is a block diagram of a circuit of a base portion of an electrical wiring device having a transformer adapted to receive an AC signal and wireless signal transmission circuits.

FIG. 169 is a block diagram of a signal adapter and wireless signal transmission circuits adapted to be coupled to the base portion of FIG. 168.

FIG. 170 is a flow chart showing a method of a base portion of an electrical wiring device having a transformer adapted to receive an AC signal and wireless signal transmission circuits.

FIG. 171 is another block diagram of a circuit for converting an AC signal to a DC signal.

FIG. 172 is a block diagram of a circuit for converting a DC signal to an AC signal.

FIG. 173 is a block diagram of a circuit for inductive coupling a DC signal from a first device to a second device.

FIG. 174 is a block diagram of circuits for authenticating the transmission of signals between a first device and a second device.

FIG. 175 is a signaling diagram showing the transmission of signals between devices.

FIG. 176 is a flow chart showing the authentication of signals transferred between a base portion and a signal adapter of an electrical wiring device.

FIG. 177 is a front perspective view of an electrical wiring device.

FIG. 178 is a rear perspective view of the electrical wiring device of FIG. 177 and having control actuators for controlling the application of a DC output signal to lighting elements.

FIG. 179 is a block diagram of an electrical wiring device, such as the electrical wiring device of FIG. 177.

FIG. 180 is a flow chart showing a method of implementing an electrical wiring device, such as the electrical wiring device of FIG. 177.

FIG. 181 is a perspective view of a base portion of an electrical wiring device adapted to receive a signa adapter and having control actuators for controlling the application of a DC output signal to lighting elements.

FIG. 182 is a perspective view of a base portion of an electrical wiring device of FIG. 181 having the signal adapter comprising a switch actuator element.

FIG. 183 is a block diagram of a base portion of an electrical wiring device, such as the base portion of FIG. 181.

FIG. 184 is a block diagram of a signal adapter, such as a signal adapter adapted to be coupled to the base portion of FIG. 181.

FIG. 185 is a block diagram of a base portion of an electrical wiring device.

FIG. 186 is a block diagram of a signal adapter configured to be received by a base portion of an electrical wiring device, such as the base portion of FIG. 185.

FIG. 187 is a flow chart showing a method of implementing an electrical wiring device, such as an electrical wiring having the circuits and elements of FIGS. 181-186.

FIG. 188 is a perspective view of a base portion of an electrical wiring device.

FIG. 189 is a block diagram of a base portion of an electrical wiring device, such as the base portion of FIG. 188.

FIG. 190 is a block diagram of a signal adapter adapted to be attached to a base portion of an electrical wiring device, such as the base portion of FIG. 188.

FIG. 191 is a flow chart showing a method of implementing an electrical wiring device, such as an electrical wiring device having the circuits and elements of FIGS. 181-186.

FIG. 192 is a perspective view of a base portion of an electrical wiring device.

FIG. 193 is a block diagram of a base portion of an electrical wiring device, such as the base portion of FIG. 192.

FIG. 194 is a block diagram of a signal adapter adapted to be received by a base portion, such as the base portion of FIG. 192.

FIG. 195 is a flow chart showing a method of implementing circuits and components of an electrical wiring device, such as the circuits and components of FIGS. 192-194.

FIG. 196 is a perspective view of an electrical wiring device.

FIG. 197 is a perspective view of the back of the electrical wiring device of FIG. 196 and having control actuators for controlling the application of a DC output signal to lighting elements.

FIG. 198 is a block diagram of an electrical wiring device, such as the electrical wiring device of FIG. 196.

FIG. 199 is a flow chart showing a method of implementing an electrical wiring device, such as the circuits and devices of FIGS. 196-198.

FIG. 200 is a perspective view of a base portion of an electrical wiring device adapted to receive a DC input signal and having control actuators for controlling the application of a DC output signal to lighting elements.

FIG. 201 is a perspective view of an electrical wiring device having a signal adapter comprising a switch actuator and couped to a base portion, such as the base portion of FIG. 200.

FIG. 202 is a block diagram of a base portion adapted to receive a DC input signal, such as the base portion of FIG. 200.

FIG. 203 is another block diagram of a base portion adapted to receive a DC input signal, such as the base portion of FIG. 200, where a signal adapter may receive a signal adapter having control actuators for controlling the application of a DC output signal to lighting elements, such as the signal adapter of FIG. 194 for example.

FIG. 204 is a flow chart showing a method of implementing an electrical wiring device, such as the circuits and devices of FIG. 2001-202.

FIG. 205 is a flow chart showing a method of implementing an electrical wiring device, such as the circuits and devices associated with the base portion of FIG. 203.

FIG. 206 is a perspective view of a base portion adapted to receive DC input signals comprising +va, +vb and −v inputs signals and having control actuators for controlling the application of a DC output signal to lighting elements.

FIG. 207 is a block diagram of a base portion adapted to receive DC input signals comprising +va, +vb and −v inputs signals and having control actuators for controlling the application of a DC output signal to lighting elements, such as the base portion of FIG. 206.

FIG. 208 is a block diagram of a signal adapter adapted to be received by a base portion, such as the base portion of FIGS. 206 and 207.

FIG. 209 is a flow chart showing a method of implementing an electrical wiring device, such as the circuits and elements of the electrical wiring device described in FIGS. 206-208.

FIG. 210 is another perspective view of a base portion adapted to receive DC input signals comprising +va, +vb and −v inputs signals and having control actuators for controlling the application of a DC output signal to lighting elements.

FIG. 211 is a block diagram of a base portion adapted to receive DC input signals comprising +va, +vb and −v inputs signals.

FIG. 212 is a block diagram of a signal adapter adapted to be received by the base portion of FIG. 211 and having control actuators for controlling the application of a DC output signal to lighting elements.

FIG. 213 is a flow chart showing a method of implementing the circuits and devices of an electrical wiring device, such as the circuits and devices of FIGS. 210-212.

FIG. 214 is a perspective view of a base portion of an electrical wiring device adapted to receive a signal adapter having a receptacle and a second signal adapter having a DC circuit.

FIG. 215 is a front perspective view of a signal adapter having a receptacle and USB electrical connectors.

FIG. 216 is a block diagram of a rear perspective view of the signal adapter of FIG. 215.

FIG. 217 is a perspective view of a front of a signal adapter having a DC receptacle interface and USB connectors.

FIG. 218 is a perspective view of a rear of a signal adapter of FIG. 217.

FIG. 219 is a perspective view of an electrical wiring device having an AC/DC converter circuit and an electrical receptacle and the signal adapter of FIG. 217 is attached.

FIG. 220 is a perspective view of an electrical wiring device having an AC/DC converter circuit and an electrical receptacle and a signal adapter having a DC receptacle is attached.

FIG. 221 is a block diagram of circuit of a base portion having an electrical interface adapted to receive a signal adapter having an AC receptacle and a second electrical interface adapted to receive a signal adapter having DC circuit.

FIG. 222 is a block diagram of a signal adapter having a receptacle.

FIG. 223 is a block diagram of a signal adapter having DC circuits.

FIG. 224 is a flow chart showing a method of implementing a base portion of an electrical wiring device adapted to receive multiple signal adapters.

FIG. 225 is a perspective view of a base portion having an electrical interface for receiving contact elements for receiving AC signals and contact elements for receiving DC signals.

FIG. 226 is a front perspective view of a signal adapter configured to be received by the base portion of FIG. 225.

FIG. 227 is a rear perspective view of a signal adapter configured to be received by the base portion of FIG. 225.

FIG. 228 is a front perspective view of another signal adapter configured to be received by the base portion of FIG. 225.

FIG. 229 is a block diagram of a circuit adapted to be implemented in the base portion of FIG. 225.

FIG. 230 is a block diagram of a circuit adapted to be implemented in a base portion, such as the base portion of FIG. 225.

FIG. 231 is a block diagram of another circuit adapted to be implemented in a base portion, such as the base portion of FIG. 225.

FIG. 232 is a flow chart showing a method of implementing an electrical wiring device having a base portion comprising an electrical interface for receiving contact elements for receiving AC signals and contact elements for receiving DC signals.

FIG. 233 is a perspective view of another electrical wiring device having a base portion comprising an electrical interface for receiving contact elements for receiving AC signals and contact elements for receiving DC signals.

FIG. 234 is a front perspective view of a signal adapter configured to be received by the base portion of FIG. 233.

FIG. 235 is a rear perspective view of a signal adapter configured to be received by the base portion of FIG. 233.

FIG. 236 is a front perspective view of another signal adapter configured to be received by the base portion of FIG. 233.

FIG. 237 is a block diagram of a circuit adapted to be implemented in the base portion of FIG. 233.

FIG. 238 is a block diagram of a circuit adapted to be implemented in a base portion, such as the base portion of FIG. 233.

FIG. 239 is a block diagram of another circuit adapted to be implemented in a base portion, such as the base portion of FIG. 233.

FIG. 240 is a flow chart showing a method of implementing an electrical wiring device having a base portion comprising an electrical interface for receiving contact elements for receiving AC signals and contact elements for receiving DC signals.

FIG. 241 is a block diagram of a system of implementing electrical wiring devices using one or both of both AC and DC currents.

FIG. 242 is a diagram showing a signaling arrangement that could be implemented in the system of FIG. 241.

FIG. 243 is a flow chart showing a method of implementing a system having a plurality of DC lighting elements.

### DETAILED DESCRIPTION

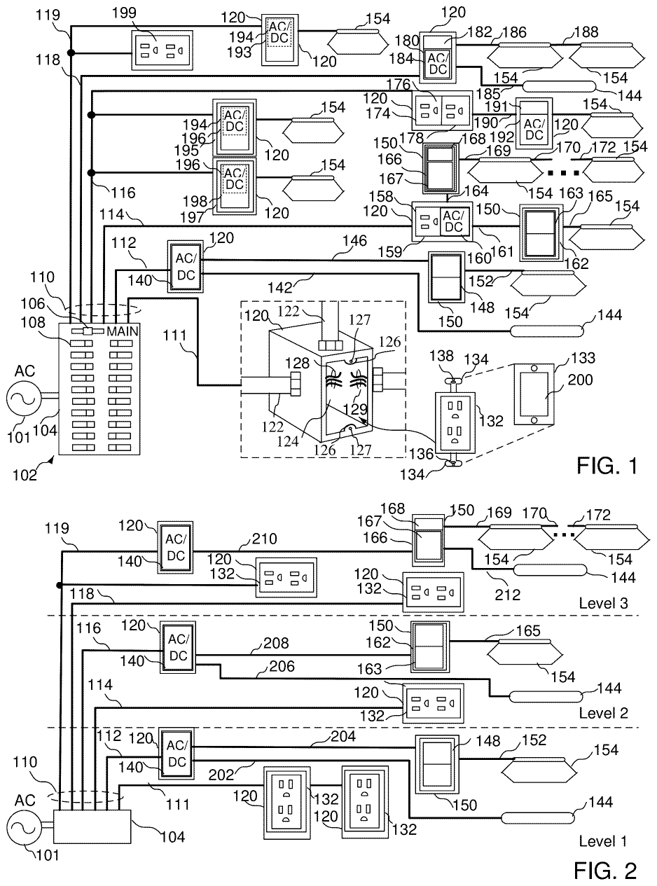

Turning first to FIG. 1, a block diagram of a system for implementing electrical wiring devices using one or both of both AC and DC currents is shown. There are two types of current that can be used to power devices, including alternating current (AC), which reverses direction a certain number of times per second, such as 60 times in the U.S., and can be converted to different voltages relatively easily using a transformer, and direct current (DC), which runs continually in a single direction, as in a battery or a fuel cell. AC enables more efficient transmission over long distances, which is why alternating current is used in power transmission from electrical generating stations to residential and commercial buildings. However, AC is considered more dangerous than DC. The human body has a higher impedance to DC currents than AC, so humans are able to withstand the effects of an electric shock arising from DC exposure much better than when exposed to AC. AC power poses a higher risk compared to DC due to the higher peak voltage. Alternating current waveforms can be easily distorted by inductive and capacitive loads. Installing AC supply needs more precautions than DC due to higher risks of shock. AC is generally considered more efficient than DC primarily because of its ability to be easily transformed into higher or lower voltages, which is crucial for efficient power distribution and minimizing energy losses during transmission and consumption.

AC wiring generally provides a line voltage, a neutral voltage and a ground voltage. In some cases, one or more additional wires may be provided to communication between devices, such as a traveler wire or some other wires for communication. Wires have a certain thicken, which is indicated by a gauge or designation of a radius of the wire. Building codes may dictate a certain gauge, as referenced by an American Wire Gauge (AWG) for example. According to some building codes and depending upon the power dissipation in the load, 12 or 14 AWG wires may be required in certain applications. Wires may be provided in groups that are held together by a sheathing, and the insulation material on the individual wires may have different colors, making it easier for an electrician to correctly wire a device. For example, electricians may generally recognize a wire having a black insulation material as being used for being electrically coupling to a line voltage to a device and a wire having a white insulation material as being used for electrically coupling a neutral voltage to a device. A wire intended to be coupled to ground may not have an insulating material or may have a green insulating material. When designating a group of wires that held together in a sheathing may be designated with first number indicating the gauge of the wire (such at 14 indicating that the wires of the bundle have 14 gauge wires) and a number of wires such as 2, indicating that 2 wires other than ground are included. For example, a bundle designated at 14-2 would have 14 gauge wire and 2 wires (e.g., for line and neutral voltages) and may have a non-insulated copper wire that is intended to be coupled to a ground electrical connector. Other groups of wires that may have higher gauge wire (e.g., 18 gauge wire, where 18 gauge wire has a smaller radius that 14 gauge wire) that may typically be used in DC applications because the current requirements are lower. DC wire groups have a similar designation but generally count all of the wires (i.e., they do not provide a separate non-insulated wire for ground). The groups of DC wires may also have different colors. For example, an 18-5 group of wires may have 5 wires that are 18 gauge wires and may have different colors, such as black, red, green, yellow and white.

The system 102 provides power to electrical devices of a building, such as a residential or commercial building. An AC source 101 which provides AC current to the system 102, which may comprise a building such as a residential or commercial building, and more particularly provides a reference voltage (e.g., 120 volts (V)) to an electrical enclosure 104 that houses circuit breakers, including a main circuit breaker switch 106 and circuit breakers 108 for individual branch circuits. The AC source 101 provides a line voltage, which is a first reference voltage that may be 120 V for example, by way of a line voltage wire, and provides a return path at a second reference voltage commonly known as a neutral voltage by way of a neutral wire.

A branch circuit of the system 102 represents a plurality of wires coupled directly or indirectly to the electrical enclosure 104, such as from a main circuit breaker switch 106 to the electrical devices that it serves. Electrical enclosures may be referred to in the construction industry as a load center or panel board, and may comprise a main circuit breaker switch 106 for disconnecting all of the circuits of the electrical enclosure from the AC source 101. For example, a branch circuit may provide line voltage by way of a line voltage wire extending from the electrical enclosure to a plurality of electrical devices, such as receptacles or other devices adapted to receive the line voltage, and may enable a return current path to a node at the neutral voltage by way of a neutral wire as is known in the art. Six branch circuits of a plurality of branch circuits 110 are shown by way of example in FIG. 1, including a first branch circuit 111, as second branch circuit 112, a third branch circuit 114, a fourth branch circuit 116, a fifth branch circuit 118, and a sixth branch 119. While six branch circuits are shown, it should be understood that greater or fewer branch circuits could be implemented and the number of branches extending to a variety of devices could vary, depending upon the size of the building, the number of electrical wiring devices implemented, or other factors. While the branch circuits of FIG. 1 are shown by way of example to provide an indication of the different types of electrical wiring devices that could be employed, it should be understood that other devices could be implemented and arranged in different configurations.

Devices such as switches or receptacles receiving the line voltage by way of an AC signal are commonly implemented in a junction box 120 that may be coupled to conduit 122 having wires associated with the branch circuit 111 for routing reference voltage signals and other signals to various devices. Conduit is typically a metal material that is bent by an electrician to route electrical wires from the electrical enclosure to a junction box having an electrical device such as a switch or a receptacle. A junction box generally comprises an area 124 for receiving a device and one or more flanges 126 having a threaded portion 127 for receiving a screw or other attachment element to enable corresponding flange of an electrical device to the flange 126 of the junction box, as will be described in more detail in reference to the receptacle device 132.

Wires associated with the conduit and junction box 120 are shown by way of example as wires 128 extending from conduit into the junction box and wires 129 extending from inside the junction box to conduit enable devices to be a part of a branch circuit. For example, an electrical wiring device may receive a line voltage, a neutral voltage, and a ground voltage by way of the wires 128 and route the line voltage to a load, such as a light fixture, by way of the wires 129. According to some implementations, wires entering into the junction box, such as wires 128 may have a first voltage and be of a first type of signal (e.g., a 120V AC signal) and wires 129 extending from a junction box may have a second voltage and a second signal type (e.g., a 48V DC signal), where an electrical wiring device such as a switch or receptacle may be electrically coupled to the wires 128 and the wires 129 as will be described in more detail below.

A receptacle device 132 comprises flanges 134 each having an opening 136 which is adapted to receive a screw used to attach the receptacle of the threaded portion 127 of the junction box and a threaded portion 138 which is adapted to receive a screw to attach a wall plate 133 to the receptacle device 132. The wall plate may have an opening through which a portion of the receptacle (or a switch in the case of an electrical wiring device having a switch). The flanges of the receptacle device 132 are shown by way of example and could be implemented differently. Similar flanges could be employed with the remaining electrical wiring devices comprising switches and receptacles described in FIG. 1 and the other figures having electrical wiring devices comprising switches and receptacles. Junction boxes 120 are commonly installed in residential and commercial buildings, such as attached to a stud behind wallboard material for example. A wall plate 133 may also be attached to a wiring device, such as the receptacle device 132 or any of the wiring devices described in FIG. 2 or any of the other figures below. The wall plate has an opening 200 for receiving a raised portion of the wiring device comprising a switch or outlet and being adapted to receive a signal adapter while the wall plate is attached to the wiring device. That is, according to some implementations, the signal adapter will be adapted to be attached to the wiring device when the wall plate is attached to the wiring device. According to other implementations, the wiring device may be configured to only receive the signal adapter or have the signal adapter removed when the wall plate is detached from the wiring device. The wall plate may be attached to the wiring device using screws for example.

According to the implementation of FIG. 1, a dedicated AC-to-DC (AC/DC) converter circuit devices may be implemented. According to some implementations, the AC/DC converter circuit devices may be implemented in a junction box as shown in FIG. 1. The AC/DC converter circuit devices may have one or more inputs (e.g., a plurality of electrical connectors for receiving wires of a junction box) to receive wires enabling the transmission of AC signals, and one or more outputs (e.g., a plurality of electrical connectors for receiving wires of a junction box) to route one or more DC signals generated by the AC/DC converter circuit devices to other electrical devices of the system 102. An AC/DC converter circuit device 140, shown as being implemented in a junction box 120 in FIG. 1, is configured to receive an AC signal, often referred to as a line signal or line power signal, at a electrical connector by way of a wire of the branch circuit 111 extending from the electrical enclosure 104.

As described above, wires designed to carry DC signals may be coupled to one or more outputs of the AC/DC converter circuit device 140. Two outputs are shown by way of example extending from the junction box 120 having the AC/DC converter circuit device 140 to rout DC signal to other devices. For example, DC signal lines 142 may be coupled to a first output of the AC/DC converter circuit that is coupled to a device 144 adapted to receive DC power. For simplicity, devices adapted to operate on a DC power signal are categorized for simplicity as a DC lighting devices (e.g., ceiling lights, sconce lights, lamps, light strips, or any other lighting device adapted to receive a DC signal for generating light), which may be widely implemented in a residential or commercial building, and other devices that may operate on DC power and commonly found in the home and controlled by a switch, plugged into a receptacle or directly wired to receive power, such as smoke detectors, CO detectors, a thermostat, motion detectors, wireless communication devices such as WIFI extenders or WIFI mesh devices, night lights, and a variety of other devices. Some lighting devices adapted to receive a DC signal may comprise one or more LED devices adapted to receive a DC signal directly from DC wiring. That is, rather than an LED bulb that comprises an AC/DC converter circuit and is adapted to be screwed into a fixture, the LED lighting devices, such as bulbs and lighting strips are adapted to receive a DC voltage and operate on DC current. As will be described in more detail below, some receptacles may comprise an electrical interface for providing DC power to an appliance that is adapted to operate on DC power and is plugged into the electrical interface.

The AC/DC converter circuit device 140 may comprise a second output coupled by way of one or more DC signal lines to an electrical wiring device 148, shown here as a switch, that is adapted to operate on DC signals. The electrical wiring device 148 is provided in DC junction box 150 and enables changing the state of a DC signal that is provided on an output electrical connector to another set of DC signal lines 152 to provide power to a lighting device 154 adapted to operate on a DC power signal. The lighting device 154 comprises a lighting device adapted to receive a DC input signal to provide power to a lighting element, such as an LED lighting element or some other lighting element. Another electrical wiring device could be coupled to the lighting device to provide multiway wiring, as will be described in more detail below.

According to one implementation, the electrical wiring device 148 shown in FIG. 1 comprises a DC switch that receives a DC input signal and is adapted to pass or block a DC output signal. The electrical wiring device 148 as shown in FIG. 1 may comprise a single piece construction as is found in many conventional switches and receptacles. As will be described in more detail below, other electrical wiring devices may be implemented using a base portion and a removably attachable signal adapter. For a base portion receiving an AC input signal (i.e., where an AC/DC conversion circuit is implemented as a part of either the base portion or a signal adapter coupled to the base portion), the base portion may comprise a plurality of electrical interfaces, including one or more of a first electrical interface adapted to receive AC signals, a second electrical interface to communicate DC signals with a signal adapter, and a third electrical interface adapted to provide DC power to a load. For a base portion receiving a DC input signal (i.e., where an AC/DC conversion circuit is implemented outside of or separate from the electrical wiring device), the base portion may comprise a plurality of electrical interfaces, including one or more of a first electrical interface adapted to receive DC signals, a second electrical interface to communicate DC signals with a signal adapter, and a third electrical interface adapted to provide DC power to a load. While the electrical wiring device 148 receives a DC input and generates a DC output, it may provide other functionality, such as dimming or motion sensing for example. That is, a switch device receiving one or more DC signals may comprise different components that may be separated by a user of the device, such as a homeowner.

According to some implementations, detachable paddle adapted to actuate separate on and off buttons may be implemented, such as with a full partition implementation, to allow for different colors to be used. According to implementations, a detachable hinged cover could be used.

According to some implementations, electrical connectors for both electrical interfaces receiving AC signals and electrical interfaces receiving DC signals may comprise screws, wires, stab (or backstab) contacts, lever contacts, or connector blocks for receiving a plurality of wires for example.

According to some implementations, the switching of a DC signal applied to a load (i.e., to apply power to the load or disconnect power to the load) may be performed mechanically or electronically using an electronic circuit. According to some implementations, the switching may be performed in the base portion, while the switching may be performed in the signal adapter. According to some implementations, a cover may be used in place of a signal adapter to provide a more aesthetically appealing electrical wiring device. According to other implementations, the cover may not have DC switching functionality but may have one or more wires for routing one or more DC signal from the base portion, through signal adapter and back to the base portion. According to some implementations, an electrical wiring device may be adapted to operate without a signal adapter. According to other implementations, an electrical wiring device may require a cover having at least one wire for routing a DC signal from the base portion, through signal adapter and back to the base portion. According to some implementations, a cover or a signal adapter may effectively override the switching operation of a switch of the base portion, where the switch of the base portion may function to provide a switching signal.

Because the electrical wiring device 148 receives DC signals and not AC signals, it may be possible to provide a different junction box that may not meet the requirements for a junction box adapted to route AC signals. That is, because a DC signal may be at lower voltage levels and less dangerous for human contact, the code requirements for the DC junction box 150 may be less constrictive, such as allowing a thinner plastic, a plastic with a lower flame retardance rating, and or not requiring the switch to be enclosed as may be required for a signal adapted to switch an AC signal for example.

While DC signals may be generated by a dedicated AC/DC converter circuit, such as an AC/DC converter circuit device 140 that is adapted to be inserted into a junction box, an AC/DC converter circuit may be implemented in an electrical wiring device comprising a receptacle. An AC/DC converter circuit could be implemented in an electrical wiring device, such as in a receptacle device or a switch device. As shown in FIG. 1, a DC junction box 150 coupled to the branch circuit 114 is coupled to an electrical wiring device 158 comprising a receptacle 159 and signal adapter 160 comprising an AC/DC converter circuit. The signal adapter 160 comprises an AC/DC converter circuit adapted to receive an AC signal, such as a line signal coupled by a wire of the junction box 120, and generate a DC signal that is output on an output electrical connector of the electrical wiring device 158. According to other examples, the AC/DC converter circuit could be implemented in a duplex receptacle (i.e., a receptacle device that comprises 2 groups of electrical connectors each adapted to receive a plug such as a conventional 3-prong plug, commonly referred to a receptacle or a receptacle), where DC output electrical connectors are on a surface of the electrical wiring device 158, such as on a rear or side surface to enable providing a DC signal to another electrical wiring device, such as an electrical wiring devices comprising a switch for example.

According to some implementations, a “duplex” receptacle could include a DC connector adapted to receive a DC connector for providing DC power to an appliance having a mating connector. A signal adapter could include the DC connector and implemented in an electrical wiring device comprising a switch.

According to some implementations, compatibility of signal adapters between a electrical wiring device comprising a switch and an electrical wiring device comprising a receptacle may be accomplished by having AC electrical connectors of a signal adapter may extend beyond a rear surface of the signal adapter. Tamper resistance for both electrical connectors adapted to receive an AC signal and electrical connectors adapted to receive a DC signal that may be accessible to a user in an electrical wiring device.

While electrical wiring device 148 has a single piece electrical construction (i.e., all of the electrical components are coupled together as a single device, where any removable device may be a non-electrical component such as a switch actuator that can be swapped out to enable a cosmetic change, such as a change in color) for the electrician or homeowner, some electrical wiring devices set forth below may have two portions that are electrically connected to enable the switching operation. As will be described in more details below, both the power switching operating of providing power to a load and user interface elements can be distributed between the base portion and the signal adapter in a variety of ways. According to some implementations, the partitioning of the electrical wiring device can be a full partition comprising a base portion electrically coupled to a signal adapter, where user interface elements are on the signal adapter. That is, the electrical interface elements accessible by a user when a signal adapter is attached to the base portion. According to some implementations, user interface settings or functions related to a given signal adapter can be provided on the signal adapter, such as on a front surface that is accessible to a user or on a rear surface that is accessible to a user when the signal adapter is removed from a base portion. For example, settings for motion sensor, a timer or a dimmer. However, it should be understood that additional user interface elements may be on the base portion when the signal adapter is detached from the base portion, as will be described in more detail below.

According to some embodiments, the partitioning of the electrical wiring device can be a partial partition comprising a base portion electrically coupled to a signal adapter, where user interface elements can be distributed on both the base portion and on the signal adapter. By way of example, a switch actuator adapted to switch power to a load may be implemented on the base portion, as will be described below.

According to some implementations of an electrical wiring device having a full partition, the switching of the DC power signal to the load can occur in the base portion.

According to some implementations of an electrical wiring device having a full partition, the switching of the DC power signal to the load can occur in the signal adapter.

According to some implementations of an electrical wiring device having a full partition, the signal adapter may occupy the entire area of an opening of a wall plate.

According to some implementations of an electrical wiring device having a partial partition, the signal adapter may occupy the entire area of an opening of a wall plate.

According to some implementations of an electrical wiring device having a partial partition, the switching of the DC power signal to the load can occur in the base portion.

According to some implementations of an electrical wiring device having a partial partition, the switching of the DC power signal to the load can occur in the signal adapter.

DC signal lines 161 coupled to the output electrical connector of the electrical wiring device 158 provides a DC voltage to an electrical wiring device 162. According to one implementation, the electrical wiring device 162 may be implemented as a full partition and comprises a switch device having a base portion and a signal adapter 163 that it electrically attached to the base portion, where the signal adapter detachably coupled to the base portion. The signal adapter user interface may comprise a conventional paddle-type switch, where pressing on the top portion of the switch may apply power to a load (e.g., turn a light or fan on) by way of DC signal lines 165 and pressing on the bottom portion of the switch may block the application of power to a load (e.g., turn a light or fan off). As will be described in more detail below, the signal adapter 163 can be removed by the electrician and homeowner and replaced with a different signal adapter having additional features. According to some implementations, the signal adapter 163 may be removed with the wall plate attached to the electrical wiring device, while other implementations may require the wall plate to be removed in order to remove the signal adapter 163. According to some implementations of the electrical wiring device 162, the switching of a DC power signal to a load will be performed in the base portion. According to other implementations, the switching of the DC power signal to the load will be performed in the signal adapter.

Switch devices having multiple components are now generally described and will be described in more detail in embodiments below. For example, the electrical wiring device 148 may comprise a base portion adapted to receive a signal adapter that is removably attached to the base portion, where different functions of the switch may be distributed between the base portion and the signal adapter that may be removably attached to the base portion. The base portion and the switching portion may be connected by a plurality of electrical connectors on the base portion and corresponding plurality of electrical connectors on the signal adapter. According to some implementations the base portion may comprise an actuator that enables the base portion to operate without a signal adapter, where the signal adapter may provide additional functionality that may be independent from any switching operations or that may affect switching of the received DC signal or a modified DC signal to a load, such as a dimming function. According to some implementations, the base portion may comprise electrical connectors adapted to receive a DC voltage and output electrical connectors adapted to provide a DC voltage to a load, such as a light.

An example of an electrical wiring device without an AC/DC converter and having a partial partition is also shown. More particularly, DC signal lines 164 coupled to the signal adapter 160 comprising an AC/DC converter circuit is electrically coupled to an electrical wiring device 166 having a signal adapter 167 and a user interface portion 168, which may comprise an actuator element to enable a toggling of the power applied to a load for example. As will be described in more detail below, the switching element for switching power to a load controlled by the electrical wiring device 166 may be in the base portion of the electrical wiring device or in the signal adapter which may be removably attached to the base portion. DC signal lines 169 is coupled to an output electrical connector of the electrical wiring device 166 and to a lighting device 154. Multiple lighting devices are shown by way of example as being connected, series or in parallel using one or more additional DC signal lines 170 and 172.

An example of an electrical wiring device having an AC/DC converter and having a partial partition is also shown. An electrical wiring device 180 comprises a base portion, a user interface portion 182, and a signal adapter 184. According to some implementations, the AC/DC converter circuit will be in the base portion, while in other implementations the AC/DC converter circuit will be in the signal adapter 184. According to some implementations, the switching element for switching the DC signal to provide power to a load will be in the base portion, while in other implementations the switching element will be in the signal adapter 184. A first output of the electrical wiring device 180 is coupled to DC signal lines 185 to provide power to a device 144. While a single device is shown, it should be understood that multiple devices 144 could be coupled together, in series or in parallel. A second output may be coupled DC signal lines 186 providing power to a lighting device 154 and DC signal lines 188 coupled to a lighting device 154. While two outputs are shown, it should be understood that additional outputs could be provided to provide a fixed DC output signal or a switched DC output signal as will be described in more detail below. Because the electrical wiring device receives an AC signal at an input, it is attached to a junction box 120 adapted to receive the electrical wiring device 180.

According to some implementations, an electrical wiring device comprising one or more receptacles may comprise a signal adapter that is removably attached to a base portion. As also shown in FIG. 1, an electrical wiring device 174 comprises a first receptacle 176 that may be a fixed receptacle and a second receptacle 178 that may be removably attached to a base portion of the electrical wiring device. According to some embodiments, both receptacles may be removably attached to the base, as a single signal adapter or two signal adapters. The electrical wiring device 174 may be configured to receive a signal adapter that is configured to operation on DC power by receiving a DC voltage. For example, the base portion may comprise an AC/DC converter circuit to allow a signal adapter that operates on DC power to be attached to the base portion of the electrical wiring device 174. According to other implementations, an AC/DC converter circuit may be implemented in an AC/DC conversion adapter device that is adapted to receive a signal adapter, including a signal adapter that can be attached to an electrical wiring device having a switch. That is, the AC/DC conversion adapter could comprise a first plurality of electrical connectors that are adapted to be coupled to the electrical connectors that the receptacle 178 would be coupled to and a second plurality of electrical connectors adapted to receive one or more corresponding electrical connectors of a signal adapter, and more particularly receive a DC voltage to provide power to the signal adapter. By enabling signal adapters that operate on DC power, received by way of electrical connectors of the base portion or electrical connectors of a AC/DC conversion adapter, to be used in a receptacle, it is possible to provide a system that enables compatibility of signal adapters with both electrical wiring devices comprising switches and electrical wiring devices having receptacles.

An example of an electrical wiring device having an AC/DC converter in a base portion of the electrical wiring device and having a partial partition is also shown. An AC signal line 190 comprises one or more wires to provide electrical signals including a line voltage, a neutral voltage and a ground voltage for example to an electrical wiring device 191 comprising an AC/DC converter circuit 192 implemented in the base portion. As will be described in more detail below, an AC/DC conversion circuit generates a DC voltage signal that is coupled to a electrical connector of the electrical wiring device 191 and is provided to a lighting device 154.

An example of an electrical wiring device with an AC/DC converter but not having a signal adapter is also shown. According to some implementations, an electrical wiring device 194 may comprise an AC/DC converter circuit 195. A DC voltage signal is provided by way of DC signal lines 193 to a lighting device 154. While electrical wiring devices having a switch may not be adapted to receive a signal adapter, the electrical wiring device 194 may comprise one or more features beyond an actuator for enabling the application of DC power from the AC/DC converter circuit to a load. That is, a variety of different electrical wiring devices 194 that are not adapted to receive a signal adapter, but rather have different functionality such as motion sensing, diming or timing, may be implemented.

An example of an electrical wiring device having an AC/DC converter in a signal adapter and having a full partition is also shown. Electrical wiring devices having switches may also comprise signal adapters that enable a full partition of the user interface element accessible to a user when the signal adapter is attached to the base portion of the electrical wiring device. For example, an electrical wiring device 196 comprises an AC/DC converter circuit 195 implemented in a signal adapter 197 that is removably coupled to the base portion of the electrical wiring device. According to another example, an electrical wiring device 198 comprises an AC/DC converter circuit 195 implemented in the base portion of the electrical wiring device that is adapted to receive a signal adapter 199 that provides a full partition of the electrical interface.

According to some implementations, a device having DC converter circuit may be implemented in a first gang of a multi-gang junction box, where an output of the DC converter circuit may be coupled to an electrical wiring device in a second gang or a dual gang junction box. According to other implementations, a single signal adapter may be adapted to be coupled to two base portions in a two-gang junction box or three portions in a three-gang junction box. According to some implementations, a backup battery could be provided in a gang of a single or multi-gang junction box, and could be used to enable lighting a certain number of lights in a building. The backup battery could be easily detached from the junction box to enable flexibility in which lights are powered. Because lights powered by DC signals are generally low power, the backup batteries could provide light for a limited number of lighting devices for a known amount of time.

According to some implementations, communication may be provided using communication circuits in a base portion in a signal adapter, or in a dedicated communication device in a junction box. Wireless communication can be implemented using any know wireless communication protocol, such as WifFi, WiFi mesh, Zigbee, Z-Wave, Bluetooth, Bluetooth Mesh, or Near Field Communication (NFC) for example, or using a propriety wireless communication protocol. Wired communication can be implemented using any know wired communication protocol, such as by way of a USB connection or using any propriety wired communication protocol.

The arrangement of elements of FIG. 1 is provided to show different configurations of inputs and outputs to various DC lighting devices and other DC devices, it should be understood additional AC/DC adapters, electrical wiring devices having switches and electrical devices having receptacles could be implemented and electrically coupled DC lighting devices and other DC devices in different configurations. While signals carrying AC signals, such as 120V AC signals commonly used in the United States, are often required by various building codes to be routed to a load device such as a light through conduit or some other protective element, wires carrying DC signals, and particularly DC signals under a certain voltage such as under 50 V, may not need to be routed in conduit. While FIG. 1 shows a variety of different types of electrical wiring devices, some examples of different arrangements of the electrical wiring devices of FIG. 1 are now shown.

Turning first to FIG. 2, another block diagram of a system for implementing electrical wiring devices using both AC current and DC current and providing AC to DC conversion devices that are mountable within a junction box is shown. According to the implementation of FIG. 2 dedicated AC/DC converter devices are implemented in a variety of locations such as individual rooms or zones to efficiently route DC signals to wiring device elements adapted to receive a DC signal input. A plurality DC signal lines are routed from AC/DC converters to provide a DC signals to switches and loads. As shown by way of example, a DC signal line 202 and a DC signal line 204 are provided on the first level from the AC/DC converter circuit device 140 to provide power to a device 144 and a lighting device 154 as shown. A DC signal line 206 and a DC signal line 208 are provided on the second level from the AC/DC converter circuit device 140 to provide power to a device 144 and a lighting device 154 as shown. A DC signal line 210 is provided to an electrical wiring device 166 adapted to control the application of DC power to lighting devices 154 as shown. DC signal line 212. While three levels are shown by way of example, it should be understood that a different number of levels could be provided and have a different configuration of electrical wiring devices, wires and loads. According to some implementations, levels 1-3 could correspond to a basement, first floor and second floor in a residential building for example.

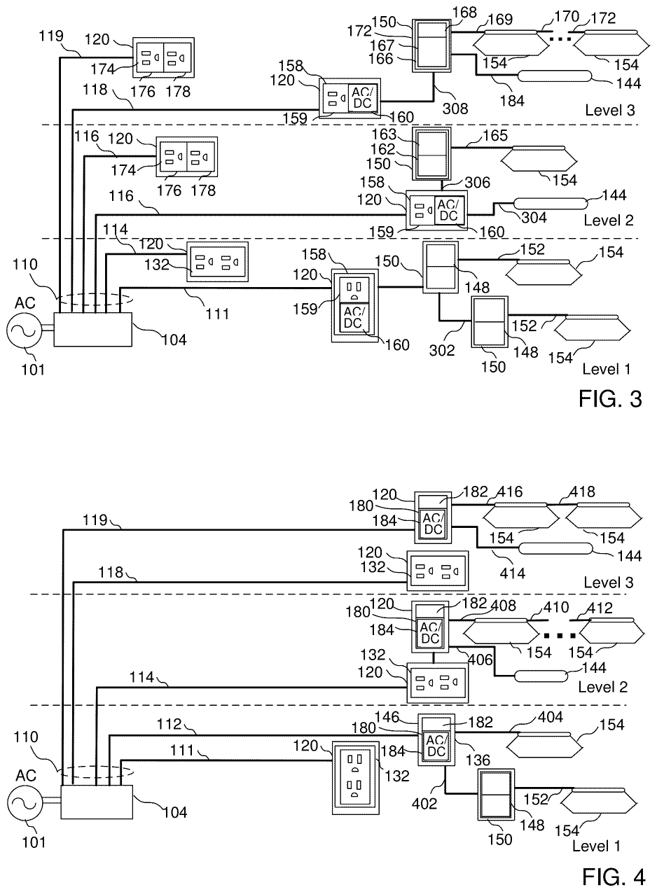

Turning now to FIG. 3, another block diagram of a system for implementing electrical wiring devices using both AC current and DC current and providing AC to DC conversion in an electrical wiring device having a receptacle is shown. As shown by way of example in FIG. 3, a signal adapter 160 comprising an AC/DC converter circuit is provided to provide DC signals using DC signal lines 302 as shown on level 1, DC signal lines 304 and DC signal lines 306 as shown on level 2, and DC signal lines 308 as shown on level three. While only three signal adapters 160 are shown in the three electrical receptacles, it should be understood additional AC/DC converter circuits could be implemented.

While FIG. 3 shows the placement of AC/DC converter circuits in a wiring device comprising a receptacle, an AC/DC converter circuit could also be placed in a wiring device comprising a switch. More particularly, FIG. 4 shows another block diagram of a system for implementing electrical wiring devices using both AC current and DC current and providing AC to DC conversion in an electrical wiring device having a switch. DC signal lines 402 provide DC signals to an electrical wiring device 146 that is adapted to provide DC power to a lighting device 154 by way of DC signal lines 404 on level 1 as shown. DC signal lines 406 provide DC signals to a device 144 on level 2 as shown. DC signal lines 408, DC signal lines 410, and DC signal lines 412 also provide a switched DC signal to lighting devices 154. That is, the electrical wiring device 180 comprising a switch on level 2 will not only provide fixed DC signals from the electrical wiring device 148 to the DC signal lines 406, but will also provide a switched DC signal, such as a switched +DC voltage signal, to allow the user interface portion 182, which may be a switch, to control the application of the +DC signal to the lighting device 154 by way of DC signal lines 408, 410, and 412 as will be described in more detail below. Similarly, the electrical wiring device 180 comprising a switch on level 3 will not only provide fixed DC signals from the electrical wiring device 148 to the AC/DC signal lines 414, but will also provide a switched DC signal, such as a switched +DC voltage signal, to allow the user interface portion 182, which may be a switch, to control the application of the +DC signal to the lighting device 154 by way of DC signal lines 416 and 418.

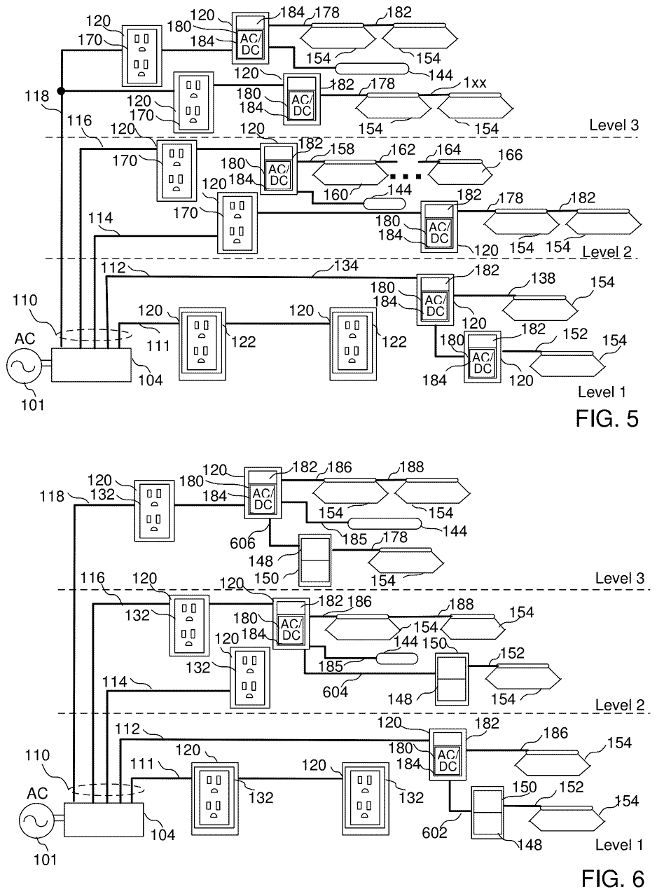

Turning now to FIG. 5, another block diagram of a system for implementing electrical wiring devices using both AC current and DC current and providing AC to DC conversion in an electrical wiring device having a switch is shown. That is, each electrical wiring device of FIG. 5 comprises an AC/DC converter circuit. According to some implementations, an AC/DC converter circuit may be implemented as a fixed circuit in the electrical wiring device having a switch for some of the electrical wiring devices.

Turning now to FIG. 6, another block diagram of a system for implementing electrical wiring devices using both AC current and DC current providing AC to DC conversion in some of the electrical wiring devices having a switch is shown. According to the implementation of FIG. 6, an electrical wiring device 180 having a signal adapter 184 comprising an AC/DC converter circuit is provided on each level, where DC signals may be provided to one or more devices 144 or lighting elements by way of one or more electrical wiring devices 148 that are adapted to provide a switched DC signal to a lighting device 154. More particularly, DC signal lines 602 are provided from an electrical wiring device 180 having an AC/DC converter circuit to an electrical wiring device 148 on level 1 as shown, DC signal lines 604 are provided from an electrical wiring device 180 having an AC/DC converter circuit to an electrical wiring device 148 on level 2 as show, and DC signal lines 606 are provided from an electrical wiring device 180 having an AC/DC converter circuit to an electrical wiring device 148 on level 3 as show.

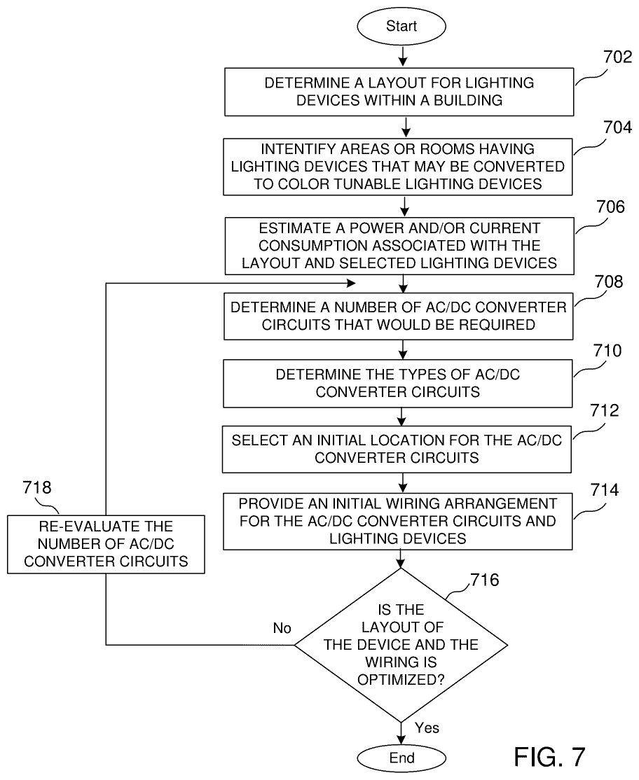

Turning now to FIG. 7, a flow chart showing a method of minimizing wiring requirements is shown. As in any project planning associated with building, it is beneficial to minimize the time in planning, the installation time, the physical labor, and the cost of materials to complete the project. This is also true of electrical wiring in a building, and particularly a residential building. It is beneficial to minimize the time in planning an electrical layout, the installation time for wiring and electrical wiring devices, the physical labor, and the cost of materials to complete the project. Because lighting devices may have known current and power consumption parameters, it is possible to select lighting devices and place electrical wiring devices that will minimize one or more the factors associated with planning and installing lighting devices and electrical wiring devices, including planning time for an electrical layout, the installation time for wiring lighting devices and electrical wiring devices, the physical labor in installing wiring associated with lighting devices and electrical wiring devices, and the cost of materials, including costs associated with wires.

The flowchart of FIG. 7 could be implemented using the devices and an arrangement of devices shown in at least Figs for example. 1-6, or other suitable arrangements of electrical wiring devices. Referring specifically to the flowchart of FIG. 7, a layout for lighting devices within a building is determined at a block 702. Areas or rooms having lighting devices that may be converted to color tunable lights are identified at a block 704. It should be noted that color-tunable lights may require additional current or power to generate the desired light patterns. A power and/or current consumption associated with the layout and selected lighting devices is estimated at a block 706. That is, when a home is designed, the location of lighting devices and the requirement for the lighting devices (e.g., the number of lighting device and the lumen or wattage requirements for the lighting devices) is known. When laying out lighting devices, an estimate for the necessary lumens or wattage may be for a given area may be increased by some amount, such as 20% or 25% for example, to ensure that the lumens or wattage value in an area will not be exceeded. A number of AC/DC converter circuits that would be required is determined at a block 708. As will be described in more detail below, the number of AC/DC converters may depend upon a number of factors, including the area of the of coverage, the number of levels requiring lighting devices or other devices, and the type if AC/DC converter devices used. The types of AC/DC converter circuits is determined at a step 710. This determination may depend upon the placement of the AC/DC converters, the types of lighting devices used, preferences of the homeowner or the contractor installing the lighting devices.

According to some implementations, it may be beneficial to determine whether the placement of lighting devices can be improved and lead to cost reductions, possibly for both hardware and labor. An initial location for the AC/DC converter circuits is selected at a block 712. An initial wiring arrangement for the AC/DC converter circuits and lighting devices is provided at a block 714. It is determined whether the layout of the device and the wring is optimized at a block 716. If so, the process is ended. If not, the number of AC/DC converter circuits required is re-evaluated at a block 718. The iteration process is continued until it is determined that the selection and placement of AC/DC converter circuits and lighting devices and wiring is optimized. The method of FIG. 7 may be implemented according to any of the arrangements devices of FIGS. 1-6 or using any of the devices set forth below.

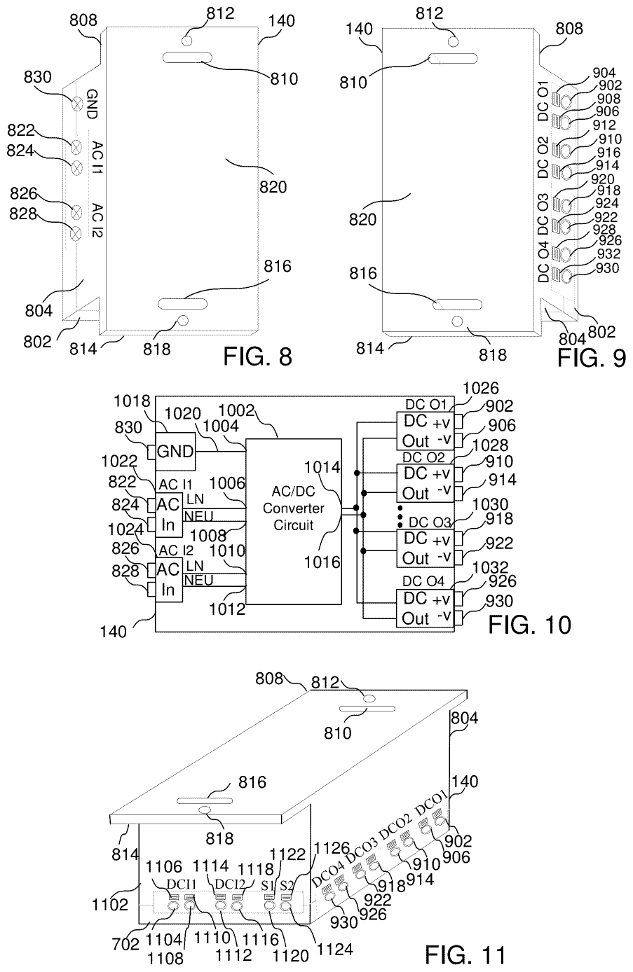

FIGS. 8-51 are directed to AC/DC converter circuits, which may be implemented in some applications as a LED drivers. The AC/DC converter circuits set forth below allow for easy placement in a conventional junction box normally used for a switch or an outlet and would be implemented according to building code requirements, such as the National Electric Code (NEC). According to some implementations, the AC/DC converter may have a signal adapter that is detachably coupled to a base portion. The AC/DC converter or a base portion may have a user interface and communication circuits for controlling the operation of the AC/DC converter circuit. Turning first to FIG. 8, a left-side perspective view of an AC/DC converter device adapted to be attached to a junction box is shown. When implementing AC/DC converter devices to be used to provide power to electrical wiring devices, lighting devices, or other devices adapted to receive DC signals, it may be beneficial to adapt an AC/DC converter circuit device 140 to be attached to a junction box, as shown for example in FIGS. 8 and 9.

The AC/DC converter circuit device 140 of FIG. 8 may comprise a bottom housing element 802 and a top housing element 804 adapted to be coupled together and retain the components and circuit elements of the AC/DC converter circuit. The bottom housing element 802 and the top housing element 804 may comprise openings that are adapted to expose electrical connectors and for receiving electrical connectors, such as wire, adapted to carry AC or DC voltages.

The AC/DC converter device may comprise a flange 808 having an opening 810 for receiving a screw to attach the AC/DC converter device to a junction box and a threaded portion 812 adapted to receive a screw to attach a wall plate to the AC/DC converter device. The AC/DC converter device may comprise another flange 814 having an opening 816 for receiving a screw to attach the AC/DC converter device to a junction box and a threaded portion 818 adapted to receive a screw to attach a wall plate to the AC/DC converter device. While flanges associated with top housing are shown by way of example, it should be that the AC/DC converter device may comprise a metal yoke that is commonly used in electrical wiring devices and shown as flange 134 for the receptacle device 132 in FIG. 1. While a front surface 820 of the AC/DC converter device may not have any functionality, according to some implementations the front surface 820 may comprise a user interface. By way of example, the front surface may comprise any type of user interface element, including and electrical user interface, such as a touch screen display, or an electrical-mechanical user interface, such as a switch actuator.

The user interface elements may be status indicators, input devices, output devices, a speaker, a microphone, control actuators, or any other elements related to the operation of the AC/DC converter device. The AC/DC converter may also comprise plurality of electrical connectors for receiving AC signals. More particularly, an electrical interface for receiving AC signals may comprise an electrical connector 822, an electrical connector 824, an electrical connector 826, and an electrical connector 828. An electrical connector 830 is adapted to receive a ground signal. While the electrical connectors are shown by way of example as a connector to adapted to receive a wire, such as a screw terminal or other type of connector adapter to receive a wire, the electrical connector could be a wire extending from the electrical wiring device and adapted to be electrically connected to wires of a junction box, where the wire may have a different gauge depending upon whether the electrical connector is adapted to receive an AC signal or a DC signal. While the electrical connectors adapted to receive AC signals are shown on one side of the AC/DC converter device, it should be understood that they could be distributed on other sides of the device.

Turning now to FIG. 9, a right-side perspective view of an AC/DC converter device adapted to be attached to a junction box is shown. As can be seen on the right side of the AC/DC converter device, a plurality of electrical connectors electrical for providing DC signals to various electrical wiring devices or loads, such as lighting devices and other devices adapted to receive a DC signal, are shown. Electrical connectors are shown with connector actuators by way of example. That is, the connector actuator may be pressed, causing the separation of metal connector elements so that a wire can be received between the metal connector elements and secured between the metal connector elements when the actuator is released. More particularly, eight connector and actuator pairs are shown, including an electrical connector 902 and corresponding connector actuator 904, an electrical connector 906 and corresponding connector actuator 908, an electrical connector 910 and corresponding connector actuator 912, an electrical connector 914 and corresponding connector actuator 916, an electrical connector 918 and corresponding connector actuator 920, an electrical connector 922 and corresponding connector actuator 924, and electrical connector 926 and corresponding connector actuator 928, and an electrical connector 930 and corresponding connector actuator 932. According to some implementations, two pairs of electrical connector and connector actuators, designated by way of example as a DC output (e.g., DC O1), may provide a +v signal and −v signal to a load, where the +v signal and −v signal are commonly referred to as DC reference voltages.

While the electrical connectors and corresponding actuators are shown by way of example for connectors adapted to receive DC signals, which may generally be adapted to receive a higher gauge (i.e., smaller diameter) that wires adapted to receive AC signal, it should be understood that the electrical connectors associated with DC signals could also be implemented with screw terminals as shown for the electrical connectors adapted to receive wires receiving an AC signal in FIG. 8, or could be wires extending from the electrical wiring device and adapted to be electrically connected to wires of a junction box, such as by using a twist wire connector for example. According to some implementations, the AC/DC converter circuit may be implemented behind a wall plate that does not allow access to the AC/DC converter circuit unless a user removes the wall plate.

Turning now to FIG. 10, a block diagram of the AC/DC converter device of FIGS. 8 and 9 is shown. Although only a single AC input signal pair (i.e., line and neutral) is required, the circuit of FIG. 10 comprises a plurality of AC inputs and a plurality of DC outputs. In addition to the electrical connectors shown in FIGS. 8 and 9, the AC/DC converter circuit device 140 may comprise elements associated with a printed circuit board (PCB), including for example an AC/DC converter circuit 1002 that is adapted to receive one or more AC input signals (a line (LN) voltage signal and a neutral (NEU) signal) and a ground (GND) signal. A ground input 1004 is adapted to receive the ground signal, a line voltage input 1006 is adapted to receive the line input, a neutral voltage input 1008 is adapted to receive the neutral signal.

According to some implementations, a second pair of line and neutral signals may be provided to receive a different phase of the line input signal. That is, many residential and commercial buildings receive two line voltage signals, which may be 120V AC for example and allow for providing 240V AC signal to some appliances that may require a 240V AC signal. Accordingly, a second line voltage input 1010 is adapted to receive a second line input signal and a second neutral voltage input 1012 is adapted to receive a second neutral signal. It should be understood that the first neutral signal and the second neutral signal could be the same signal according to some implementations. The AC/DC converter circuit also comprises a positive output 1014 for generating a positive DC voltage (generally designated as +v) and a negative output 1016 for generating a negative DC voltage (generally designated as −v). Although one pair of output signals is shown, it should be understood that additional pairs of output signals could be provided to provide DC power to various loads.

Various interconnect elements may be provided to enable an electrical connection between an electrical connector that is accessible to a user of the electrical wiring device and the AC/DC converter circuit 1002. Interconnect elements could be one or more of a portion of a connector element adapted to be attached to a printed circuit board and electrically coupled to a signal line, such as a trace on a printed circuit board. By way of example, an interconnect element 1018 may be coupled to a signal line 1020 to provide a signal from electrical connector 830 to the input 1004 of the AC/DC converter circuit 1002. An interconnect element 1018 may be coupled to a signal line 1020 to provide a signal from electrical connector 830 to the input 1004 of the AC/DC converter circuit 1002. An interconnect element 1022 may be coupled to a signal line 1020 to provide signals from electrical connectors 822 and 824 to the inputs 1006 and 1008 of the AC/DC converter circuit 1002. An interconnect element 1024 may be coupled to signal lines to provide signals from electrical connector 826 and electrical connector 828 to the inputs 1010 and 1012 of the AC/DC converter circuit 1002.

Interconnect elements are also provided to provide output signals generated at the positive output 1014 and the negative output 1016 to electrical connectors that provide DC output signals. More particularly, an interconnect element 1026 may be coupled to the positive output 1014 and the negative output 1016 to provide signals to electrical connector 902 and electrical connector 906. An interconnect element 1028 may be coupled to the positive output 1014 and the negative output 1016 to provide signals to electrical connector 910 and electrical connector 914. An interconnect element 1030 may be coupled to the positive output 1014 and the negative output 1016 to provide signals to electrical connector 918 and electrical connector 922. An interconnect element 1032 may be coupled to the positive output 1014 and the negative output 1016 to provide signals to electrical connector 926 and electrical connector 930. The AC/DC converter circuit 1002 would be implemented in an integrated circuit device or could be implemented using standalone devices.

Turning now to FIG. 11, a bottom left-side perspective view of an AC/DC converter device adapted having a DC input block is shown. According to the implementations of FIGS. 11-13, DC input signals (i.e., +v and −v) may be provided to the device, and selectively provided to DC outputs as shown. A surface 1102 of the AC/DC converter device may comprise a plurality of electrical connectors for receiving DC input signals, also shown here by way of example as pair of a electrical connector and a connector actuator, including for example an electrical connector 1104 and a corresponding connector actuator 1106, an electrical connector 1108 and a corresponding connector actuator 1110, an electrical connector 1112 and a corresponding connector actuator 1114, an electrical connector 1116 and a corresponding connector actuator 1118, an electrical connector 1120 and a corresponding connector actuator 1122, and an electrical connector 1124 and a corresponding connector actuator 1126. According to some implementations, electrical connector 1104 and 1108 may be adapted to receive a first DC input signal (e.g., +v and −v), and electrical connector 1112 and 1116 may be adapted to receive a second DC input signal (e.g., +v and −v). Electrical connector 1120 and 1124 may comprise inputs or outputs for receiving and/or transmitting signals, as will be described in more detail below.

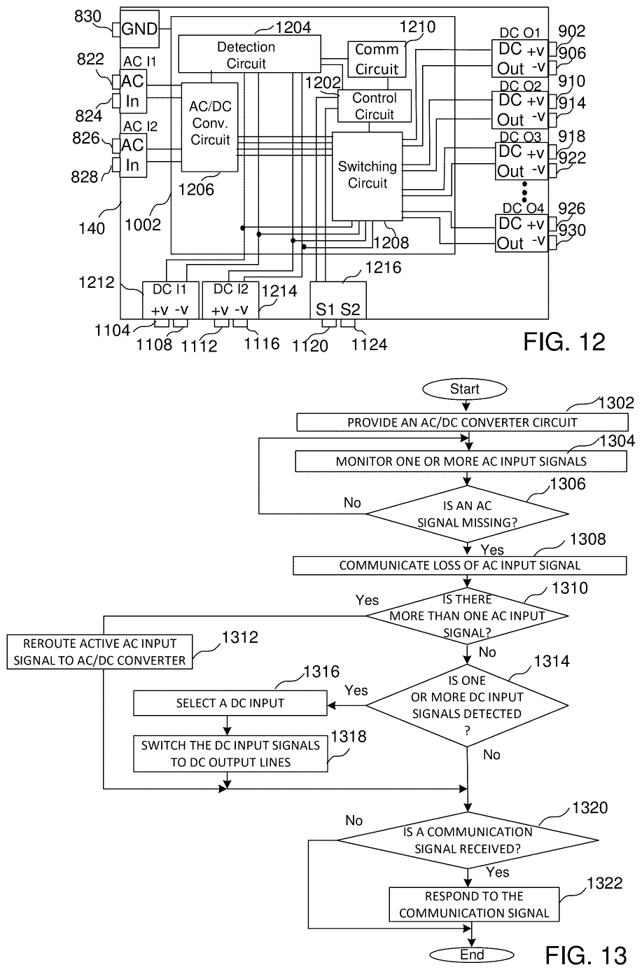

Turning now to FIG. 12, a block diagram of the AC/DC converter device of FIG. 11 is shown. The AC/DC converter device of FIG. 12 comprises a control circuit 1202 coupled to a detection circuit 1204. An AC/DC converter circuit 1206 is adapted to receive one or more AC input signals (e.g., a line and neutral voltage) from one or more AC input signal lines and provide one or more pairs of DC signals (e.g., +v and −v) to a switching circuit 1208 which is adapted to provide DC output signals to various loads by way of the interconnect elements 1026-1032 (designated at DC O1, DC O2, DC O3, and DC O1) and their corresponding electrical connectors. A communication circuit 1210 is also coupled to the control circuit 1202 and the detection circuit 1204 and is adapted to transmit received signals to the control circuit or transmit signals, either using a wired or wireless communication protocol, received from the control circuit 1202 to another device. The communication circuit 1210 may transmit signals received from the detection circuit 1204 to the control circuit 1202 or some other device. According to some implementations, the control circuit could comprise a processor, such as a central processing unit (CPU), a graphics processing unit (GPU), a digital signal processor (DSP), an application-specific integrated circuit (ASIC), a system on a chip, a field programmable device, such as a programmable logic device (PLD) or field programmable gate array (FPGA), or a combination of two or more of these devices.

The AC/DC converter device of FIG. 12 may also comprise an interconnect element 1212 and an interconnect element 1214 that is adapted to receive DC input signals, such as +v and −v DC input signals from a source for providing DC signals other that the AC/DC convert circuit, such as another AC/DC converter device, a backup battery, or an electrical wiring device for example. More particularly, interconnect element 1212 may be configured to receive DC input signals (i.e., +v and −v) from a first source, while interconnect element 1214 may be configured to receive DC input signals (i.e., +v and −v) from a second source. The detection circuit 1204 may detect the loss of AC power based upon the loss of a DC output signal from the AC/DC converter circuit 1206, and the presence or absence of a DC signal received at either of the DC signal inputs (i.e., DC I1 and DC I2). An interconnect element 1216 may enable the transmission or receipt of signals that are provided by or received at the control circuit 1202. The signals provided by or received at the control circuit 1202 may be used for a variety of functions, including both active functions, such as dimming, motion detection, timing, smart switching, etc., and passive functions, such as sensors (including for example a light sensor, motion sensor, camera, microphone, a thermometer, humidity sensor, air quality sensor, or any other sensor that could provide information). Some aspects of the operation of the AC/DC converter device of FIG. 12 will be described below in reference to FIG. 13.

Communication over signal lines between devices can be over dedicated signal lines S1 and S2 or on subcarrier channels on other signal lines, such as the ground or neutral lines. Examples of wired communication protocols that could be implemented include the Digital Addressable Lighting Interface (DALI), which is commonly used in lighting control, or other communication protocols, such as USB, ethernet, RS-232, RS-385, CAN bus, serial peripheral interface (SPI), and Inter-Integrated Circuit (I2C), for example.

Turning now to FIG. 13, a flow chart shows a method of implementing an AC/DC converter device. An AC/DC converter circuit is provided at a block 1302. One or more AC input signals is monitored at a block 1304. It is determined whether an AC signal is missing at a block 1306. If so, the loss of the AC input signal is then communicated at a block 1308. It is also determined whether there is more than one AC input signal at a block 1310. If so, an active AC input signal may be rerouted to an AC/DC converter at a block 1312. If not, it is determined whether there is more than one DC input signals detected at a block 1314. If so, a DC input is selected at a block 1316 and the selected DC input signal is switched to the DC output lines at a block 1318. It is also determined whether a communication signal is received at a block 1320. If so, the communication signal is responded to at a block 1322. The methods set forth in FIG. 13 may be implemented using the circuits and devices of at least FIGS. 8-12 for example as described above or other suitable circuits and devices.

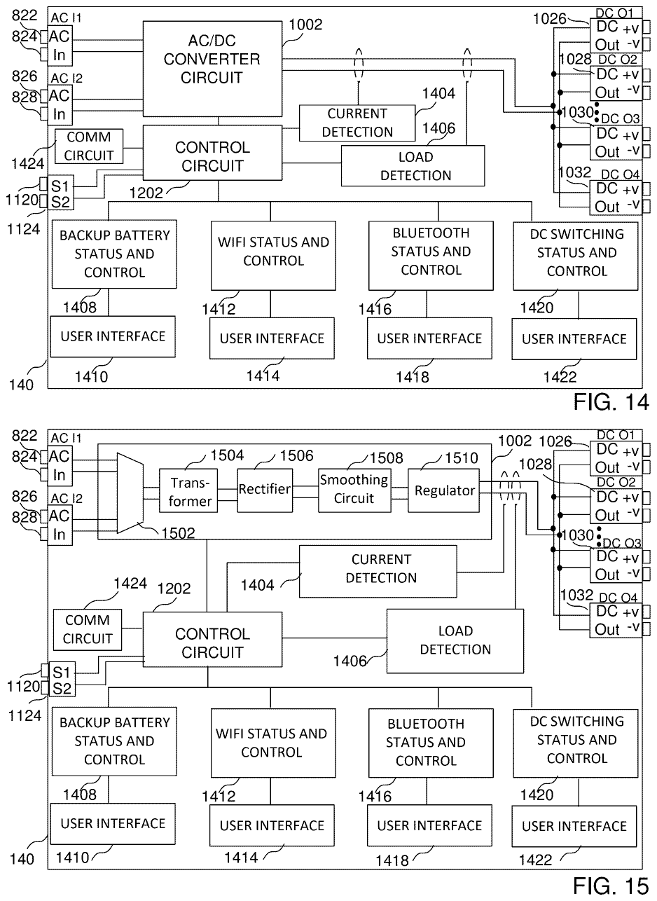

FIGS. 14-16 are block diagrams of AC/DC converter circuits that may be implemented in a wiring device and provide additional functionality beyond AC/DC conversion. Turning first to FIG. 14, a block diagram of the AC/DC converter device of FIG. 11 showing additional user interface elements is shown. A current detection circuit 1404 is provided to detect the amount of current provided by the AC/DC converter circuit 1002. That is, depending upon the load that is coupled to the DC output interfaces DC O1-DC O4, the detected current driven by AC/DC converter circuit 1002 may indicate that the load associated with lighting devices or other devices is greater than it should be. That is, if a constant voltage is output by the AC/DC converter circuit 1002, the current may be reduced below a desired level to drive the lighting devices, and the lighting devices may be fully lit (i.e., they may be dimmed and provide less light than they should). If a constant current is provided, a load detection circuit 1406 may be implemented to enable the detection of a load driven by the AC/DC converter circuit. That is, the resistance of the load can be determined based output voltage and output current of the AC/DC converter circuit. According to some implementations, an indication that the load has exceeded a recommended or desired load resistance value can be provided on a user interface of the AC/DC converter device. According to some implementations, the control circuit may control the AC/DC converter circuit to modify the operation of the AC/DC converter circuit and control the voltage or current provided by the AC/DC converter circuit. For example, the AC/DC converter circuit may alter a voltage or current provided to a load based upon detected qualities of a load, such as resistance of the load or desired power output for the load.

Various other user interface devices could also be provided. For example, a backup battery status and control 1408 and corresponding user interface 1410 may also be provided. The backup battery system may be associated with the building, and provide a DC input signal in response to the loss of an AC input signal that is normally converter to a DC signal. According to some Implementations, the AC/DC converter may be adapted to receive a DC power signal from both from an external device (such as another AC/DC converter, a battery, or some other device) and signals that may be used by a control circuit. For example, the user interface 1410 may provide information such as information related to an available power or capacity associated with a battery, or provide inputs for controlling the use of the backup battery system.

In an implementation of an AC/DC converter device or an electrical wiring device having a wide area wireless connection, shown by way of example here as a WIFI connection, a WIFI status and control circuit 1412 and corresponding user interface 1414 could be implemented. WIFI status information could include a connection indication and a signal strength for example. WIFI control could include user interface elements that enable a connector to a WIFI network or a resetting of a connection. The user interface elements could include a touch screen display or physical actuators such as buttons for example. While WIFI is shown by way of example as a wireless protocol, it should be understood that user interface elements could be employed for other long range wireless communication, such as cellular communication for example.

A Bluetooth status and control circuit 1416 and corresponding user interface 1418 could also be provided. It may be beneficial to provide both a wide range communication interface such as a WIFI interface and a short-range interface such as Bluetooth could be provided. That is, a Bluetooth connection may be established without requiring any authentication such as a password to establish a connection, in contrast to a WIFI connection that may require a password, the Bluetooth connection can establish a communication link to provide the necessary authentication information such as a password to establish a communication link of the WIFI network. While Bluetooth is shown by way of example, it should be understood that any short-range networks (e.g., Near Field Connection (NFC)) could be employed. Wireless communication can be implemented using any known wireless communication protocol, such as WiFi mesh, Zigbee, Z-Wave, Bluetooth Mesh, or a propriety wireless communication protocol. Wired communication may also be implemented using any known wired communication protocol, any propriety wired communication protocol.

A DC switching status and control circuit 1420 and corresponding user interface 1422 could be employed. Various devices described in FIGS. 1-6, including for example an AC/DC converter circuit device 140 or an AC/DC converter circuit implemented in an electrical wiring device, such in the switch and outlet wiring devices having an AC/DC converter circuit or an AC/DC converter circuit in a signal adapter. The various electrical wiring devices of FIGS. 1-6 can be wired to receive DC input signals from multiple AC/DC converter devices. That is, while electrical wiring devices of FIGS. 1-6 that receive a DC signal as an input signal or generate a DC signal as an output signal, the electrical wiring devices that receive a DC signal as an input signal may be adapted to receive a second DC input signal to provide DC power to a load, For example, as shown in FIGS. 11 and 12, a DC input signals (e.g., +v and −V) could be received at inputs DC I1 and DC I2, which could be implemented in the circuit of FIG. 14 as shown in FIG. 12 and as will be described in more detail below. By way of example, if AC power is lost and the AC/DC converter circuit 1002 would not be able to generate a DC power signal, the control circuit may control the application of a DC signal to the DC output interfaces (e.g., DC O1, DC O2, DC O3, and DC O4) as will be described in more detail below.

A communication circuit 1424 is also shown. While signals may be received by the signal inputs S1 and S2 by way of electrical connectors 1120 and 1124, the AC/DC converter may comprise the communication circuit 1424 adapted to receive signals by way of a wireless communication link. The communication circuit may comprise transmitters and receivers for one or more wireless communication protocols, including for example WiFi, Zigbee, Z-Wave, near field communication (NFC), Bluetooth, Matter enabled communication links, and proprietary communication protocol. According to some implementations, a short-range wireless communication link that does not require any type of authorization or authentication, such as Bluetooth or NFC, may be relied upon to establish an initial communication that would allow a user to provide the necessary authentication or authorization to establish a second communication, such as WIFI.

It should be understood that, while the various interface elements of FIG. 14 may not be shown in all of the block diagrams of circuits implemented in AC/DC converter devices or electrical wiring devices, the interface elements of FIG. 14 could be implemented in any of the AC/DC converter devices or electrical wiring devices as described below.

Turning now to FIG. 15, another block diagram of the AC/DC converter device of FIG. 11 showing additional details of the AC/DC converter circuit is shown. According to one, the AC/DC converter circuit 1002 may comprise a multiplexer 1502, controlled by the control circuit, that is adapted to select one of the input interfaces AC I1 or AC I2 the provides the AC inputs signals (i.e. line and neutral). A transformer 1504 generates a DC output signal that is processed by a rectifier 1506, a smoothing circuit 1508, and a regulator circuit 1510 to generate the +v and −v signals. While the example of the AC/DC converter circuit 1002 is shown in FIG. 15 by way of example, it should be understood that other AC/DC converter circuits could be implemented.

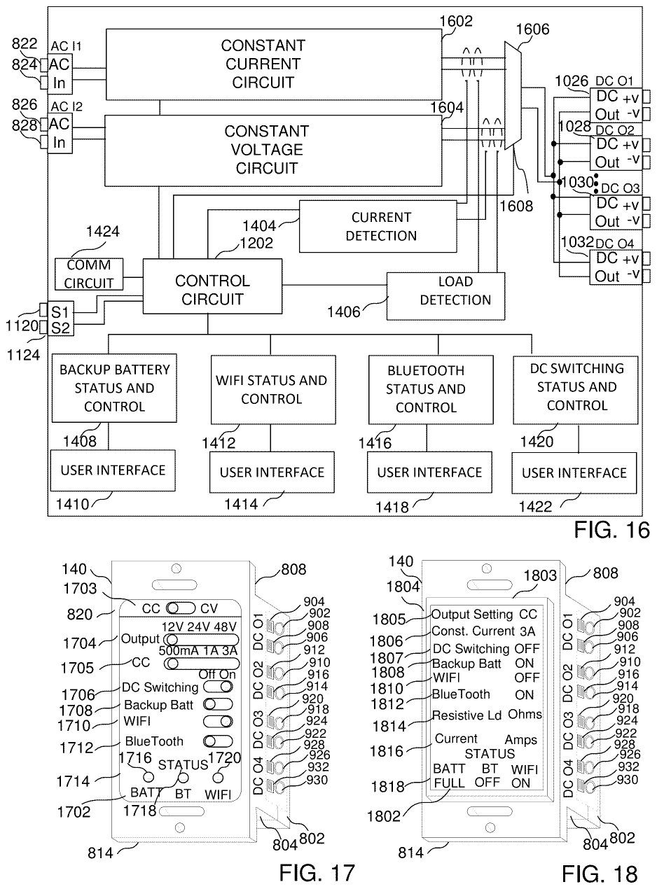

Turning now to FIG. 16, another block diagram of the AC/DC converter device of FIG. 11 showing selectable AC/DC converter circuits is shown. Depending upon application of the AC/DC converter circuit, it may be beneficial in some instances to generate a constant current to drive DC loads and in other instances to generate a constant voltage, as will be described in more detail below. According to the implementation of FIG. 16, the AC/DC converter device comprises a constant current circuit 1602 adapted to generate a constant current output to the DC outputs DC 01-DC 04, and a constant voltage circuit 1604 adapted to generate a constant voltage output to the DC outputs DC 01-DC 04. A selection circuit 1606 controlled by the control circuit 1202 is coupled to the outputs of the constant current circuit 1602 and the constant voltage circuit 1604. control input 1608 to select whether a constant DC current signal or a constant voltage DC signal is provided to the DC outputs DC 01-DC 04.

Example user interface arrangements for an AC/DC converter device, such as the AC/DC converter device of FIGS. 14-16 are shown in FIGS. 17 and 18, where mechanical or electrical aspect of user interface elements are implemented. Turning first to FIG. 17, a perspective view of an AC/DC converter device having a user interface comprising user selectable switches is shown. The AC/DC converter device of FIG. 17 may comprises a user interface 1702, an output voltage actuator 1703, a voltage mode selector interface 1704, a current mode selector interface 1705, a DC switching selection interface 1706, a backup battery selection interface 1708, a WiFi control interface 1710, a Bluetooth control interface 1712, a status interface 1714, a battery status indicator 1716, a Bluetooth status indicator 1718, and a WiFi status indicator 1720. While various slide-type mechanical actuators are shown by way of example, it should be understood that the user interface or a portion of the user interface may comprise a touchscreen display, as will be described in more detail in reference to FIG. 18. According to some implementations, the user interface 1702 could be accessed by a user by removing the wall plate that is attached to the AC/DC converter circuit, or by opening a cover on the wall plate of the AC/DC converter circuit.

Turning now to FIG. 18, a perspective view of an AC/DC converter device having a user interface comprising a touchscreen user interface is shown. According to the implementation of FIG. 18, user interface elements, shown by way of example in FIG. 18 as a touchscreen display, may be accessible in an opening in wall plate, such as a Decora brand wall plate available from Leviton Manufacturing Co., Inc. A user interface 1802 of the AC/DC converter device may comprise a raised portion 1803 which is surrounded by a surface 1804 that is adapted to receive the wall plate. That is, an edge of the wall plate that surrounds the opening will be adjacent to the surface 1804 and may abut the surface 1804 when the wall plate is attached to the AC/DC converter device.

The user interface may be a touchscreen user interface having an output setting field 1805, a constant current selection field 1806, a DC switching field 1807, a backup battery field 1808, a WiFi control field 1810, a Bluetooth control field 1812, a resistive load field 1814 which may indicate the resistance (in Ohms for example) of the load attached to the AC/DC converter circuit, a current field 1816 which may indicate the current (in Amps for example) driving the load, and a status field 1818. By way of example, the status filed may include the status associated with a battery, such as a backup battery of the AC/DC converter device or a backup battery for the system in which the AC/DC converter circuit is being used, a status of a Bluetooth (BT) circuit and a status of a WIFI circuit. While a touch screen display is shown by way of example, it should be understood that the user interface or a portion of the user interface may comprise physical actuators, such as the slide-type mechanical actuators described in reference to FIG. 17. While various user interface elements are shown, it should be understood that fewer or additional user interface elements could be implemented within the spirit and scope of the disclosure.

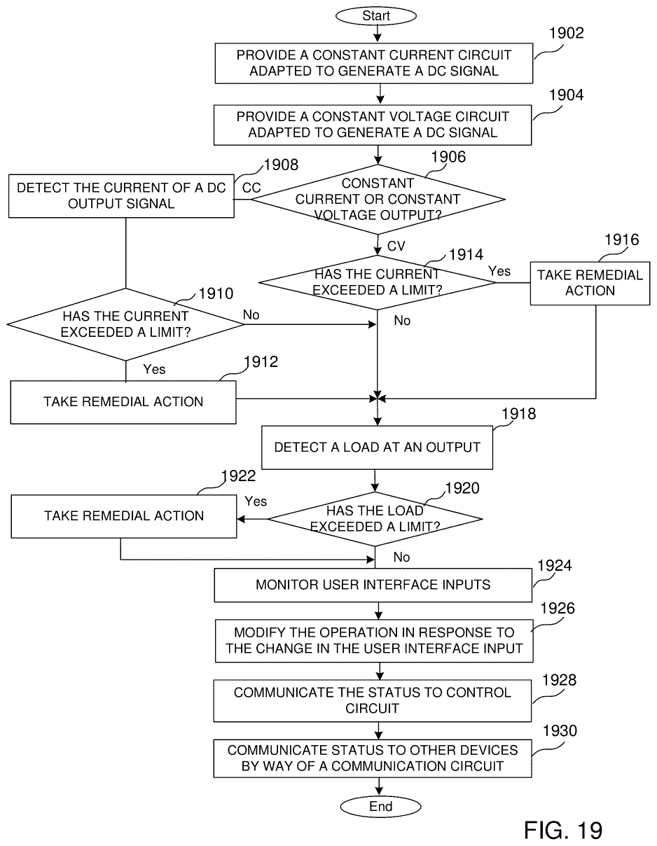

Turning now to FIG. 19, a flowchart shows a method of implementing an AC/DC converter device having a constant current circuit and a constant voltage circuit. A constant current circuit adapted to generate a DC signal is provided at a block 1902. A constant voltage circuit adapted to generate a DC signal is provided at a block 1904. It is determined whether a selection of a constant current circuit or a constant voltage circuit is made at a block 1906. If constant current is detected, the current of a DC output signal is detected at a block 1908. It is also determined whether the current has exceeded a limit at a block 1910. If so, remedial action is taken, such as by providing a warning signal or disable the circuit at a block 1912. If the constant voltage is detected, it is determined whether the current has exceeded a current limit at a block 1914. If so, remedial action may be taken at a block 1916. A load at an output is then detected at a block 1918. It is also determined whether the load has exceeded a limit at a block 1920. If so, remedial action is taken, such as by providing a warning signal or disable the circuit, at a block 1922. User interface inputs are monitored at a block 1924. The operation is modified in response to the change in the user interface input at a block 1926. The status is communicated to the control circuit at a block 1928, and the status is communicated to other devices by way of a communication circuit at a block 1930. The methods set forth in FIG. 19 may be implemented using the circuits and devices of at least FIGS. 8-18 for example as described above and implemented in the arrangements of FIGS. 1-6 for example, or other suitable circuits and devices.

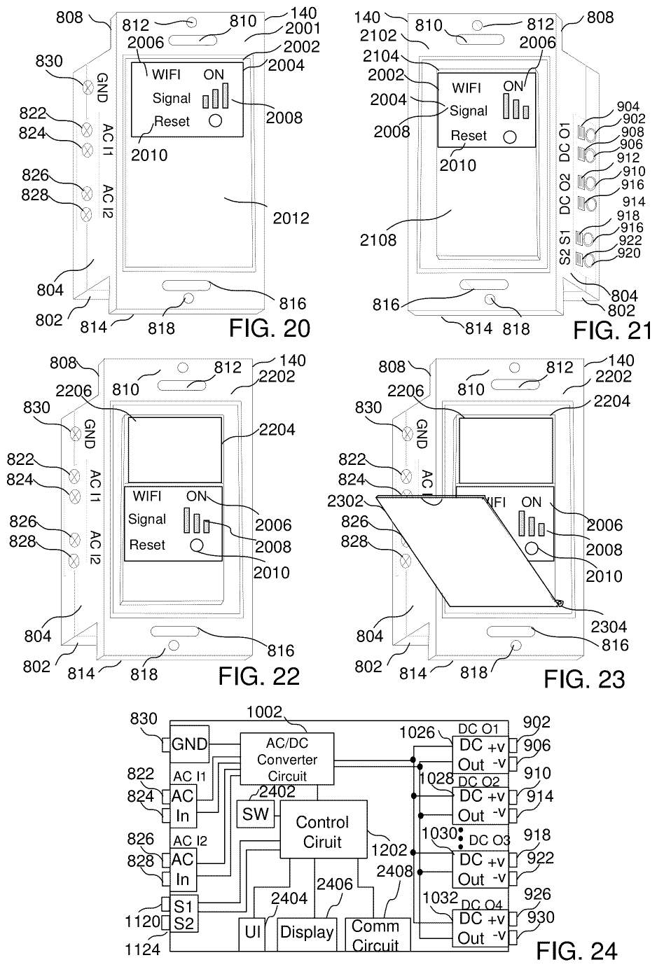

FIGS. 20-24 show additional user interface arrangements for AC/DC converter devices are shown. According to the implementations of FIGS. 20 and 21, a reduced user interface providing information is shown. Turning first to FIG. 20, a left-side perspective view of an AC/DC converter device comprising a wireless communication circuit and a user interface adapted to be located behind a wall plate, and accessible when the wall plate is removed or when a movable cover of the wall plate is opened, is shown. The AC/DC converter device comprises a surface 2001 adapted to receive a wall plate and a user interface 2002 that comprises a display 2004. The display 2004 may comprise a touchscreen display having WiFi status field 2006, a signal strength field 2008, and a reset field 2010. According to some implementations, the WIFI status field 2006 may be responsive to a touch on the display to turn on or off WIFI connection. Similarly, the reset field 2010 may be responsive to a touch on the display to reset the WIFI connection. A surface 2012 below the display 2004 may optionally comprise other user interface elements, such as another display, LED indicators or various user interface actuators as shown in FIG. 17 for example.

Turning now to FIG. 21, a left-side perspective view of an AC/DC converter device comprising a wireless communication circuit and a user interface adapted to extend through an opening of a wall plate as described above in reference to FIG. 18 is shown. The AC/DC converter device of FIG. 21 comprises a surface 2102 for receiving a wall plate and a raised portion 2104 adapted to extend through an opening of a wall plate, such a Decora wall plate as described above. The AC/DC converter device may also comprise a surface 2108 below the display, where the surface 2108 may also be adapted to include another display, LED indicators or various user interface actuators as shown in FIG. 17 for example.

According to the implementations of FIGS. 22-24, the AC/DC converter circuit may be associated with an electrical wiring device comprising a switch. Turning now to FIG. 22, a left-side perspective view of an AC/DC converter device comprising a switch and a user interface adapted to extend through an opening of a wall plate is shown. The AC/DC converter device comprises a surface 2202 adapted to receive a wall plate and a raised portion 2204. That is, the perimeter of an opening of the wall plate is adapted to be adjacent to or abutting the surface 2202 and the raised portion 2204 is adapted to extend through the opening of the wall plate. A switch actuator 2206 accessible by the user through the opening of the wall plate is also shown. The operation of the switch of the AC/DC converter device will be described in more detail below in reference to FIG. 24.

Turning now to FIG. 23, a left-side perspective view of the AC/DC converter device of FIG. 20 having a movable cover is shown. The implementation of a cover 2302 having a hinge 2304 enables a user to easily see the display of the AC/DC converter device when necessary but hiding the display when it is necessary. According to some implementations, the cover 2302 may be removable so that the display is always exposed.

Turning now to FIG. 24, a block diagram of an AC/DC converter device having a user interface is shown. In addition to the elements of the AC/DC converter device of FIG. 12, the block diagram of the AC/DC converter device of FIG. 24 discloses a switch 2402 coupled to the control circuit 1202 and responsive to the switch actuator 2206. That is, the switch 2402 will provide a signal to the control circuit 1202, which will control the operation of the AC/DC converter circuit to apply a DC load to the DC output interfaces DC 01-DC 04. By way of example, the switch 2402 may provide a toggle signal to the control circuit instructing the control circuit to change the state of the output of the AC/DC converter circuit (e.g., provide a DC output signal to the to the DC output interfaces if a DC output signal is not provided or vice versa), for example if the actuator is a push button actuator, the selection of which indicates that the state should be changed. Alternatively, the switch 2402 may provide either an “on” signal or an “off” signal indicating that a DC signal should be applied to the DC output interfaces DC 01-DC 04, for example if the actuator is a toggle-style actuator, the selection of which indicates an on condition or an off condition. The AC/DC converter device of FIG. 24 may also comprise a user interface 2404, a display 2406, and a communication circuit 2408.

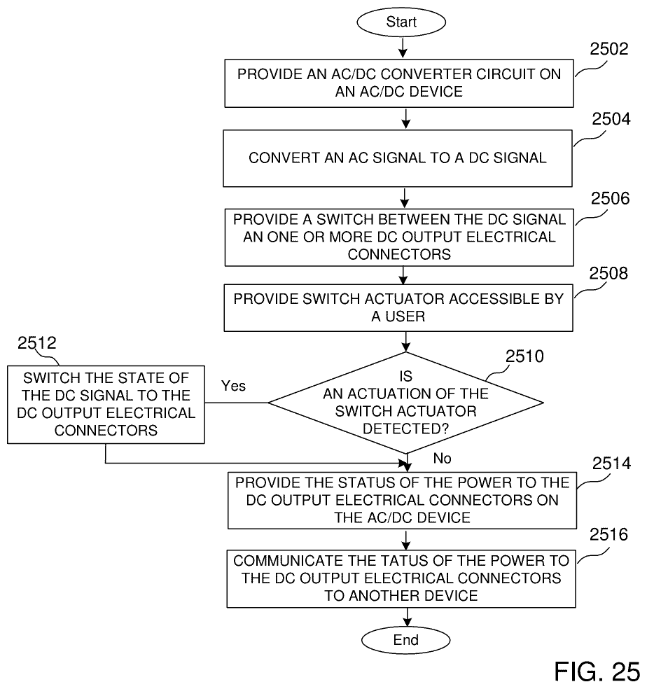

Turning now to FIG. 25, a flow chart shows a method of implementing an AC/DC converter device having a user interface. An AC/DC converter circuit is provided on an AC/DC device at a block 2502. An AC signal is converted to a DC signal at a block 2504. A switch is provided between the DC signal an one or more DC output electrical connectors at a block 2506. A switch actuator accessible by a user is provided at a block 2508. It is also determined whether an actuation of the switch actuator is detected at a block 2510. If so, the state of the DC signal to the DC output electrical connectors is switched at a block 2512. The status of the power to the DC output electrical connectors on the AC/DC device is provided at a block 2514. The status of the power to the DC output electrical connectors is communicated to another device at a block 2516. The methods set forth in FIG. 25 may be implemented using the circuits and devices of at least FIGS. 20-24 for example as described above or other suitable circuits and devices.

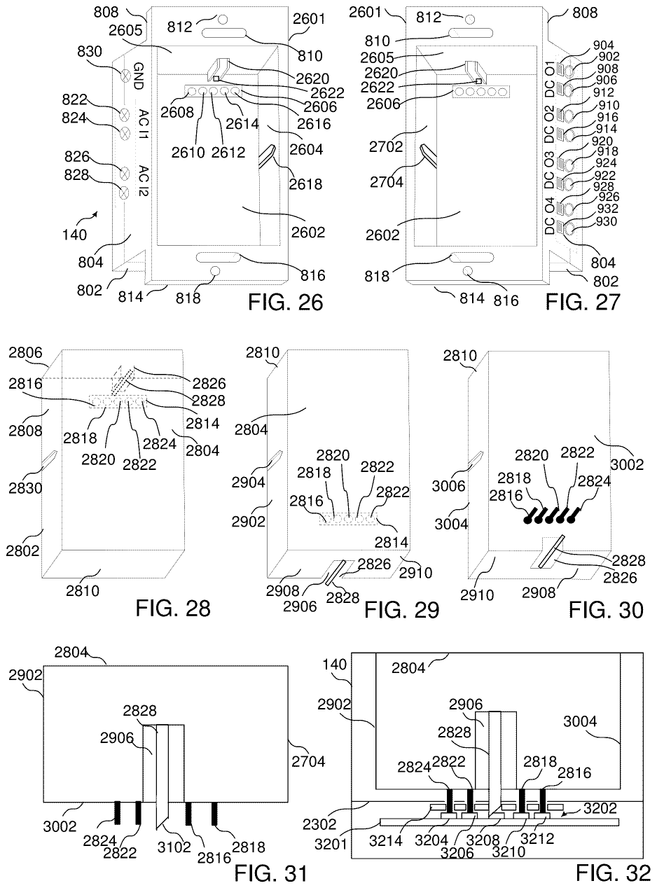

FIGS. 26-38 show various implementations of AC/DC circuits, shown here as adapted to be coupled to a junction box, and having a removable AC/DC converter component. According to various implementations, AC/DC converter circuits and electrical wiring devices may be implemented with 2 components that may be detachably coupled. For example, the AC/DC converter circuits and electrical wiring devices may comprise a base portion and a signal adapter. According to some implementations, the base portion and the signal adapter may be partitioned according to a full partition. That is, elements that a user is able to interact with are on the signal adapter. According to some implementations of an AC/DC converter circuits and electrical wiring device having a full partition, the signal adapter will substantially occupy the region of the opening of a wall plate. According to other implementations, the base portion and the signal adapter may be partitioned according to a partial partition. That is, some of the elements that a user may interact with, such as a switching actuator as will be described in more detail below, will be on the base portion and other elements that a user may interact with may be on the signal adapter. According to some implementations, the elements that a user may interact with on the base portion and signal adapter may extend through an opening of a wall plate. However, it should be understood that, in either a full partition or partial partition arrangement, elements that a user may interact with may be positions in a region of the base portion adapted to receive the signal adapter. Turning first to FIG. 26, a left-side perspective view of a base portion adapted to receive signal adapter is shown. The AC/DC converter circuit device 140 of FIG. 26 comprises a base portion 2601 having a rear surface 2602 of an open region having side wall 2604 and top wall 2605, where another corresponding side wall of the open region (shown in FIG. 27) is opposite side wall 2604 and a bottom wall opposite the top wall 2605. That is, as shown in the right-side perspective view of a base portion adapted to receive signal adapter, the base portion 2601 comprises a side wall 2702 and another alignment element 2704 on the side wall 2702.

A plurality of openings 2606, shown by way of example on the rear surface 2602, comprises an opening 2608, an opening 2610, an opening 2612, an opening 2614, and an opening 2616. Each of the openings leads to an electrical connector of the base portion, such as a contact pad on a printed circuit board or other contact element adapted to mate with a contact element of a removable AC/DC converter component. The base portion 2601 may also comprise an alignment element 2618 for guiding a removable AC/DC converter circuit into the opening of the base portion. The base portion 2601 may also comprise an alignment element 2620, which also helps align the AC/DC converter component to the base portion, and an opening 2622 for receiving an actuator of an AC/DC converter component adapted to engage a tamper resistance element. While the contact elements below the plurality of openings 2606 may be coupled to low voltage DC signals, a tamper resistance element may be provided to prevent contact to other elements of the base portion, such as an element coupled to a high voltage AC signal. Examples of tamper resistance elements will be described in more detail below.

FIGS. 28-31 show various perspectives of a signal adapter configured to be attached to a base portion of an AC/DC converter circuit device. By providing a signal adapter that operates as an AC/DC converter circuit, it is possible to change or upgrade the functionality of AC/DC converter circuit. Turning first to FIG. 28, a right-side and bottom perspective view of a signal adapter configured to be electrically and mechanically coupled to the base portion is shown. A signal adapter 2802 may be configured to be received by the base portion of FIG. 26, and may comprise a front surface 2804, a top surface 2806, a side surface 2808, a bottom surface 2810 and an electrical interface 2814. The signal adapter comprises a plurality of contact elements which may include a contact element 2816, a contact element 2818, a contact element 2820, a contact element 2822, and a contact element 2824. The plurality of contact elements is adapted to make an electrical connection to a plurality of contact elements behind the plurality of openings 2608. The signal adapter may also comprise an alignment element 2826 adapted to mate with corresponding alignment element 2620 of the base portion, an actuator element 2828 adapted to enter the opening 2622 of the base portion and move a tamper resistant element, and alignment element 2830 adapted to mate with the alignment element 2704. The contact element could be any type of element adapted to conduct current, such as a metal material as is commonly known.

Turning now to FIG. 29, a right-side and top perspective view of a signal adapter configured to be electrically and mechanically coupled to the base portion is shown. Based upon the perspective view of FIG. 29, a side surface 2902, an alignment element 2904, and an opening 2906 is shown. A first portion 2908 is shown on the top surface and second portion 2910 of the top surface. As shown in left-side and top perspective view of a signal adapter configured to be electrically and mechanically coupled to the base portion of FIG. 30, a rear surface 3002, a side surface 3004, and an alignment element 3006 is visible. In the top perspective view of a signal adapter configured to be electrically and mechanically coupled to a base portion of FIG. 31, a beveled edge 3102. of the actuator element 2828 enables the movement of a tamper resistant element.

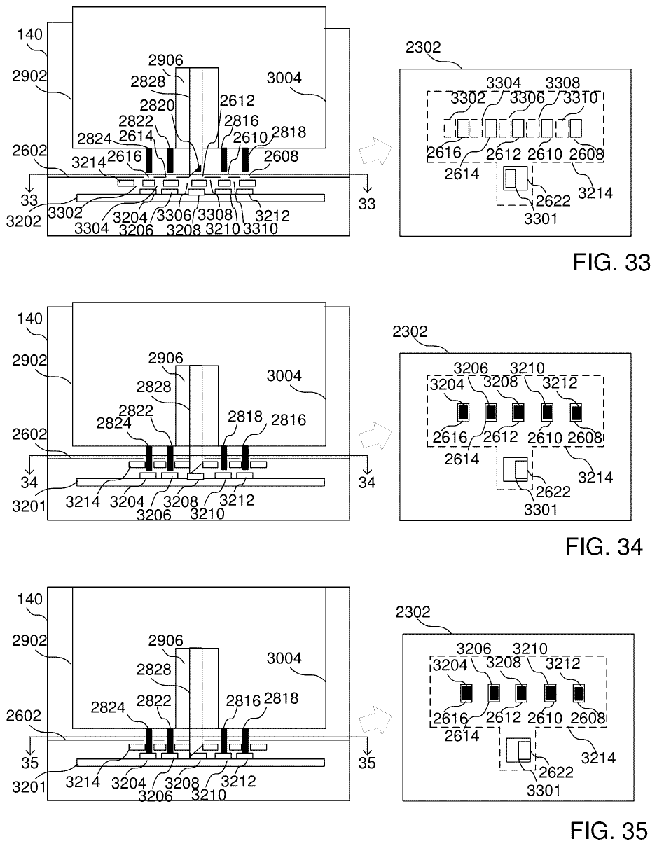

Turning now to FIG. 32, a cross-sectional view of a signal adapter electrically and mechanically coupled to a base portion is shown. When contact elements may carry a high voltage, it may be beneficial to include tamper resistance elements. When coupling a signal adapter to a base portion, contact elements of the base portion may be exposed. Depending upon the voltages on the contact elements of the base portion or voltages that are input to the base portion, it may be necessary to provide a tamper resistant element to prevent a user of the device making contact to a voltage that may be unsafe. As shown in the cross section of FIG. 32, a circuit board 3201 comprises a plurality of contact elements adapted to make an electrical connection to contact elements of the signal adapter. More particularly, an electrical interface 3202 comprises a plurality of contact elements, including a contact element 3204, a contact element 3206, a contact element 3208, a contact element 3210, and a contact element 3212. Although the contact elements of the electrical interface 3202 are shown by way of example as contact pads, it should be understood that other types of contact elements could be implemented. When the signal adapter is attached to the base portion, contact element 2824 is electrically connected to contact element 3204, contact element 2822 is electrically connected to contact element 3206, contact element 2820, which is obscured by actuator element 2828, is electrically connected to contact element 3208, contact element 2818 is electrically connected to contact element 3210, contact element 2816 is electrically connected to contact element 3212, as shown. The base portion may also include a tamper resistant element 3214. As will be described in more detail below, the tamper resistant element 3214 may comprise a movable shutter element, the openings of which will align with contact elements on the circuit board 3201 to enable the electrical connections, as will be described in more detail in reference to FIGS. 33-35.

FIGS. 33-35 is a sequence of figures showing the attachment of a signal adapter to a base portion of an AC/DC converter device, and more particularly, the movement of a tamper resistant element to enable the contact elements of the signal adapter to make an electrical connection to a corresponding contact elements of the base portion. For each of the FIGS. 33-35, the cross section is shown on the right to provide a plan view of the location of the openings of the tamper resistant element, where an opening is shown in dashed lines when it has not yet aligned with the openings in the bottom of the base portion that are adapted to receive the contact elements of the signal adapter. Turning first to FIG. 33, a first cross-sectional view of a base and a signal adapter including the alignment of openings of a tamper resistance element with openings of a rear wall of the base is shown. A guide 3301 of the tamper resistant element is provided to enable the tamper resistant element to be moved (to the right in the top perspective view, to allow the plurality of openings of the tamper resistance element to align with the openings in the rear surface 2602 of the base portion. As shown in both the cross-sectional view and the plan view to the right, the plurality of openings in the tamper resistant element includes an opening 3302, an opening 3304. opening 3306, an opening 3308 and an opening 3310, where the openings of the tamper resistant element do not align with the openings of the rear surface 2602, and therefore the contact elements on the printed circuit board are not exposed.

However, as the actuator element 2828 engages the guide 3301 of the tamper resistant element, the tamper resistant element moves to the right as shown, and the contact elements of the printed circuit board are exposed, and the contact elements of the signal adapter are close to make and electrical connection to the contact elements on the printed board, as shown in FIG. 34. As shown in FIG. 35, the contact element of the signal adapter makes an electrical connection to the contact elements of the base portion. Because the contact elements of the base portion have a larger cross-section than the contact elements of the signal adapter, only the contact elements of the base portion are labeled. However, it should be understood that the contact elements would also be shown in the plan view on the right side of FIG. 34 and FIG. 35.

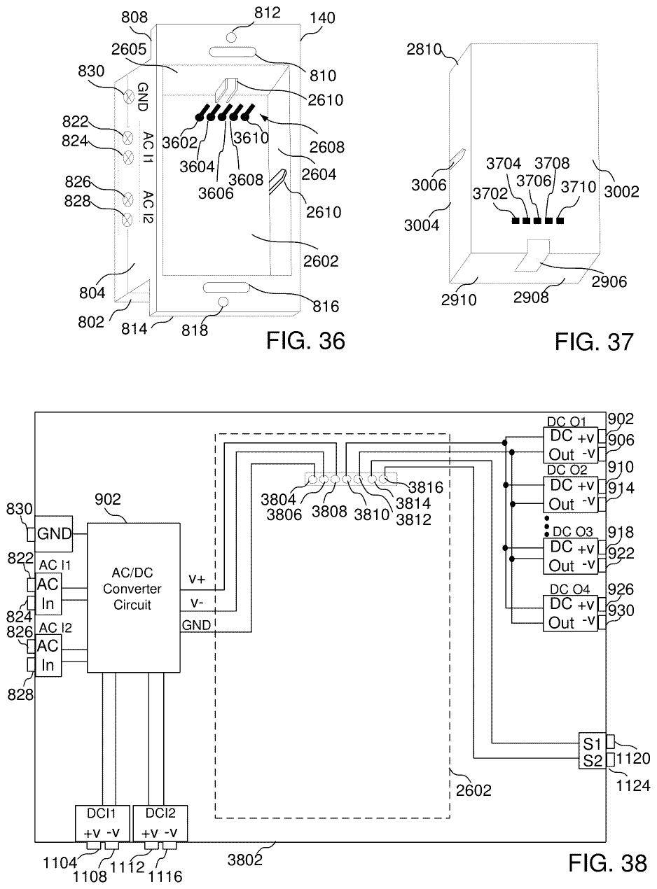

FIGS. 36 and 37 show an implementation where the contact elements of the base portion extend from the rear surface 2602. That is, if the voltage levels of the signals provided by the plurality of contact elements of FIG. 36, and more particularly, contact element 3602, contact element 3604, contact element 3606, contact element 3608, and contact element 3610 comprise low voltage signals that are not harmful if a user of the base portion comes into contact with the contact elements, a tamper resistant element would not be needed, and the contact elements could extend from the bottom of the base portion. According to some implementations, the contact elements may comprise a pin, such as a pogo pin. Turning first to FIG. 36, a left-side perspective view of another base portion adapted to receive signal adapter is shown. (shown by way of example as a pin or pogo-pin). As shown in the left-side and top perspective view of the signal adapter of FIG. 37, which is configured to be electrically and mechanically coupled to the base portion of FIG. 36, corresponding contact pads may be provided on the signal adapter rather than the base portion. That is, a contact element 3702 is adapted to make electrical and mechanical contact to the contact element 3602, a contact element 3704 is adapted to make electrical and mechanical contact to the contact element 3604, a contact element 3706 is adapted to make electrical and mechanical contact to the contact element 3606, a contact element 3708 is adapted to make electrical and mechanical contact to the contact element 3608, and a contact element 3710 is adapted to make electrical and mechanical contact to the contact element 3610. While various examples set forth below show an arrangement where contact elements comprising pins on a signal adapter make electrical connections to contact pads on the base portion, it should be understood that contact elements comprising contact son a signal adapter make electrical connections to pins on the base portion as shown in FIGS. 36 and 37.

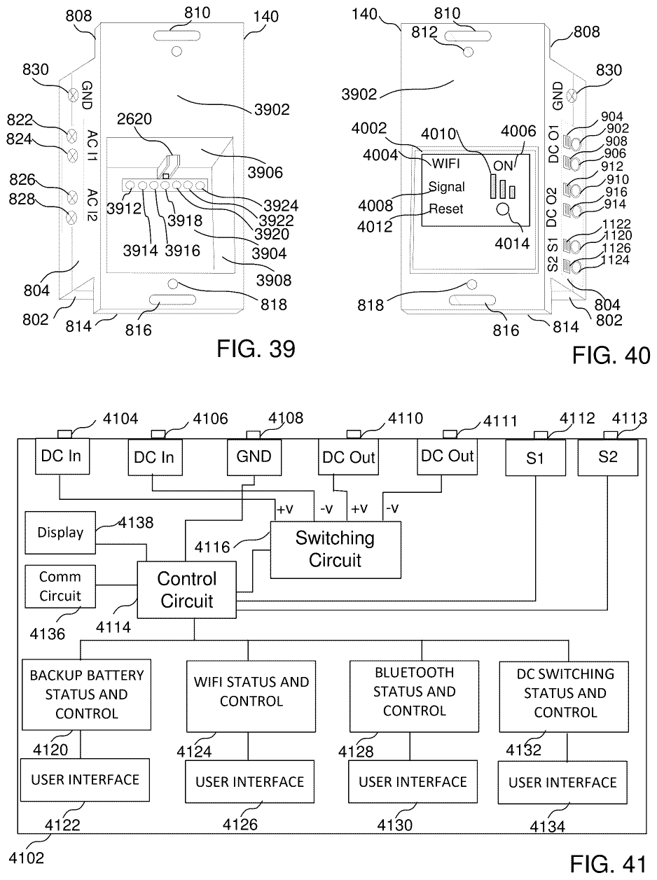

Turning now to FIG. 38, a block diagram of a base portion of an electrical wiring device having a plurality of AC and DC input connectors and DC output connectors is shown. The block diagram of FIG. 38 comprises elements of FIG. 12 in the base portion 3802 and a plurality of contact elements, which may be accessed through openings in the base portion as described above, comprising a contact element 3804 adapted to receive a +v DC signal, a contact element 3806 adapted to receive a −v DC signal, and a contact element 3808 adapted to receive a ground signal. Contact elements are also provided for providing the −v DC and +DC signals, received by the signal adapter and provided to the DC output interfaces DC 01-DC 04, More particularly, a contact element 3810 and a contact element 3812 provide the +v DC signal and the −v DC signal to the DC output interfaces DC O1-DC O4, Contact element are adapted to provide communication signals, shown here by way of example as a contact element 3814 adapted to transmit or receive a first communication signal and a contact element 3816 adapted to transmit or receive a second communication signal. The signal adapter may provide a number of functions. While a signal adapter according to one implementation may merely pass the DC signal received at contact elements 3806 and 3808 to contact elements 3810 and 3812 comprising DC signal outputs, other signal adapters may provide control functions for applying the DC signals to the DC output interfaces DC O1-DC O4. For example, the signal adapter may function as a timer to apply the DC signals to the DC output interfaces, regulate an output voltage of the DC output interfaces, regulate an output current provided to the DC output interfaces, or provide other control of the signals provided to the DC output interfaces, as will be described in more detail below. While the AC/DC converter circuit is shown in the base portion and other functions may be provided in a signal adapter, as will be described in more detail below, It should be understood that the circuit diagram of FIG. 38 could be implemented in a base portion receiving a larger signal adapter, such as the base portion of FIG. 26 or a base portion adapted to receive a smaller signal adapter, such as the base portion of FIG. 39.

Turning now to FIG. 39, a left-side perspective view of a base portion of an electrical wiring device having an electrical interface adapted to receive DC signals and a region for receiving a signal adapter is shown. According to the implementation of FIGS. 39 and 40, a signal adapter may occupy a smaller area of the base portion compared to the embodiments of FIGS. 26-37 described above. The base portion of FIG. 139 comprises a front surface 3902 and a rear surface 3904 of an opening adapted to receive a signal adapter formed by walls or surfaces that extend upward from the rear surface, including a top surface 3906 and a side surface 3908, which are visible in FIG. 39, and a bottom surface opposite the top surface 3906 and another side surface opposite side surface 3908. The rear surface 3904 comprises a plurality of openings, including an opening 3912, an opening 3914, an opening 3916, an opening 3918, an opening 3920, an opening 3922, and an opening 3924 that are adapted to receive contact elements of a signal adapter to make an electrical connection to corresponding contact elements behind the plurality of openings. The base portion may also comprise a tamper resistant element as described above in reference to FIG. 36. According to some implementations, signal adapters adapted to be received in an opening of a base portion of FIG. 39 may also be received in an opening of a base portion comprising a receptacle, as will be described in more detail below. Such an arrangement may provide an advantage that signal adapters providing certain functionality, such as a sensor associated with another system in the building for example, may be able to pe placed in a variety of locations, such as in a base portion having a switch or in a base portion having a receptacle.

Turning now to FIG. 40, a left-side perspective view of a base portion of an electrical wiring device having a signal adapter inserted in the opening of the base portion of FIG. 39 is shown. The signal adapter 4002 may comprise a communication field 4004, which may indicate the type of communication signal provided by the signal adapter, shown here by way of example as a WIFI communication, and a status 4006, which shows here by way of example as being “on. According to some implementations, a display of the signal adapter could be a touch screen display, where one or both of the communication field and the status field could be selected by the touch of a finger to change the type of communication enabled, such as changing WIFI to Bluetooth, or changing the status from “ON” to “OFF”. The display of the signal adapter may also comprise a signal quality field 4008, showing by way of example as a signal strength, and a signal value field 4010, showing a bar graph to show the signal field. It should be understood that the signal quality field could be changed by a selection of the touch screen interface to select some other measure of signal quality, such as upload or download rate for example. The signal adapted may also comprise a reset field 4012 and a reset field status indicator 4014. For example, a reset could be initiated by the selection of the reset field 4012 on a touch screen of the signal adapter, where the reset field status indicator 4014 may indicate a state of the reset operation based upon a different color. While certain information fields and interfaces are shown in the signal adapter of FIG. 40, it should be understood that a greater number or fewer information fields and interfaces could be implemented. It should also be understood that an attachment element for attaching the signal adapter to the base portion could be implemented, as will be described in more detail below.

Turning now to FIG. 41, a block diagram of a signal adapter configured to be received by a base portion having an electrical interface adapted to receive DC signals is shown. The signal adapter 4002 may comprise an electrical interface including a contact element 4104 adapted to receive a DC input, which may be the −v signal received from the contact element 3804 for example, a contact element 4106, adapted to receive DC input signal, such as the +v DC signal from the contact element 3806, a contact element 4108 adapted to receive a ground signal, such as the ground signal from the contact element 3808, a contact element 4110 adapted to provide-v DC output signal, such as to the contact element 3810, a contact element 4111 adapted to provide a +v DC output signal, such as to the contact element 3812, a contact element 4112 adapted to provide an first communication signal designated as an S1 communication signal to a contact element 3814, and contact element 4113 adapted to provide a second communication signal, such as a S2 communication signal to a contact element to a contact element 3816. The signal adapter also comprises a control circuit 4114, adapted to control a switching circuit 4116. The control circuit 4114 may be one or more of a processor, such as a central processing unit (CPU), a graphics processing unit (GPU), a digital signal processor (DSP), an application-specific integrated circuit (ASIC), a system on a chip, a field programmable device, such as a programmable logic device (PLD) or field programmable gate array (FPGA), or a combination of two or more of these devices. The switching circuit may provide control the application of the DC output signals received from contact elements 4104 and 4106 and provided to the contact elements 4110 and 4111. The switching circuit may comprise one or more switches to pass the input DC signals (+v and −v) to the DC outputs (+v and −v). According to some implementations, the switching circuit may comprise a multiplexer for example to receive multiple input DC signals (e.g., DC input signals from different sources) to different DC output contact elements to drive different loads.

The signal adapter 4102 adapted to provide DC power may comprise a variety of control circuits and corresponding user interface elements. For example, the signal adapted may comprise a backup battery status and control circuit 4120 and a corresponding user interface 4122. The signal adapted may also comprise a WiFi status and control circuit 4124 and a corresponding user interface 4126. The signal adapted may also comprise a Bluetooth status and control circuit 4128 and a corresponding user interface 4130. The signal adapted may also comprise a DC switching status and control circuit 4132 and a corresponding user interface 4134. While the various control circuits are shown separate from the control circuit 4114, it should be understood that they could be a part of the control circuit 4114. The user interface elements are described above.

According to some implementations, the communication circuit 4136. The communication circuit could implement any wireless or wired communication protocols. A display 4138 may also be provided to display information such as that shown in FIG. 40 for example, or other information.

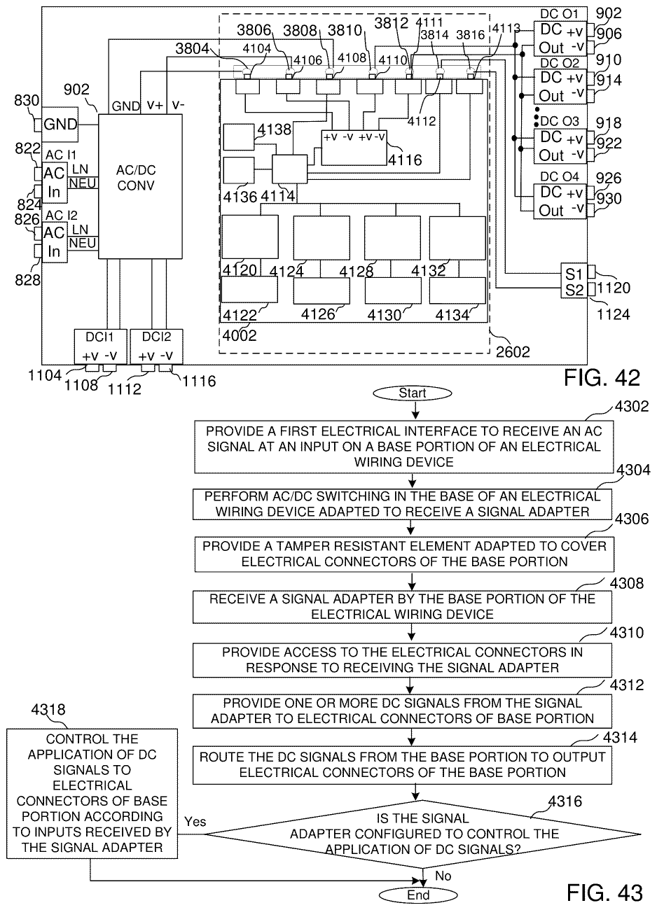

Turning now to FIG. 42, a block diagram of an electrical wiring device having the base portion of FIG. 40 and the signal adapter of FIG. 41 is shown. According to the implementation of FIG. 42, the electrical wiring device could operate as a switch in addition to operating as an AC/DC converter circuit. By providing the functionality in a signal adapter, it is easy to upgrade the AC/DC converter circuit or other functions associated with the signal adapter. It should be noted that by providing DC input contact elements, it is possible to make the base a universal base, where either a signal adapter that is adapted to receive an AC input signal (and generate a DC signal in the signal adapter) or a signal adapter adapted to receive a DC input signal could be used.

Turning now to FIG. 43, a flow chart shows a method of implementing an electrical wiring device having a base portion and a signal adapter. A first electrical interface to receive an AC signal at an input on a base portion of an electrical wiring device is provided at a block 4302. An AC/DC switching is performed in the base of an electrical wiring device adapted to receive a signal adapter at a block 4304. A tamper resistant element adapted to cover electrical connectors of the base portion is provided at a block 4306. A signal adapter is received by the base portion of the electrical wiring device at a block 4308. Access to the electrical connectors is provided in response to receiving the signal adapter at a block 4310. One or more DC signals is provided from the signal adapter to electrical connectors of base portion at a block 4312. The DC signals is routed from the base portion to output electrical connectors of the base portion at a block 4314. It is also determined whether the signal adapter is configured to control the application of DC signals to electrical connectors of base portion at a block 4316. The application of DC signals to electrical connectors of base portion is controlled according to inputs received by the signal adapter at a block 4318. The methods set forth in FIG. 43 may be implemented using the circuits and devices of at least FIGS. 26-42 for example as described above or other suitable circuits and devices.

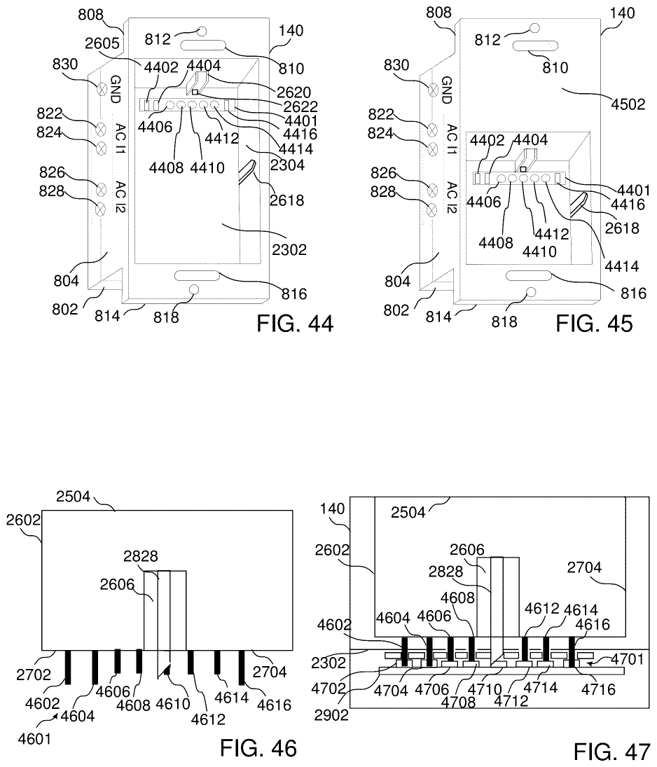

In FIGS. 26-43, an AC/DC conversion was done in a base portion of an AC/DC converter, and control of an AC/DC converter output was implemented by a signal adapter. However, the conversion of an AC/DC signal is performed in a signal adapter in FIGS. 44-51. Turning first to FIG. 44, a block diagram of a base portion of an electrical wiring device adapted to receive a signal adapter according to a full partition arrangement is shown. Because the AC/DC conversion is performed in the base portion, it is necessary to provide at least one AC signal such as the line voltage signal, to a signal adapter. More particularly, the base portion comprises a plurality of openings 4401 including an opening 4402 adapted to receive an electrical connector that may provide an AC signal (LN), an opening 4404. adapted to receive an electrical connector that may provide an AC neutral signal (NEU); an opening 4406 adapted to receive a DC contact element, an opening 4408 adapted to receive a DC contact element, an opening 4410 adapted to receive a DC contact element, an opening 4412 adapted to receive a DC contact element, and opening 4414 adapted to receive a DC contact element, and an opening 4416 for receiving an electrical connector adapted to receive an AC signal, such as a ground (GND) signal.

According to the implementation shown in the block diagram of a base portion of an electrical wiring device adapted to receive a signal adapter of FIG. 45, a partial partition arrangement is shown. That is, the opening for receiving a signal adapter is generally smaller and comprises a surface 4502 above that may be implemented as a user interface in some implementations.

Turning now to FIG. 46, a top perspective view of a signal adapter configured to be implemented with a base portion and having an actuator adapted to engage a tamper resistant element and electrical connectors for AC and DC signals is shown. The signal adapter comprises electrical interface 4601 having a plurality of AC and DC contact elements. The plurality of contact elements comprises a contact element 4602 which is adapted to receive an AC signal, a contact element 4604 which is adapted to receive an AC signal, a contact element 4606 which is adapted to receive a DC signal, a contact element 4608 which is adapted to receive a DC signal, an actuator element 2828 which is adapted to engage a tamper resistant element which may operate in a similar manner as FIGS. 33-35 for example, a contact element 4612 which is adapted to receive a DC signal, a contact element 4614 which is adapted to receive a DC signal, and a contact element 4616, which is adapted to receive an AC signal.

Turning now to FIG. 47, a cross-sectional view of a signal adapter attached to a base portion is shown. The base portion comprises a plurality of contact elements of electrical interface 4701 having a contact element 4702 adapted to make an electrical connection to a contact element 4602, contact element 4704 adapted to make an electrical connection to a contact element 4604, contact element 4706 adapted to make an electrical connection to a contact element 4606, a contact element 4708 adapted to make an electrical connection to a contact element 4608, a contact element 4710, positioned behind the actuator 2828 and adapted to make an electrical connection to a contact element 4610, a contact element 4712 adapted to make an electrical connection to a contact element 4610, contact element 4714 adapted to make an electrical connection to a contact element 4614, and contact element 4716 adapted to make an electrical connection to a contact element 4616. It should be understood that the embodiment of FIG. 47, as in other embodiments where contact elements of a base portion comprise high voltage contacts, such as 120 V AC contacts, tamper resistant elements, such as a shutter element, could be used.

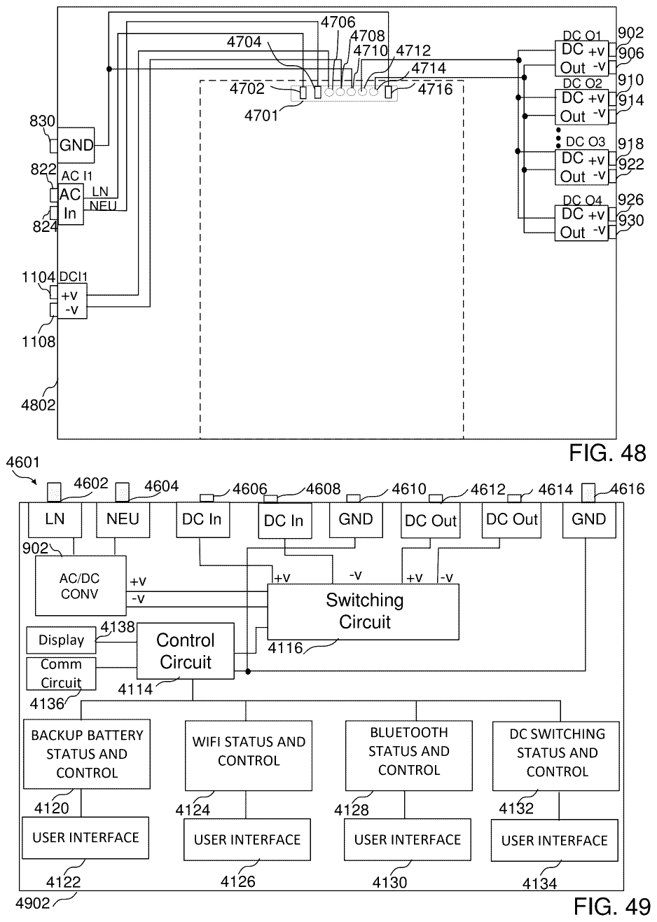

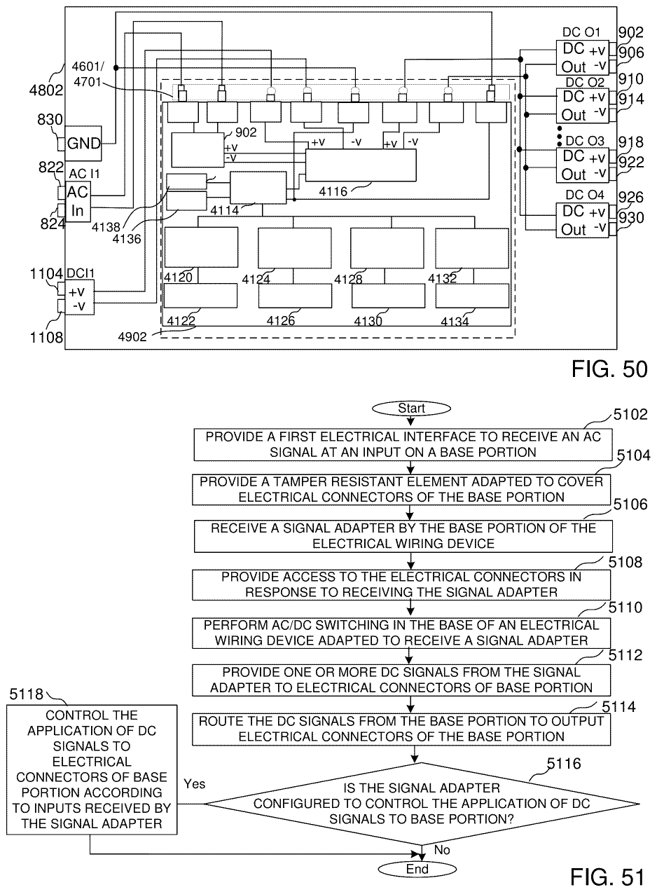

A block diagram of a base portion 4802 of an electrical wiring device of FIG. 48 has a region for receiving a signal adapter of FIG. 47 is shown. A signal adapter 4902 adapted to be electrically coupled to a base portion of an electrical wiring device is adapted to be received as shown in FIG. 49. Turning now to FIG. 50, a block diagram of an electrical wiring device having the base portion of FIG. 48 and the signal adapter of FIG. 49 is shown.

Turning now to FIG. 51, a flow chart shows a method of implementing a base portion and a signal adapter electrically attached to the base portion. A first electrical interface is provided to receive an AC signal at an input on a base portion of an electrical wiring device at a block 5102. A tamper resistant element adapted to cover electrical connectors of the base portion is provided at a block 5104. A signal adapter is received by the base portion of the electrical wiring device at a block 5106. Access to the electrical connectors is provided in response to receiving the signal adapter at a block 5108. AC/DC switching is performed in the base of an electrical wiring device adapted to receive a signal adapter at a block 5110. One or more DC signals are provided from the signal adapter to electrical connectors of base portion at a block 5112. The DC signals are routed from the base portion to output electrical connectors of the base portion at a block 5114. It is then determined whether the signal adapter is configured to control the application of DC signals to electrical connectors of base portion at a block 5116. If so, the application of DC signals to electrical connectors of base portion is controlled according to inputs received by the signal adapter at a block 5118. The methods set forth in FIG. 51 may be implemented using the circuits and devices of at least FIGS. 41-50 for example as described above or other suitable circuits and devices.

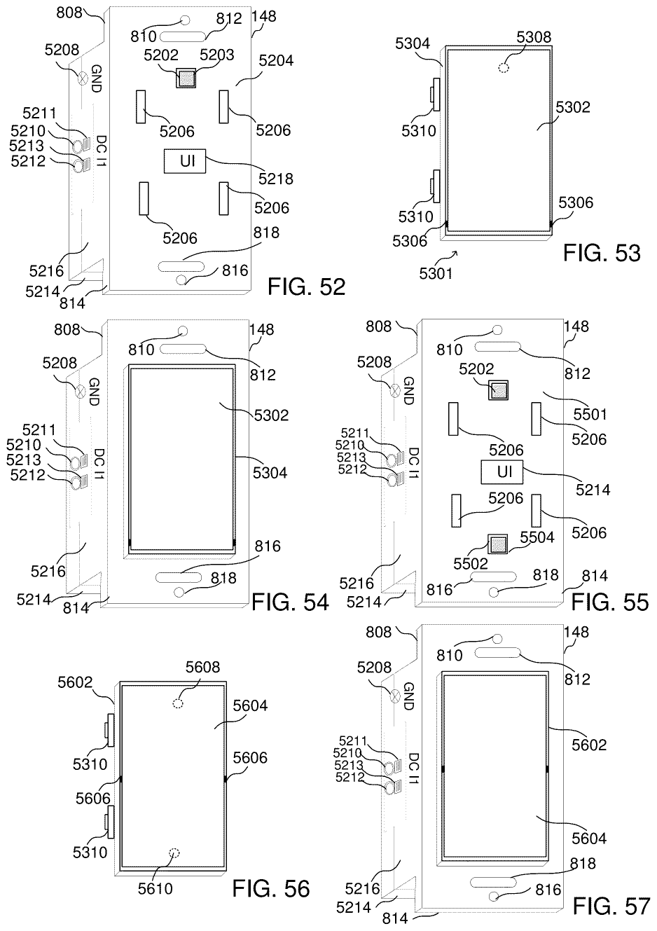

FIGS. 52-60 show electrical wiring devices having a switch that may be actuator by a user to control a DC output signal. While the AC/DC converters may be used to control the application of power to a load as described above, the switches described in FIGS. 52-60 are adapted to be distributed and easily enable a user to control the application of power to predetermined loads. Also, unlike the AC/DC converter devices of FIGS. 8-51, the switches of FIGS. 52-60, Turning first to FIG. 52, a left-side perspective view of an electrical wiring device having a switching function is shown. The electrical wiring device 148 comprises a switch actuator 5202 that. is accessible through an opening 5203 in the surface 5204. An opening 5206 is provided for receiving a flange of a frame having a switch actuator as shown in FIG. 53. A plurality of electrical connectors is provided to receive a DC input signal and provide a DC output signal. More particularly, an electrical connector 5208 is provided to receive a ground signal. The electrical connector 5210 and an associated connector actuator 5211 are adapted to receive a DC input signal (such as +v), while another electrical connector 5212 and a corresponding connector actuator 5213 are adapted to receive another DC input signal (such as 1v). The electrical wiring device 148 comprises a rear housing 5214 and a front housing 5216 adapted to enclose all of the electrical components of the electrical wiring device while allowing the contact elements to be exposed and accessible to a user to attach wires for routing DC signals.

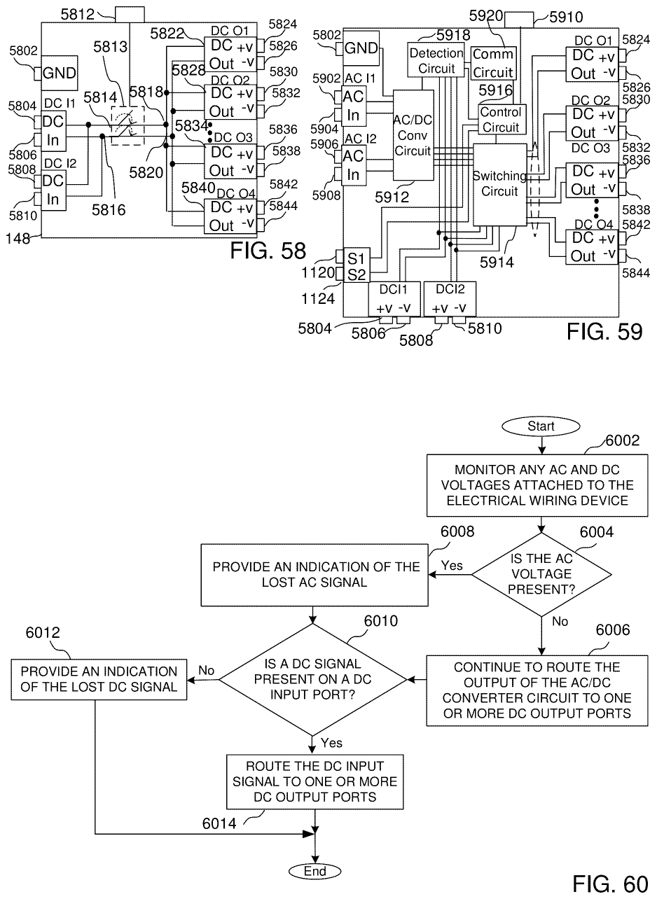

The electrical wiring device may also comprise a user interface 5218. According to some implementations, the user interface may be accessed by removing the actuator element 5301, where a left-side perspective view of a detachable actuator element adapted to be coupled to the electrical wiring device of FIG. 52 is shown in FIG. 53. That is, the four openings 5206 may be provided, where the actuator frame 5304 can be squeezed to enable the four flanges 5310 to be placed in the four corresponding openings 5206. Corresponding DC outputs connector elements, which will be described in reference to FIG. 58, will be provided on another surface of the electrical wiring device 148. The actuator 5302 may also comprise a hinge element 5306 located near the bottom of the actuator frame and allow the top portion of the actuator 5302 to be pressed toward the electrical wiring device. That is, when a user presses the top portion of the actuator 5302, an actuator element 5308 (shown in dashed lines as being on a back surface of the actuator 5302), enables an actuation of a switch of the electrical wiring device 148 to allow power to be applied to a load or removed from a load attached to connectors associated with DC output signals.

The user interface 5218 may be accessible by removing the actuator element 5301. According to some implementations, the user interface 5218 may be accessible by pulling the actuator 5302 outward from the electrical wiring device, where the actuator is adapted to rotate about the hinge element 5306 to expose the electrical interface. The user interface may comprise any type of actuator associated with a function of the electrical wiring device. According to some implementations, the actuators may comprise a switch, a knob, a dial, a slider element, or a dual inline package (DIP) switch, for example. The functions controlled by the actuators may include for example output voltage control, output current control, signal modulation, or any other function that controls the DC output signal on a DC output interface. Input/output (I/O) elements may also be provided, where input/output elements may provide one or more connects, such as USB connectors for providing charging or data access, a speaker, microphone, light emitting diodes (LEDs) for providing status indicators, or a display for providing status or other information. A left-side perspective view of the electrical wiring device 148 of FIG. 52 having the detachable actuator element 5301 of FIG. 53 is shown in FIG. 54.

While an electrical wiring device having a single actuator for toggling the application of DC power to a load is shown in FIG. 54, separate actuators for turning on or turning off power to a load may be implemented. Turning now to FIG. 55, a left-side perspective view of an electrical wiring device having a switching function is shown. Two actuators may be beneficial when a lighting element associated with light fixture is not visible, and it is possible to select the desired state (i.e., on or off) of the application of power applied to the lighting element. The electrical wiring device 148 of FIG. 55 comprises a surface 5501 having a second actuator 5502 accessible through an opening 5504.

According to the left-side perspective view of a detachable actuator element of FIG. 56 adapted to be coupled to the electrical wiring device of FIG. 55, the actuator frame 5602 is adapted to be attached to the electrical wiring device in a similar manner as described above in reference to FIGS. 52-54. An actuator 5604 comprises a hinge element 5606 enabling the actuator to pivot about the center, allowing an actuator element 5608 (shown in dashed lines as being behind the actuator) to engage the actuator 5202 to apply power to a load, and allowing an actuator element 5610 (shown in dashed lines as being behind the actuator) to engage the switch actuator 5202 to prevent power from being applied to a load. The left-side perspective view of FIG. 57 shows a combination of the electrical wiring device of FIG. 55 having the detachable actuator element of FIG. 56.

Turning now to FIG. 58, a block diagram of an electrical wiring device having a mechanical switching function is shown. The electrical wiring diagram of FIG. 58 comprises an electrical connector 5802 adapted to receive a ground signal, an electrical connector 5804 adapted to receive a DC input signal and an electrical connector 5806 adapted to receive another DC input signal to form a pair of DC input signals (e.g., +v, −v), and an electrical connector 5808 adapted to receive a DC input signal and an electrical connector 5810 adapted to receive a DC input signal (e.g., another +v, −v power signal pair). The electrical wiring device may also comprise a switch actuator 5812 coupled to control a switch 5813 adapted to receive a DC input signal at an input 5814 and another DC input signal at an input 5816. According to some implementations, the DC power signal from both pairs of DC inputs may be coupled to the inputs 5814 and 5816 as shown. The switch 5813 also comprises an output 5818 and an output 5820 adapted to provide the input DC signal to the DC outputs. A plurality of electrical interfaces comprises a first electrical interface 5822 comprising an electrical connector 5824 and an electrical connector 5826, a second electrical interface 5828 comprising an electrical connector 5830 and an electrical connector 5832, a third electrical interface 5834 comprising an electrical connector 5836 and an electrical connector 5838, and a fourth electrical interface 5840 comprising an electrical connector 5842 and an electrical connector 5844 ash shown. While a single switch actuator is shown, as shown for example in 52, it should be understood that two switch actuators could be implemented in FIG. 55.

Turning now to FIG. 59, a block diagram of an electrical wiring device having an electrical switching function is shown. More particularly, an electrical connector 5902 adapted to receive an AC input signal and an electrical connector 5904 adapted to receive another AC input signal to form a pair of AC input signals (e.g., a line voltage and a neutral voltage), and an electrical connector 5906 adapted to receive a AC input signal and an electrical connector 5908 adapted to receive an AC input signal (e.g., one of a line and neutral power signal pair as described above). The electrical wiring device may also comprise a switch actuator 5910 coupled to control the application of a DC signal to the DC output ports. The electrical wiring device of FIG. 59 comprises an AC/DC converter circuit 5912, a switching circuit 5914, a control circuit 5916. The control circuit controls the switching circuit to apply power to the DC outputs, where the switching circuit is adapted to receive both DC inputs from the AC/DC converter circuit and the DC input interfaces DCI1 and DCI2. That is, the switching circuit enables the selection of a variety of DC inputs that can be routed to a variety of DC outputs. The switching circuit may comprise a multiplexer, which may be implemented in discrete components or in a dedicated multiplexer or some other type of integrated circuit device, such as a programmable logic device or field programmable gate array. The switching circuit enables the routing of DC signals, which may be beneficial in the event a user desires to conserve energy, such as during a power outage for example.

The electrical wiring device of FIG. 59 may also comprise a detection circuit 5918 and a communication circuit 5920. The detection circuit can detect the various DC signals generated by the AC/DC converter circuit or received by the DC inputs to enable the control circuit to which DC signals are available to be routed to DC outputs. By way of example, if the AC signal is lost, the detection circuit may determine that the DC outputs of the AC/DC converter circuit would not be available and the control circuit would need to control the multiplexer to route any available DC signal receive at DC inputs to the DC outputs. The control circuit 5916 may also receive signals by the communication circuit 5920 that may determine which signals are routed from inputs to outputs. According to some implementations, the detection circuit enables the routing of DC signals for a DC input is receiving a DC signal. Further, the communication circuit enables the selection of DC inputs and DC outputs in response to signals received by the communication circuit.

Turning now to FIG. 60, a flow chart shows a method of controlling AC and DC power to loads. Any AC and DC voltages attached to the electrical wiring device are monitored at a block 6002. It is also determined whether the AC voltage is present at a block 6004. If not, the output of the AC/DC converter circuit is continued to be routed to one or more DC output ports of the electrical wiring device at a block 6006. If so, an indication of the lost AC signal is provided at a block 6008. It is also determined whether a DC signal is present on a DC input port at a block 6010. If not, an indication of the lost DC signal is provided at a block 6012. If so, the DC input signal is routed to one or more DC output ports at a block 6014. The methods set forth in FIG. 60 may be implemented using the circuits and devices of at least FIGS. 51-59 for example as described above or other suitable circuits and devices.

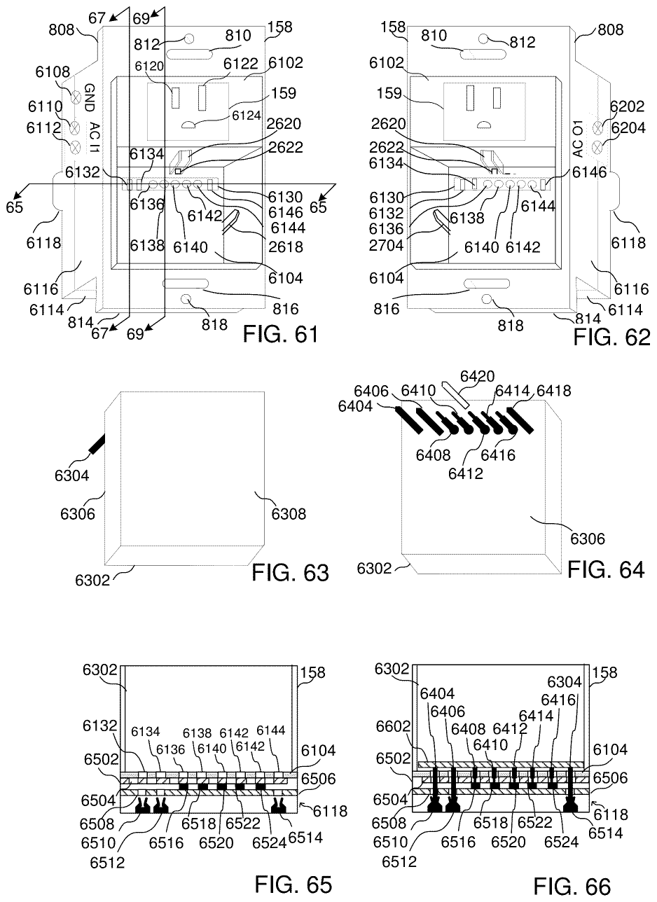

In addition to the AC/DC converter devices and electrical wiring devices described above, electrical wiring devices comprising receptacle devices are also described in reference to FIGS. 61-84, where the receptacle devices are adapted to provide DC signals to a signal adapter attached to the electrical wiring device. Turning first to FIG. 61, a left-side perspective view of a base of an electrical wiring device having a receptacle is shown. The electrical wiring device 158 comprises a receptacle 6102 and an area 6104 for receiving a signal adapter. The electrical wiring device comprises an electrical connector 6108 adapted to receive a ground signal. While the ground is shown as a screw contact element on the side of the electrical wiring device, it should be understood that the ground could be provided in other areas, such as a screw terminal associated with a flange of the yoke such as the flange 134 of the electrical wiring device of FIG. 1 for example. An electrical connector 6110 adapted to receive a neutral (NEU) signal, and an electrical connector 6112 adapted to receive a line (LN) voltage signal. The electrical wiring device comprises a bottom housing 6114 adapted to be coupled to a top housing 6116 to retain the electrical and mechanical elements of the device to provide power to both the receptacle and any signal adapter attached to the electrical wiring device. The electrical wiring device also comprises an extended portion 6118 that is adapted to receive longer contact elements of a signal adapter, such as contact elements carrying AC signals.

The receptacle 6102 comprises a plurality of opening adapted to receive contact element of a plug, commonly called prongs, such as an opening 6120 adapted to receive a line prong of a plug to receive the line voltage, an opening 6122 neutral prong of a plug to receive the neutral voltage, and an opening 6124 adapted to receive a ground prong of a plug adapted to receive the ground signal. The electrical wiring device also comprises a plurality of openings adapted to receive contact elements of a signal adapter. More particularly, the electrical wiring device comprises a plurality of openings 6130 having an opening 6132, an opening 6134, an opening 6136, an opening 6138, an opening 6140, an opening 6142, and opening 6144 and an opening 6146. As will be described in more detail in reference to FIGS. 63-66. That is, some of the openings are adapted to receive a first type of contact element adapted to conduct an AC signal, and particularly a high voltage signal (e.g., 120V AC signal) and higher current than normally drawn by an AC circuit compared to a low voltage DC signal. Openings for receiving a second time of contact elements, such as smaller contact elements for transmitting or receiving DC signals.

Turning now to FIG. 62, a right-side perspective view of a base of an electrical wiring device having a receptacle is shown. The electrical wiring device of FIGS. 61 and 62 comprises an electrical connector 6202 and electrical connector 6204 for providing an AC output signal, which may also be a 120V AC signal.

Turning now to FIG. 63, a left-side perspective view showing a front surface of a signal adapter is shown. More particularly, a signal adapter 6302 comprises a plurality of contact elements, including for example a contact element 6304 extending from a rear surface 6306. A front surface 6308 is also shown. According to some implementations, user interface elements may be located on one or more surfaces, including the front surface, as will be described in more detail below.

Turning now to FIG. 64, a perspective view showing a rear surface of the signal adapter of FIG. 63 is shown, where multiple contact elements, including the first type of contact elements adapted to route AC signals and a second plurality of contact elements adapted to route DC signals. More particularly, the plurality of contacts elements comprises a contact element 6404, a contact element 6406, a contact element 6408, a contact element 6410, a contact element 6412, a contact element 6414, a contact element 6416, where contact elements 6404, 6406, and 6418 may comprise contact elements adapted to route AC signals and contact elements 6408, 6410, 6412, 6414, and 6416 may be adapted to route DC signals. The signal adapted may also comprise an actuator element 6420 which is adapted to engage a tamper resistant element, as will be described in more detail below.

Turning now to FIG. 65, a cross-sectional view shows the base portion of FIG. 61 of the electrical wiring device having the signal adapter of FIG. 63 attached thereto and taken at lines 65-65. The base portion comprises a tamper resistant element 6502 and a plurality of openings and a corresponding contact element. More particularly, the tamper resistant element comprises an opening 6504 that is above a circuit board 6506. When the tamper resistant element is moved to the right as shown in the cross-sectional view, the opening 6504 is adapted to align with the opening 6508 and the contact element 6510, enabling the contact element 6404 to make an electrical connection with the contact element 6510, as will be shown in FIG. 66. The base portion also comprises a contact element 6512 adapted to adapted to make an electrical connection to contact element 6406 and a contact element 6514 adapted to receive a contact element 6418 when the tamper resistant element is moved to align the openings of the tamper resistant element and a surface of the base portion. The base portion also comprises a contact element 6516 adapted to be electrically connected to a corresponding contact element 6408, a contact element 6518 adapted to be electrically connected to a corresponding contact element 6410, a contact element 6520 adapted to be electrically connected to a corresponding contact element 6412, a contact element 6522 adapted to be electrically connected to a corresponding contact element 6414, and a contact element 6524 adapted to be electrically connected to a corresponding contact element 6416 as shown in FIG. 65. As shown in FIG. 66, the plurality of electrical connectors of the signal adapter extends from a circuit board 6602 and make electrical connection to corresponding electrical connectors of the base portion.

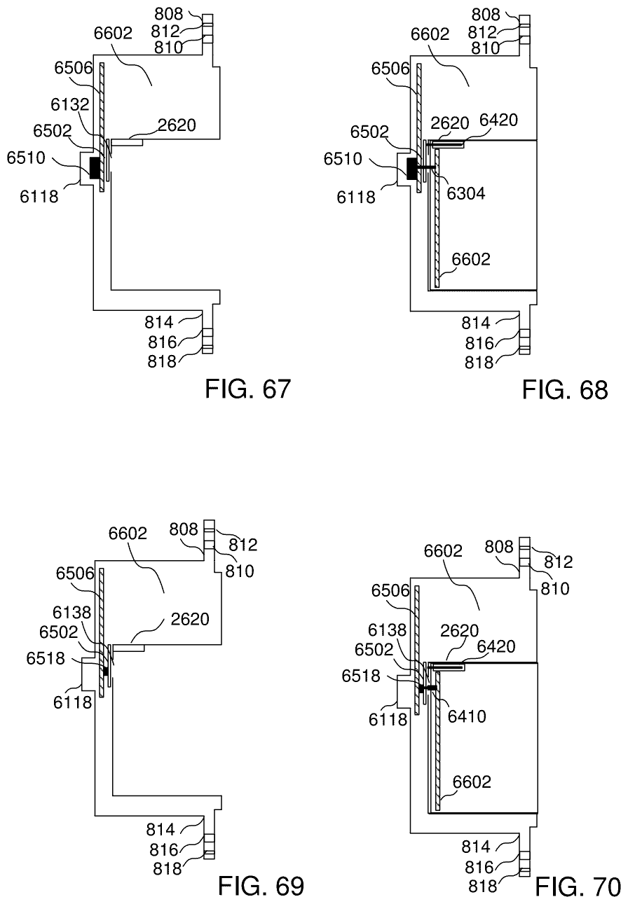

Turning now to FIGS. 67 and 68, cross-sectional views show the base portion of FIG. 61 taken at lines 67-67, where the cross-sectional view of FIG. 67 shows the base portion without a signal adapter and FIG. 68 shows the base portion of FIG. 61 of the electrical wiring device having a base portion with a signal adapter attached.

Turning now to FIGS. 69 and 70, additional cross-sectional views show the base portion of FIG. 61 taken at lines 69-69, where FIG. 69 is a cross-sectional view of the base portion alone and FIG. 70 is a cross-sectional view of a base portion having a signal adapter attached.

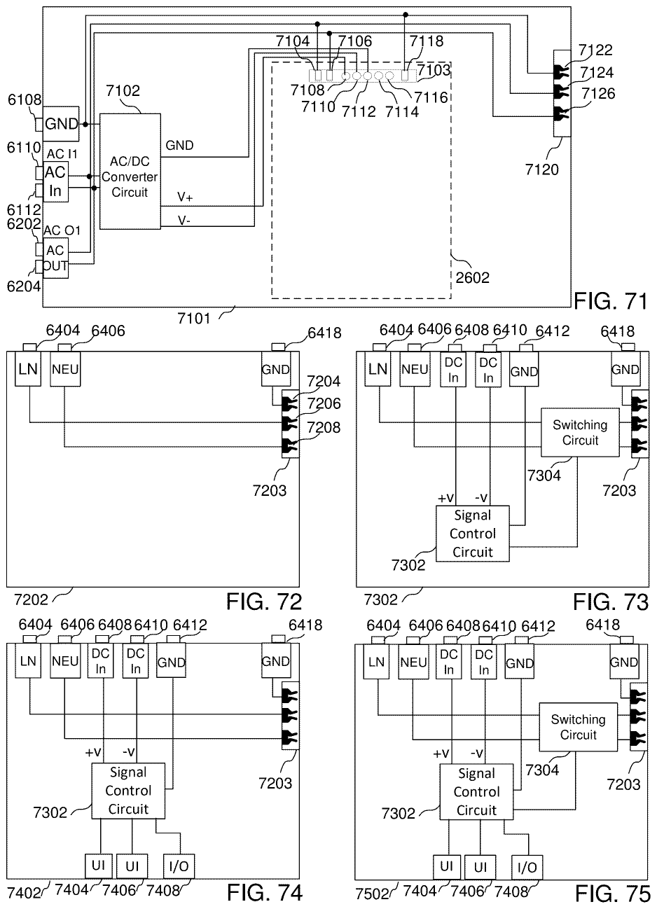

Turning now to FIG. 71, a circuit diagram of a base portion of an electrical wiring device adapted to receive a signal adapter is shown. More particularly, a base portion 7101 comprises an AC/DC converter circuit 7102 adapted to provide a DC power signal to a plurality of contact elements 7103, including a contact element 7104, contact element 7106, contact element 7108, contact element 7110, contact element 7112, contact element 7114, contact element 7116, contact element 7116, and a contact element 7118. A plurality of contact elements 7120 adapted to receive prongs of plug of an appliance for example comprises a contact element 7122 adapted to receive the ground signal and a ground prong of a plug, a contact element 7124 adapted to receive the line signal and line prong of a plug, and a contact element 7126 adapted to receive a neutral signal and neutral prong of a plug.

FIGS. 72-75 are directed to signal adapters adapted to receive DC input signals and provide an operation of the signal adapter associated with a DC signal. Turning first to FIG. 72, a circuit diagram of a signal adapter adapted to be electrically coupled to a base portion of an electrical wiring device is shown. The signal adapter of FIG. 72 has limited functionality associated with AC signals. More particularly, the signal adapter 7202 comprises electrical interface 7203 for receiving prongs of a plug (e.g., lamp or appliance), including a contact element 7204, a contact element 7206, and a contact element 7208 adapted to mate with the corresponding contact element of the plurality of contact elements 7120 of FIG. 71.

Turning now to FIG. 73, a circuit diagram of a signal adapter adapted to be electrically coupled to a base portion of an electrical wiring device and having a switching operation for a receptacle of the signal adapter is shown. The signal adapter of FIG. 73 comprises a signal control circuit 7302 and a switching circuit 7304 as shown. The switching circuit 7304 enables selectively controlling the application of the line signal to the line contact element of the plurality of contact elements of an electrical interface 7203. The signal control circuit is adapted to control the switching circuit and selectively apply power to the receptacle. It should be understood that signal adapters used with a base portion having an outlet may comprise a signal adapter that may passively provide to a function to a user, such as a clock or a night light, provide information such as from a sensor to a system associated with a builder, such as an HVAC, air quality or home monitoring system, or a home monitoring system.

Turning now to FIG. 74, a circuit diagram of a signal adapter adapted to be electrically coupled to a base portion of an electrical wiring device and having user interface and input/output functions is shown. The signal adapter 7402 of FIG. 74 comprises one or more user interfaces, including a user interface 7404 and a user interface 7406, and an input/output port 7408. According to some implementations, the input/output port may comprise a low voltage interface for communicating or charging a device, such as a USB connector for communicating with or charging a mobile phone for example.

Turning now to FIG. 75, a circuit diagram of a signal adapter adapted to be electrically coupled to a base portion of an electrical wiring device and having a switching operation for a receptacle of the signal adapter and user interface and input/output functions is shown. The signal adapter 7502 comprises both the switching circuit 7304 of FIG. 73 and the user interface 7404, the user interface 7406, and an input/output port 7408 as described in reference to FIG. 74. While the signal adapters of FIGS. 74-75 include a receptacle, it should be understood that signal adapters could be implemented without the receptacle. In addition to providing a DC electrical interface, such as for USB charging, the signal adapters may also provide a variety of other functions, such as sensors or control devices for other systems, such as air quality and heating ventilation and air conditioning (HVAC) systems. According to some implementations, the signal adapter may comprise a DC power interface, such as a DC power interface adapted to receive a plug of an appliance adapted to operate on DC power. That is, the DC power interface may be an interface having contact elements that are configured to receive corresponding contact elements of the DC appliance adapted to operate on DC power. According to some implementations, the DC power signal could be approximately in a range of 0-50V DC.

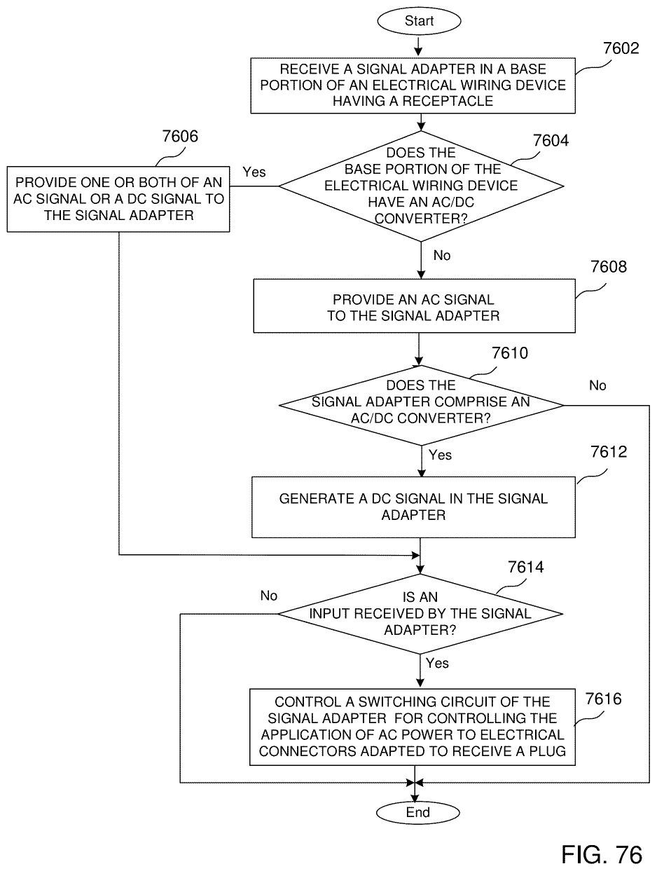

Turning now to FIG. 76, a flow chart shows a method of implementing a electrical wiring device comprising a base having n receptacle and adapted to receive a signal adapter. A signal adapter is received in a base portion of an electrical wiring device having an outlet at a block 7602. It is then determined whether the base portion of the electrical wiring device has an AC/DC converter at a block 7604. If so, one or both of an AC signal or a DC signal is provided to the signal adapter at a block 7606. If not, an AC signal is provided from the base portion to electrical connectors of the signal adapter at a block 7608. It is also determined whether the signal adapter comprises and AC/DC converter circuit at a block 7610. If so, a DC signal is generated in the signal adapter at a block 7612. It is also determined whether an input received by the signal adapter at a block 7614. If so, a switching circuit for controlling the application of AC power to electrical connectors adapted to receive a plug is controlled at a block 7616. The methods set forth in FIG. 76 may be implemented using the circuits and devices of at least FIGS. 61-75 for example as described above or other suitable circuits and devices.

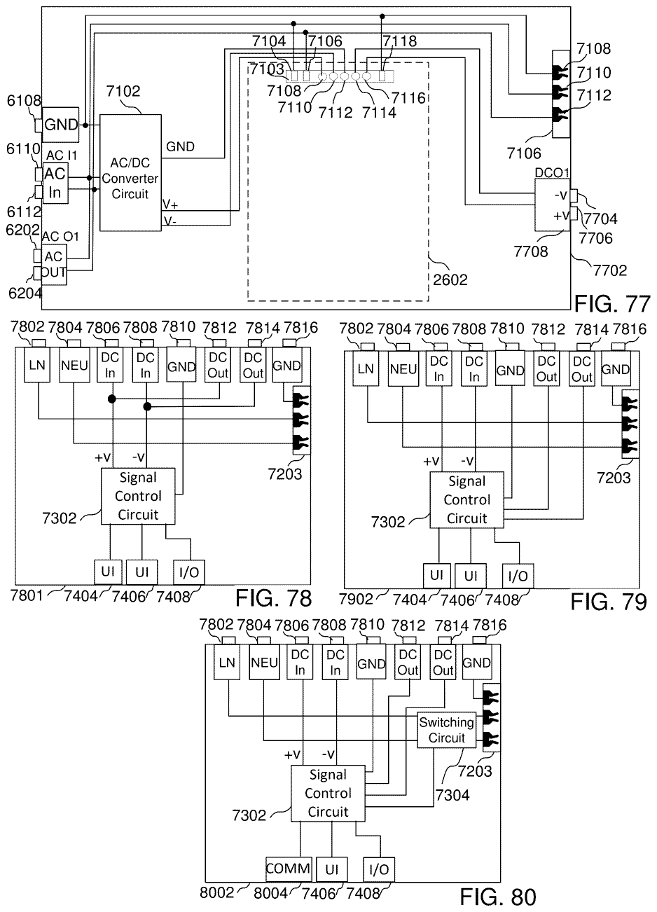

Turning now to FIG. 77, a circuit diagram of a base portion of an electrical wiring device adapted to receive a signal adapter and having an output port adapted to route a DC voltage signal to another electrical wiring device is shown. The base portion 7702 of the electrical wiring device of FIG. 77 comprises an electrical connector 7704 and an electrical connector 7706 of the electrical interface 7708. That is, the base portion 7702 enables the routing of DC signals, such as power signals, to other devices, as described above.

Turning now to FIG. 78, a circuit diagram of a signal adapter adapted to route a DC output signal to the output port of a base portion of the electrical wiring device is shown. The signal adapter 7801 of FIG. 78 comprises a contact element 7802 comprises a contact element 7804, a contact element 7804, a contact element 7806, a contact element 7808, a contact element 7810, a contact element 7812, a contact element 7814, and a contact element 7816 to enable the routing of signals when electrically connected to the plurality of contact elements 7103 of the base portion 7702 for example.

Turning now to FIG. 79, a circuit diagram of a signal adapter adapted to route a DC output signal to the output port of a base portion of the electrical wiring device is shown. The signal adapter 7902 of FIG. 79 enables the control of the DC output signals at the contact elements 7812 and 7814 for example.

Turning now to FIG. 80, a circuit diagram of a signal adapter adapted to route a DC output signal to the output port of a base portion of the electrical wiring device and control an AC signal routed to an out is shown. The signal adapter 8002 of FIG. 80 is similar to the signal adapter of FIG. 79, but comprises the switching circuit 7304 and a communication circuit 8004 to enable the plurality of contact elements of an electrical interface 7203 to be operated as a switched outlet.

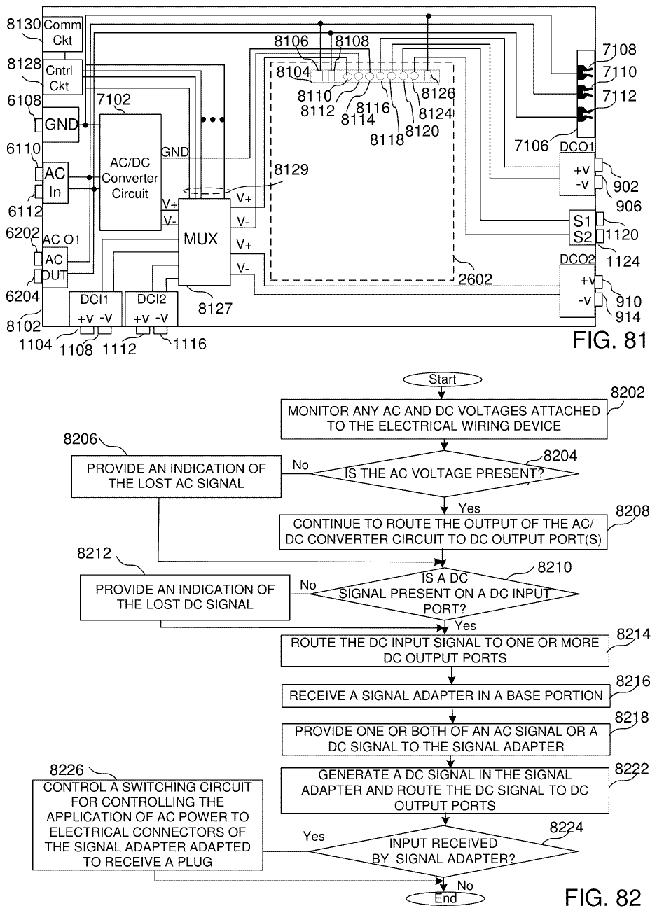

Turning now to FIG. 81, a circuit diagram of a base portion of an electrical wiring device having a receptacle and controlling the application of a DC output signal to a DC output port is shown. The base portion 8102 of an electrical wiring device has a plurality of contact elements 8104 comprising a contact element 8106, a contact element 8108, a contact element 8110, a contact element 8112, a contact element 8114, a contact element 8116, a contact element 8118, a contact element 8120, a contact element 8122, a contact element 8124, and a contact element 8126 which are connected to the various circuits as shown. The base portion may also comprise a plurality of signal lines 8129 coupled between a multiplexer 8127 and a control circuit 8128 which is coupled to a communication circuit 8130 as shown.

Turning now to FIG. 82, a flow chart shows a method of implementing an electrical wiring device comprising a base portion having a DC output port and a receptacle. Any AC and DC voltages attached to the electrical wiring device are monitored at a block 8202. It is then determined whether the AC voltage is present at a block 8204. If not, an indication of the lost AC Signal is provided at a block 8208. If so, the output of the AC/DC converter circuit is continued to be routed to one or more DC output ports of the electrical wiring device at a block 8206. It is also determined whether a DC signal is present on a DC input port at a block 8210. If not, an indication of the lost DC signal is provided at a block 8212. The DC input signal is routed to one or more DC output ports at a block 8214. A signal adapter may be received in a base portion of an electrical wiring device having an outlet at a block 8216, and one or both of an AC signal or a DC signal is provided to the signal adapter at a block 8218. An AC signal is provided from the base portion to electrical connectors of the signal adapter at a block 8220 and a DC signal is generated in the signal adapter at a block 8222. It is also determined whether an input is received by the signal adapter at a block 8224. If so, a switching circuit for controlling the application of AC power to electrical connectors of the signal adapter adapted to receive a plug is controlled at a block 8226. The methods set forth in FIG. 82 may be implemented using the circuits and devices of at least FIGS. 76-81 for example as described above or other suitable circuits and devices.

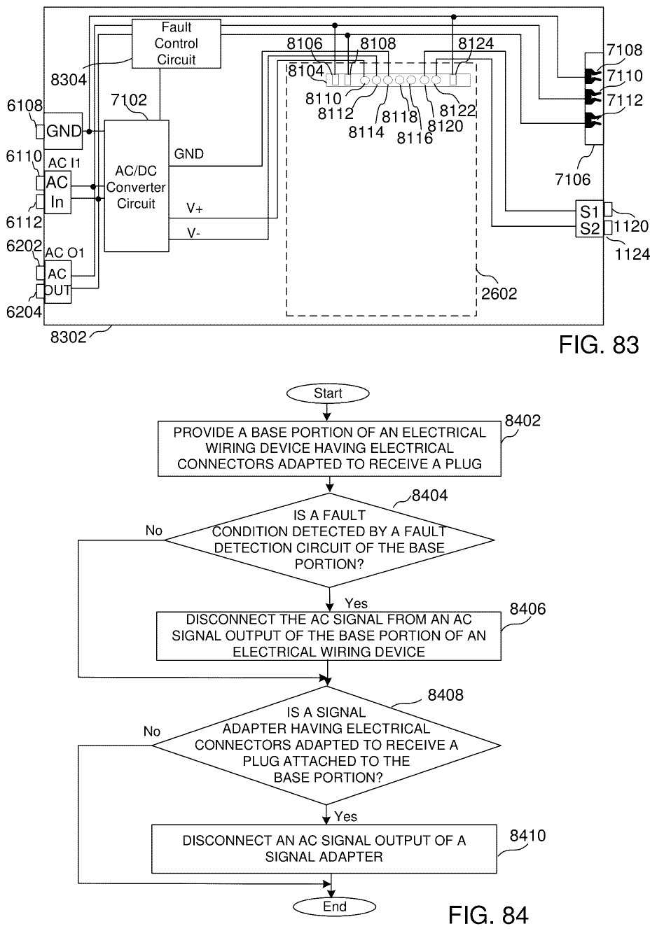

Turning now to 83 is a block diagram of a base portion of an electrical wiring device having a receptacle and a fault control circuit is shown. According to the implementation of FIG. 83, the base portion 8302 of an electrical wiring device may comprise a fault detection circuit 8304. (e.g., ground fault circuit interrupt (GFCI) or arc fault interrupt circuit (AFCI)).

Turning now to FIG. 84, a flow chart shows a method of implementing a base portion of an electrical wiring device having a receptacle and a fault control circuit. blocks. A base portion of an electrical wiring device having electrical connectors adapted to receive a plug is provided at a block 8402. It is then determined whether a fault condition is detected by a fault detection circuit of the base portion at a block 8404. If so, the AC signal is disconnected from an AC signal output of the base portion of an electrical wiring device at a block 8406. It is also determined whether a signal adapter having electrical connectors adapted to is received a plug attached to the base portion at a block 8408. If so, an AC signal output of a signal adapter is disconnected at a block 8410. The methods set forth in FIG. 83 may be implemented using the circuit and device of at least FIG. 84 for example as described above or other suitable circuits and devices.

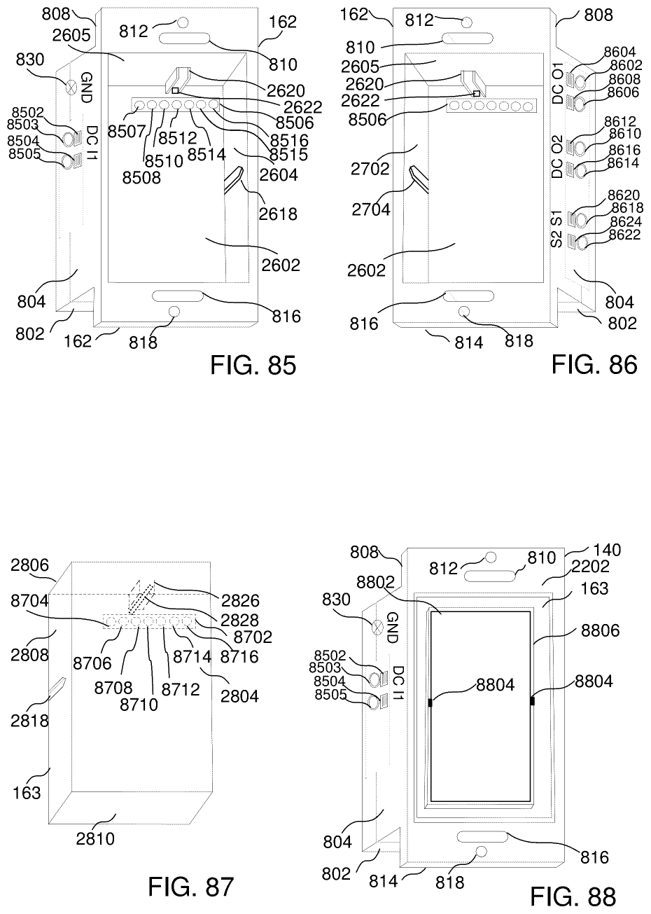

FIGS. 85-94 relate to modular switches adapted to receive a DC input and provide a signal to one or more outputs, where a user interface portion of the signal adapter may occupy an area that extends through an opening in a wall plate. Turning first to FIG. 85, a left-side perspective view of a base portion of a electrical wiring device based upon a full partition arrangement and adapted to receive a signal adapter is shown. The base portion of FIG. 85 comprises a connector actuator 8502 associated with an electrical connector 8503, and a connector actuator 8504 associated with an electrical connector 8505. The base portion may also comprise a plurality of openings 8506, including an opening 8507, an opening 8508, an opening 8510, an opening 8512, an opening 8514. opening 8515, and an opening 8516 for receiving contact elements of a signal adapter, as will be described in more detail below.

Turning now to FIG. 86, a right-side perspective view of the base portion of FIG. 85 is shown. The right-side perspective view shows additional electrical connectors, including an electrical connector 8602 and a corresponding actuator element 8604, an electrical connector 8606 and a corresponding actuator element 8608, an electrical connector 8610 and a corresponding actuator element 8612, an electrical connector 8614 and a corresponding actuator element 8616, an electrical connector 8618, and actuator element 8620, and an electrical connector 8622 and a corresponding actuator element 8624 as shown. The operation of the electrical connections and the routing of signals will be described in more detail below.

Turning now to FIG. 87, a left-side perspective view of a signal adapter configured to be attached to a base portion is shown. The signal adapter comprises a plurality of contact elements 8702 which may comprise a contact element 8704, a contact element 8706, a contact element 8708, a contact element 8710, a contact element 8712, a contact element 8714 and a contact element 8716. The electrical connections of the contact elements of the signal adapted with corresponding contact elements of a base portion will be described in more detail below.

Turning now to FIG. 88, a left-side perspective of the base portion of FIG. 85 attached to the signal adapter of FIG. 87 is shown. The actuator element 8802 of the signal adapter comprises hinge elements 8804 and a frame portion 8806 that enables a user to toggle the state of a switch.

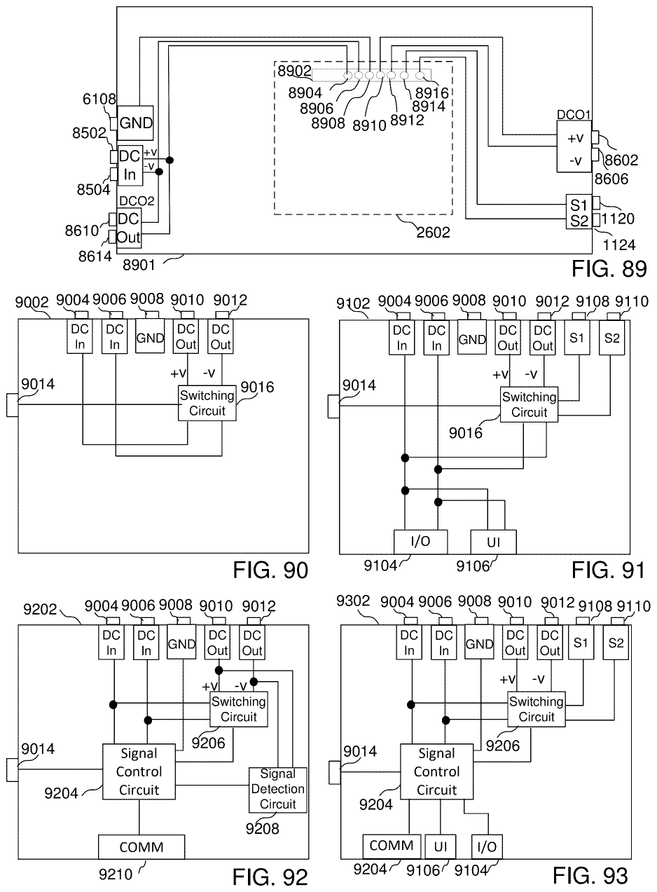

Turning now to FIG. 89, a block diagram of a base portion of an electrical wiring device, which may be the electrical wiring device of FIG. 85 for example, is shown. The base portion 8901 of an electrical wiring device comprises a plurality of contact elements 8902 which may comprise a contact element 8904, a contact element 8906, a contact element 8908, a contact element 8910, a contact element 8912, a contact element 8914, and a contact element 8916, which are connected as shown.

Turning now to FIG. 90, a block diagram of a signal adapter configured to be attached to the base portion of FIG. 89 and comprising a switching circuit adapted to route a DC input signal to a DC output port is shown. The signal adapter 9002 comprises a plurality of contact elements which may include a contact element 9004, a contact element 9006, a contact element 9008, a contact element 9010, and a contact element 9012. The signal adapter comprises a switch actuator 9014 and a switching circuit 9016 for controlling the switching of the DC input signals to the DC output contact elements, and therefore the load, such as a lighting element by way DC output contact elements of the DC output interface DC 01 of the base portion 8901.

Turning now to FIG. 91, a block diagram of a signal adapter configured to be attached to the base portion of FIG. 89 and comprising a switching circuit, an input/output (I/O) port and user interface (UI) elements is shown. The signal adapter 9102 of FIG. 91 comprises input/output port 9104 which may receive control signals for controlling the switching circuit. The input/output port 9104 may comprise any type of input for receiving information or data, included by way of a wireless interface or a wired interface. The signal adapter may comprise a user interface 9106 for receiving signals or information or providing signals or information to a user. The user interface 9106 may may comprise any type of user interface, including for example actuator elements, an audio input, an audio output, and a screen for providing information. The actuator element may be used for controlling the operation of the signal adapter. The signal adapted may also comprise a contact element 9108. contact element 9110 for transmitting or receiving signals, such as signals that may control the switching circuit.

Turning now to FIG. 92, a block diagram of a signal adapter configured to be attached to the base portion of FIG. 89 and comprising a switching circuit adapted to route a DC input signal to a DC output port and a communication circuit is shown. The signal adapter 9202 comprises a signal control circuit 9204, a switching circuit 9206, a signal detection circuit 9208, and communication circuit 9210.

Turning now to FIG. 93, a block diagram of a signal adapter configured to be attached to the base portion of FIG. 89 and comprising a switching circuit, a communication circuit, a user interface, and an I/O port is shown. The signal adapter 9302 is similar to the signal adapter of FIG. 92, but also includes the signaling contact elements, including contact element 9108 and contact element 9110. Signal adapters that are adapted to be used with a base portion adapted to provide switching functionality may include other functionality such as communication functionality to enable control signals from a remote location, such as receiving WiFi or Bluetooth signals for example, to control a switching operation of the signal adapter.

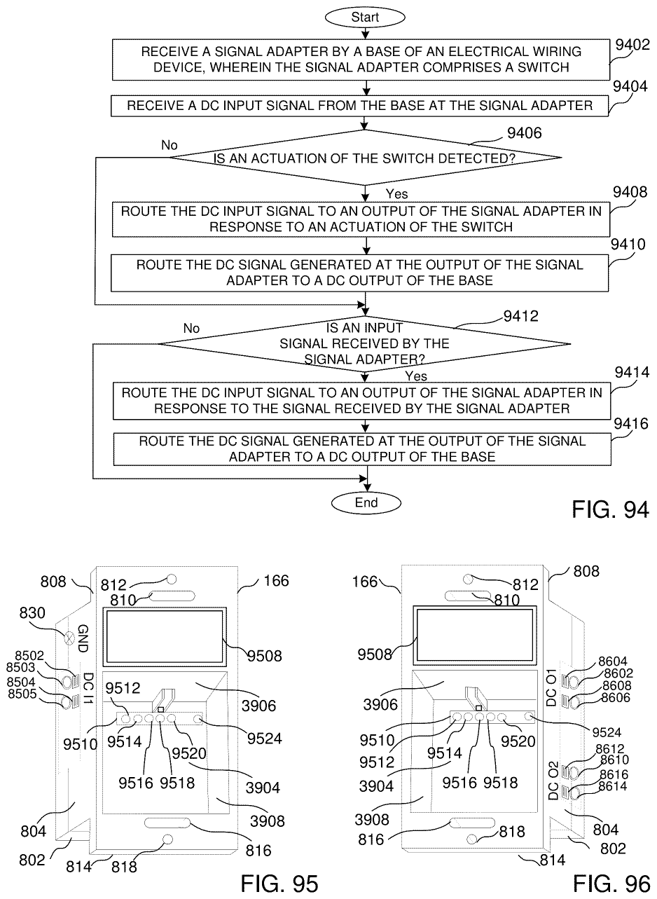

Turning now to FIG. 94, a flow chart shows a method of implementing an electrical wiring device adapted to receive a signal adapter in a full partition arrangement. blocks. A signal adapter Receive by a base of an electrical wiring device, wherein the signal adapter comprises a switch at a block 9402. A DC input signal Receive from the base at the signal adapter at a block 9404. It is determined whether an actuation of the switch detected at a block 9406. The DC input signal is routed to an output of the signal adapter in response to an actuation of the switch at a block 9408. The DC signal generated at the output of the signal adapter is routed to a DC output of the base of the electrical wiring device at a block 9410. It is also determined whether an input signal is received by the signal adapter at a block 9412. The DC input signal is routed to an output of the signal adapter in response to the signal received by the switch at a block 9414. The DC signal generated at the output of the signal adapter is routed to a DC output of the base of the electrical wiring device at a block 9416. The methods set forth in FIG. 94 may be implemented using the circuits and devices of at least FIGS. 85-93 for example as described above or other suitable circuits and devices.

FIGS. 95-103 are directed to electrical wiring devices that receive a DC input signal and generate a DC output signal, but may include one or more user interface elements, such as a switch actuator element as shown in FIG. 95. Turning first to FIG. 95, a right-side perspective view of an electrical wiring device having a switch actuator and adapted to receive a signal adapter in a partial partition arrangement is shown. The base portion of an electrical wiring device comprises a switch actuator 9508 and comprises plurality of openings associated with an electrical interface 9510, which may comprise an opening 9512, an opening 9514, an opening 9516, an opening 9518, an opening 9520, and an opening 9524. The right-side perspective view of the electrical wiring device of FIG. 95 shows the DC output connectors as shown for example in FIG. 96.

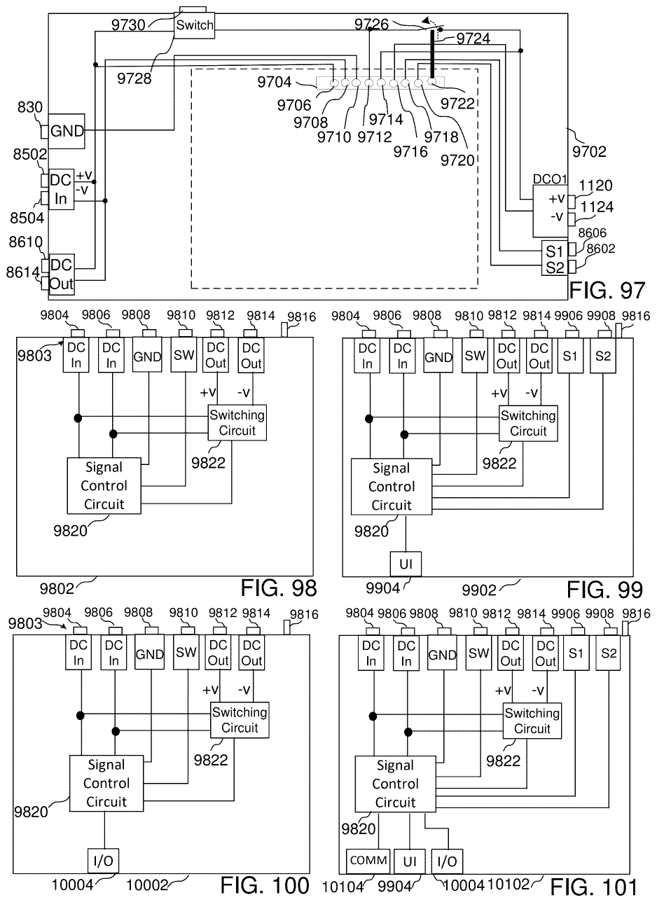

Turning now to FIG. 97, a circuit diagram of a base portion of an electrical wiring device having a switch and adapted to operate without a signal adapter in a partial partition arrangement is shown. According to the implementation of the base portion of FIG. 97, the base portion may operate as a switch responsive to a switch actuator element of the base portion and in response to signals from a signal adapter, such as a signal adapter of FIGS. 98-10, as will be described in more detail below. The base portion 9702 of an electrical wiring device may comprise a plurality of contact elements 9704 associated with an electrical and mechanical interface comprising a plurality of electrical connectors and an actuator element. The electrical interface may comprise a contact element 9706, a contact element 9708, a contact element 9710, a contact element 9712, a contact element 9714, a contact element 9716, a contact element 9718, a contact element 9720, and a contact element 9722. A switch actuator 9724, response to a signal adapter being attached to the base portion, may actuate a switch 9726 to disconnect the +v DC power signal to an output port. The base portion may also comprise a switch 9728 responsive to an actuator element 9730. When no signal adapter is coupled to the base portion, the switch 9728 controls the application of the +v DC power signal to the output contact element of the output DC port.

Each of the signal adapters of FIGS. 98-101 comprises a switch (SW) contact element for receiving a switching signal associated with the switch 9728 to detect when a user has attempted to toggle +v DC power signal applied to the output contact element of the output DC port. Turning first to FIG. 98, a block diagram of a signal adapter having a switching circuit for controlling the application of an output signal in response to a switching signal from a switch of a base portion of an electrical wiring device is shown. The signal adapter 9802 comprises an electrical interface 9803 having a plurality of contact elements including a contact element 9804, a contact element 9806, a contact element 9808, a contact element 9810, a contact element 9812, and a contact element 9814. An actuator element 9816 may be implanted to control the switch 9726 of the base of FIG. 97. A signal control circuit 9820 and switching circuit 9822 may also be implemented as described above.

Turning now to FIG. 99, a block diagram of a signal adapter having a switching circuit and a signal control circuit and user interface for controlling the application of an output signal in response to a switching signal from a switch of a base portion of an electrical wiring device is shown. The signal adapter 9902 of FIG. 99 is similar to the signal adapter of FIG. 98, but also includes a user interface 9904 and an electrical connector 9906 and an electrical connector 9908 for transmitting signals S1 and S2.

Turning now to FIG. 100, a block diagram of a signal adapter having a switching circuit and an input/output port for controlling the application of an output signal in response to a switching signal from a switch of a base portion of an electrical wiring device is shown. The signal adapter 10002 is similar to the signal adapter of FIG. 98, but also includes an input/output port 10004.

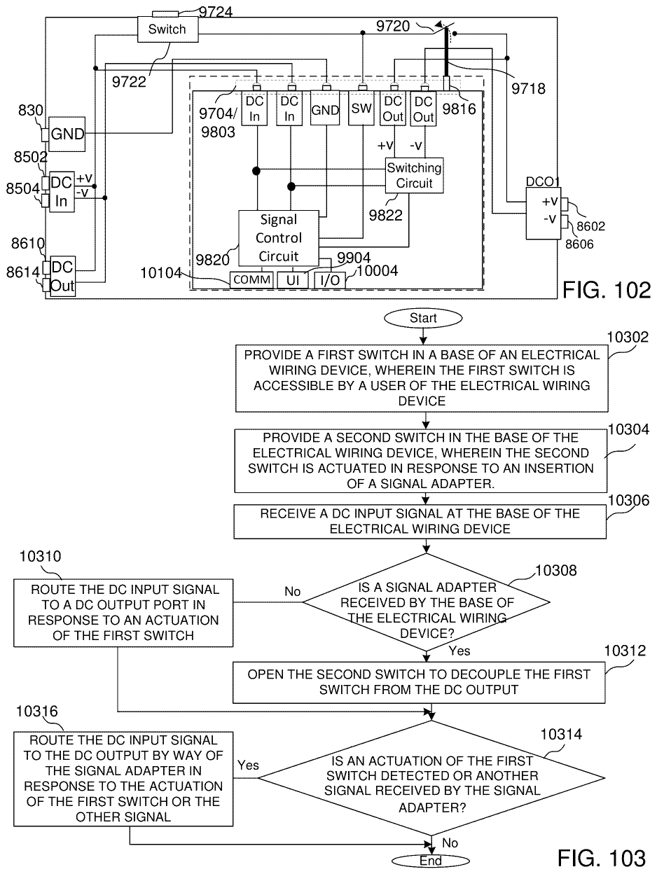

Turning now to FIG. 101, a block diagram of a signal adapter having a switching circuit and a communication circuit for controlling the application of an output signal in response to a switching signal from a switch of a base portion of an electrical wiring device is shown. The signal adapter 10102 further includes a communication circuit 10104. A circuit diagram of base portion of an electrical wiring device and a signal adapter in a partial partition arrangement is shown in FIG. 102.

Turning now to FIG. 103, a flow chart shows a method of implementing an electrical wiring device having a base portion with a switch and a signal adapter for controlling the application of an output signal in response to a switching signal from a switch of a base portion of an electrical wiring device. A first switch is provided in a base of an electrical wiring device, wherein the first switch is accessible by a user of the electrical wiring device at a block 10302. A second switch provided in the base of the electrical wiring device, wherein the second switch is actuated in response to an insertion of a signal adapter at a block 10304. A DC input signal is received at the base of the electrical wiring device at a bock 10306. It is determined whether a signal adapter is received by the base of the electrical wiring device at a bock 10308. If not, the DC input signal is routed to a DC output port in response to an actuation of the first switch at a block 10310. If so, the second switch is opened to decouple the first switch from the DC output at a block 10312. It is also determined whether an actuation of the first switch is detected or another signal is received by the signal adapter at a block 10314. If so, the DC input signal is routed to the DC output by way of the signal adapter in response to the actuation of the first switch or the other signal at a block 10316. The methods set forth in FIG. 193 may be implemented using the circuits and devices of at least FIGS. 95-102 for example as described above or other suitable circuits and devices.

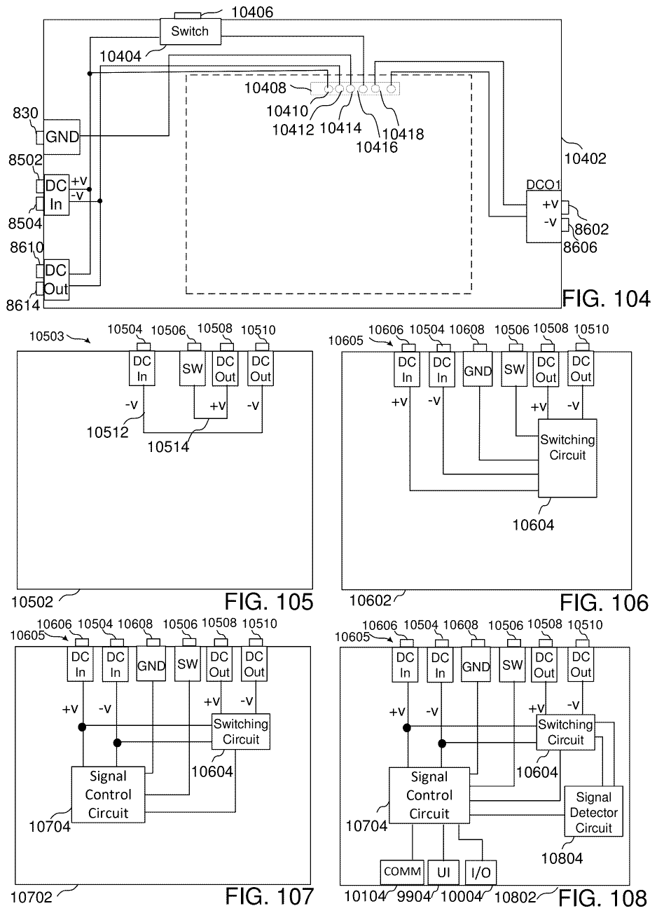

FIGS. 104 to 110 are directed implementations of a base portion configured to operate using a signal adapter. Turning first to FIG. 104, a circuit diagram of base portion of an electrical wiring device having a switch and adapted to receive a signal adapter in a partial partition arrangement is shown. A base portion 10402 of an electrical wiring device comprises a switch 10404 and a switch actuator 10406. An electrical interface 10408 may comprise a plurality of contact elements which may include a contact element 10410, a contact element 10412, a contact element 10414, a contact element 10416, and a contact element 10418. Unlike the implementation as shown in FIG. 102 for example which can operate without a signal adapter, the base portion of FIG. 104 requires a signal adapter to route a DC output signal to a load, such as a lighting element.

Various signal adapters that are adapted to be used with the base portion 10402 are shown in FIG. 104. Turning first to FIG. 105, a block diagram of a signal adapter having a switching circuit for controlling the application of an output signal in response to a switching signal from a switch of a base portion of an electrical wiring device is shown. The signal adapter 10502 comprises an electrical interface 10503 that may have a contact element 10504, a contact element 10506, a contact element 10508, a contact element 10510, a contact element 10512 (e.g., wiring on a circuit board or jumper wire), and a contact element 10514 (e.g., wiring on a circuit board or jumper wire) as shown.

Turning now to FIG. 106, a block diagram of a signal adapter having a switching circuit and a signal control circuit and user interface for controlling the application of an output signal in response to a switching signal from a switch of a base portion of an electrical wiring device is shown. The signal adapter 10602 may also comprise a switching circuit 10604 and a plurality of contact elements 10605 comprising a contact element 10606 and a contact element 10608, as shown.

Turning now to FIG. 107, a block diagram of a signal adapter having a switching circuit and an input/output port for controlling the application of an output signal in response to a switching signal from a switch of a base portion of an electrical wiring device is shown. The signal adapter 10702 may further comprise a signal control circuit 10704 as shown.

Turning now to FIG. 108, a block diagram of a signal adapter having a switching circuit and a communication circuit for controlling the application of an output signal in response to a switching signal from a switch of a base portion of an electrical wiring device is shown. The signal adapter 10802 may further comprise a signal detector circuit 10804 as shown.

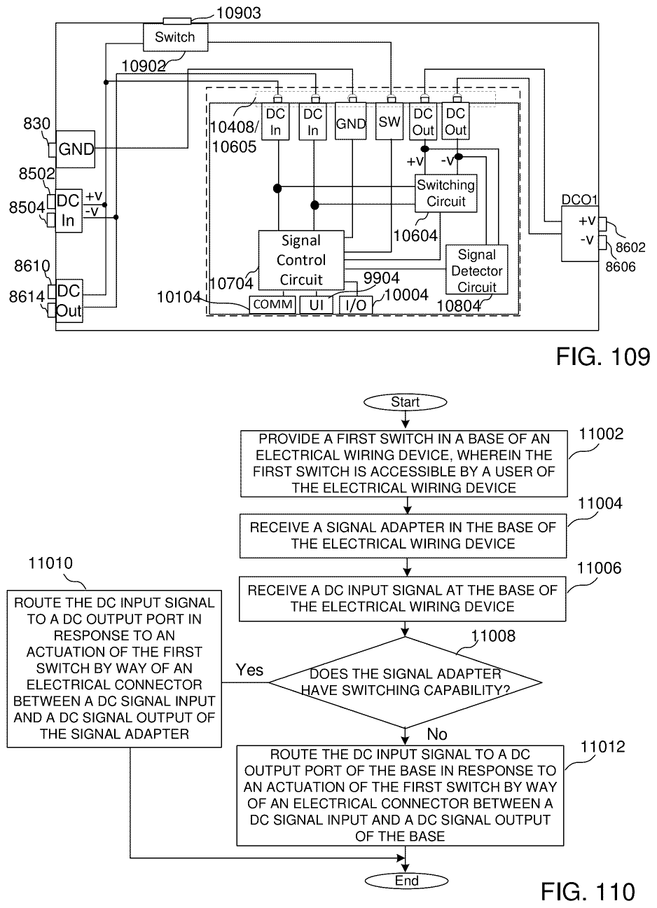

The circuit diagram of FIG. 109 shows a base portion of an electrical wiring device having a switch 10902 and switch actuator 10902 and having a signal adapter in a partial partition arrangement.

Turning now to FIG. 110, a flow chart shows a method of implementing an electrical wiring device having a base portion with a switch and a signal adapter for controlling the application of an output signal in response to a switching signal from a switch of a base portion of an electrical wiring device. A first switch is provided in a base of an electrical wiring device, wherein the first switch is accessible by a user of the electrical wiring device at a block 11002. A signal adapter is received in the base of the electrical wiring device at a block 11004. A DC input signal is received at the base of the electrical wiring device at a block 11006. It is then determined whether the signal adapter has switching capability at a block 11008. If so, the DC input signal is routed to a DC output port in response to an actuation of the first switch by way of an electrical connector between a DC signal input and a DC signal output of the signal adapter at a block 11010. By way of example, if a user selects the actuator 10903 of the switch 10902, a signal received at the SW contact element will be detected by the signal control circuit 10704, which will control the switching circuit 10604 to change the state of the output on the electrical connector 8602. If no, the DC input signal is routed to a DC output port of the base in response to an actuation of the first switch by way of an electrical connector between a DC signal input and a DC signal output of the base at a block 11012. The methods set forth in FIG. 110 may be implemented using the circuits and devices of at least FIGS. 104-109 for example as described above or other suitable circuits and devices.

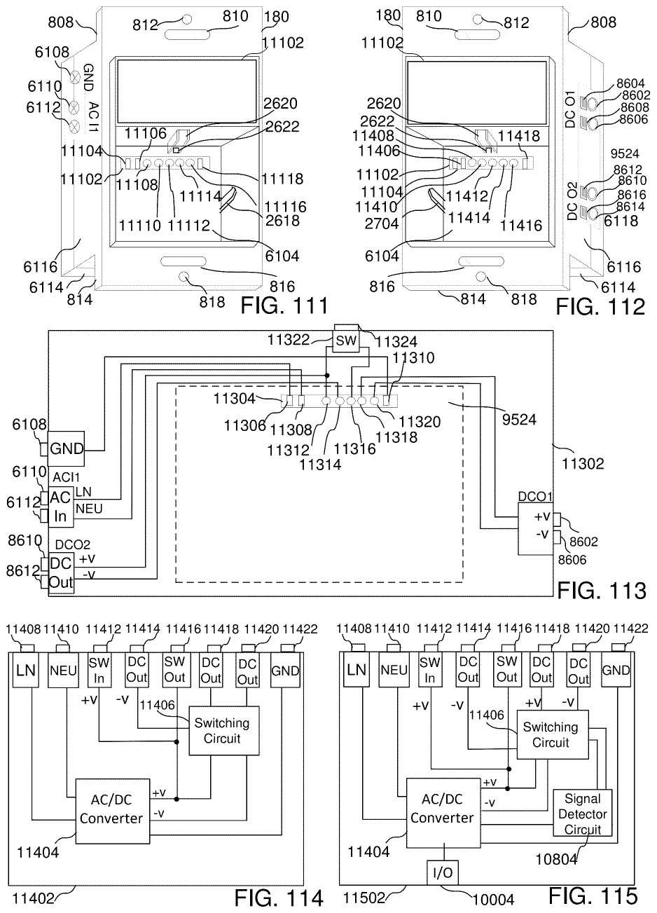

FIGS. 111-118 are directed to modular switches adapted to receive an AC input signal and generate a DC signal that may be routed to a load such as an LED light that is adapted to be powered by a DC power signal. As will be described in more detail below, a signal adapter may comprises an AC/DC converter to receive an AC input signal and generate a DC signal for powering the signal adapter and enabling the signal adapter to control the application of a DC output signal to a load. Turning first to FIG. 111, a left-side perspective view of a base portion of an electrical wiring device adapted to receive a signal adapter and having a switch and switch actuator is shown. The base portion comprises a switch actuator 11102 and a plurality of openings 11104 associated with an electrical interface, and may include for example an opening 11106, an opening 11108, an opening 11110, an opening 11112, an opening 11114, an opening 11116, and an opening 11118. FIG. 112 is a right-side perspective view of the base portion of the electrical wiring device shown in FIG. 111.

Turning now to FIG. 113, a circuit diagram of the electrical wiring device of FIG. 111 is shown. The base portion 11302 of an electrical wiring device comprises an electrical interface 11304 which may comprise a contact element 11306, a contact element 11308, a contact element 11310, a contact element 11312, a contact element 11314, a contact element 11316, a contact element 11318, and a contact element 11320. The base portion may also comprise a switch 11322 that is responsive to a switch actuator 11324.

FIGS. 114-117 are directed to signal adapters that are adapted to operate with the base portion of FIG. 113. Turning first to FIG. 114, a block diagram of a signal adapter having an AC/DC adapter and a switching circuit for controlling the application of a DC output voltage signal is shown. The signal adapter 11402 may comprise an AC/DC converter circuit 11404 for receiving an AC power signal (e.g., line and neutral voltages), and a switching circuit 11406 adapted to control the application of a DC power signal and DC output contact elements adapted to be coupled to a load. The base portion may comprise a plurality of contact elements including for example a contact element 11408, a contact element 11410, a contact element 11412, a contact element 11414, a contact element 11416, a contact element 11418, a contact element 11420, and a contact element 11422 as shown.

Turning now to FIG. 115, a block diagram of a signal adapter of FIG. 115 having an input/output device is shown. The signal adapter 11502 of FIG. 115 is similar to the signal adapter of FIG. 14, but includes the signal detector circuit 10804 as shown.

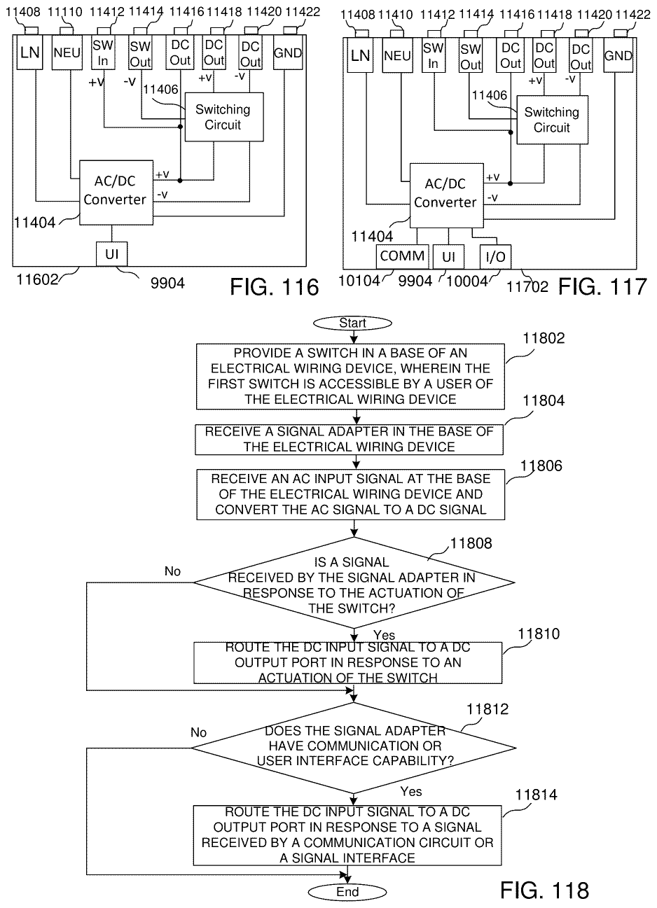

Turning now to FIG. 116, a block diagram of a signal adapter of FIG. 115 having an input/output device and a user interface is shown. The signal adapter 11602 is similar to the signal adapter of FIG. 14, but includes the user interface 9904 as shown.

Turning now to FIG. 117, a block diagram of a signal adapter of FIG. 115 having an input/output device, a user interface and a communication circuit is shown. The signal adapter 11702 further includes the communication circuit 10104.

Turning now to FIG. 118, a flow chart shows a method of implementing a signal adapter an AC/DC adapter and a switching circuit for controlling the application of a DC output voltage signal. A switch is provided in a base of an electrical wiring device at a block 11802, wherein the first switch is accessible by a user of the electrical wiring device. A signal adapter is received in the base of the electrical wiring device at a block 11804. An AC input signal is received at the base of the electrical wiring device and converted the AC signal to a DC signal at a block 11806. It is then determined whether a signal received by the signal adapter in response to the actuation of the switch at a block 11808. If so, the DC input signal is routed to a DC output port in response to an actuation of the switch at a block 11810. It is then determined if the signal adapter has communication or user interface capability at a block 11812. If so, the DC input signal is routed to a DC output port in response to a signal received by a communication circuit or a signal interface at a block 11814. The methods set forth in FIG. 118 may be implemented using the circuits and devices of at least FIGS. 111-117 for example as described above or other suitable circuits and devices.

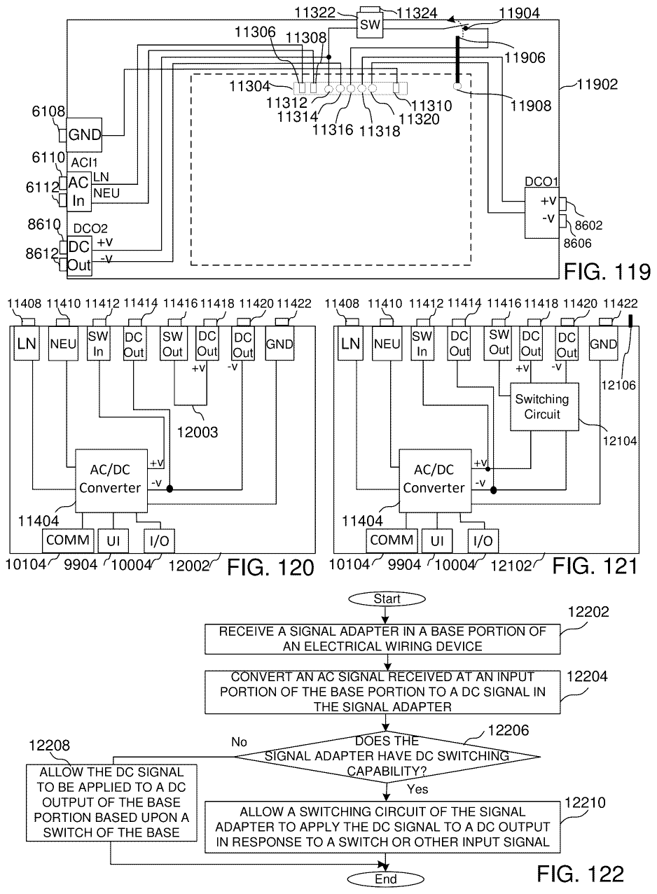

The implementations of FIGS. 119-122 are directed to base portions that receive an AC input signal and generate a DC output signal but may operate without a signal adapter. That is, the base portion 11902 is adapted to operate as a simple switch responsive to the switch on the base portion without a signal adapter, or responsive to the switch on the base portion and signals received by a signal adapter, as will be described in more detail below. Turning first to FIG. 119, a base portion of an electrical wiring device adapted to receive a signal adapter and having an actuator for engaging a switch is shown. The base portion 11902 of an electrical wiring device comprises a switch 11904 that is responsive to an actuator 11906. The base portion also comprises an opening 11908 that is adapted to receive an actuator of a signal adapter, as described above in reference to FIG. 97 for example.

Turning now to FIG. 120, a signal adapter adapted to be received by the base of FIG. 119 is shown. The signal adapter 12002 may comprise an electrical connector 12003 that is adapted to route the +v DC power signal to the load in response to the switching of the switch 11322 as shown.

Turning now to FIG. 121, a signal adapter adapted to be received by the base and comprising an actuator adapted engage the switch of the base portion of FIG. 119 is shown. The signal adapter 12102 comprises a switching circuit 12104 for controlling the application of the DC power signal to the load. The signal adapter may also comprise an actuator element 12106 for engaging the switch 11904 to block the application of the DC power signal to the load.

Turning now to FIG. 122, a flowchart shows a method of implementing the base portion of FIG. 119. A signal adapter is received in a base portion of an electrical wiring device at a block 12202. An AC signal received at an input portion of the base portion is converted to a DC signal in the signal adapter at a block 12204. It is then determined whether the signal adapter has DC switching capability at a block 12206. If so, the DC signal is allowed to be applied to a DC output of the base portion based upon a switch of the base at a block 12208. If not, a switching circuit of the signal adapter is allowed to apply the DC signal to a DC output of the base portion in response to a switch of the base or other input signal at a block 12210. The methods set forth in FIG. 122 may be implemented using the circuits and devices of at least FIGS. 119-121 for example as described above or other suitable circuits and devices.

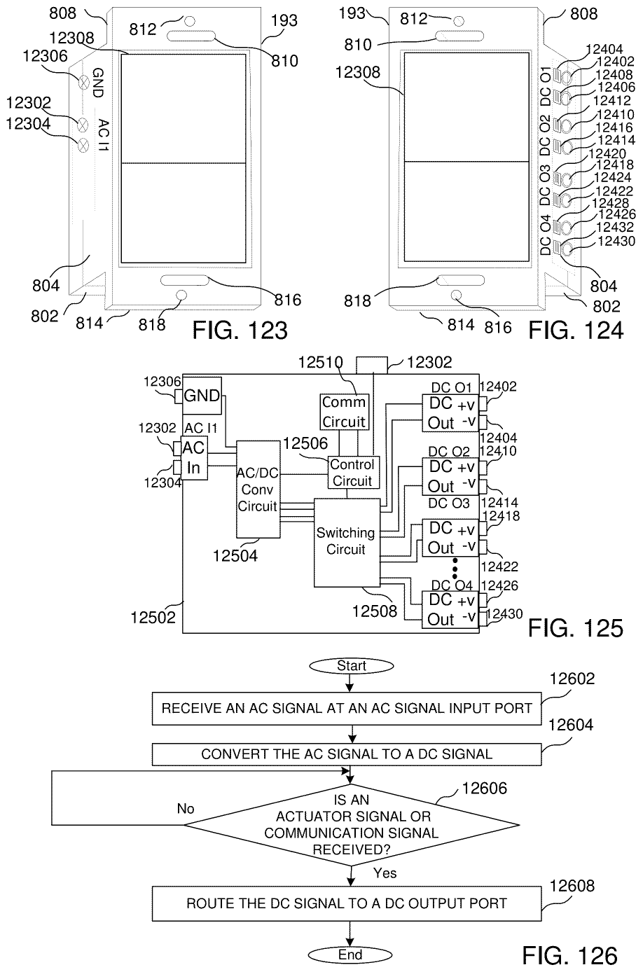

Unlike some of the modular switches described above, FIGS. 123-126 are directed to an electrical wiring device that comprises a single unit, where the wiring devices of FIG. 123-126 receive an AC input signal and generate a DC output signal that is routed to load, such as lighting elements. Turning first to FIG. 123, a left-side perspective view of an electrical wiring device is shown. electrical connector 12302. electrical connector 12304. electrical connector 12306. actuator element 12308. The right-side perspective view of the electrical wiring device of FIG. 124 shows additional electrical connectors, including for example an electrical connector 12402. connector actuator 12404, an electrical connector 12406 and a corresponding connector actuator 12408, an electrical connector 12410 and a corresponding connector actuator 12412, an electrical connector 12414 and a corresponding connector actuator 12416, an electrical connector 12418 and a corresponding connector actuator 12420, an electrical connector 12422 and a corresponding connector actuator 12424, an electrical connector 12426 and a corresponding connector actuator 12428, and an electrical connector 12430 and a corresponding connector actuator 12432.

Turning now to FIG. 125, a block diagram of the electrical wiring device, such as the electrical wiring device of FIG. 123, is shown. The electrical wiring device 12502 comprises an AC/DC converter circuit 12504, a control circuit 12506, a switching circuit 12508, and communication circuit 12510 as shown.

Turning now to FIG. 126, a flow chart shows a method of generating a DC output signal based upon an AC input signal received at an electrical wiring device. An AC signal is received at an AC signal input port at a block 12602. The AC signal is converted to a DC signal at a block 12604. It is then determined whether an actuator signal or communication signal received at a block 12606. The DC signal is routed to a DC output port at a block 12608. The methods set forth in FIG. 126 may be implemented using the circuits and devices of at least FIGS. 120-125 for example as described above or other suitable circuits and devices.

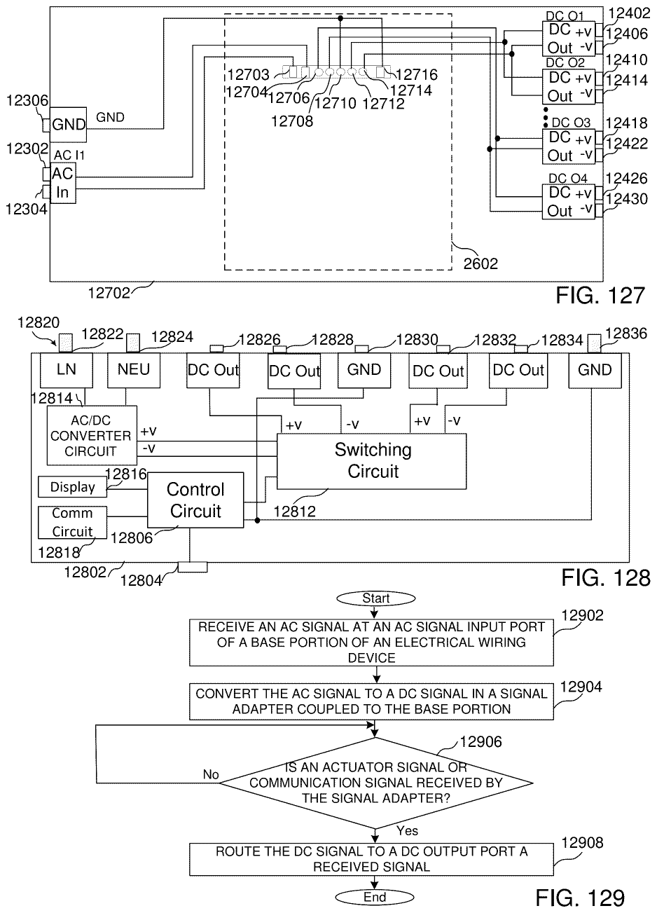

FIGS. 127-129 are related to modular switches receiving DC inputs and generating DC outputs, where the modular arrangement comprises a full modular arrangement. Turning first to FIG. 127, a circuit diagram of a base portion of an electrical wiring device adapted to receive a signal adapter adapted to receive an AC signal and generate a DC signal is shown. A base portion 12702 of an electrical wiring device comprises a plurality of contact elements which may include a contact element 12703, a contact element 12704, a contact element 12706, a contact element 12708, a contact element 12710, a contact element 12712, a contact element 12714, and a contact element 12716. It should be noted that the contact element 12703, the contact element 12704, and the contact element 12716, shown as triangles comprise contact elements adapted to receive AC signals, such as 120V AC signals, while the remaining contact elements comprise contact elements adapted to receive lower voltage DC signals, such as between 0 and 50V DC, as described herein.

Turning now to FIG. 128, a block diagram of a signal adapter adapted to be received by the base portion of an electrical wiring device is shown. The signal adapter 12802 comprises a control circuit 12806 is coupled to the switch actuator 12804 and a switching circuit 12812. The signal adapter also comprises an AC/DC converter circuit 12814 coupled to receive a line voltage signal and a neutral voltage signal. The control circuit is also coupled to a display 12816 and a communication device 12818. An electrical interface 12820 comprises a plurality of electrical connectors which may include an electrical connector 12822, an electrical connector 12824, an electrical connector 12826, an electrical connector 12828, an electrical connector 12830, an electrical connector 12832, an electrical connector 12834, and an electrical connector 12836.

Turning now to FIG. 129, a flow chart shows a method of implementing a signal adapter having an AC/DC converter circuit and an actuator for controlling the application of a DC output signal to an output of the electrical wiring device. An AC signal is received at an AC signal input port of a base portion of an electrical wiring device at a block 12902. The AC signal is converted to a DC signal in a signal adapter coupled to the base portion at a block 12904. It is then determined whether an actuator signal or communication signal is received by the signal adapter at a block 12906. The DC signal is routed to a DC output port a received signal at a block 12908. The methods set forth in FIG. 129 may be implemented using the circuits and devices of at least FIGS. 127-128 for example as described above or other suitable circuits and devices.

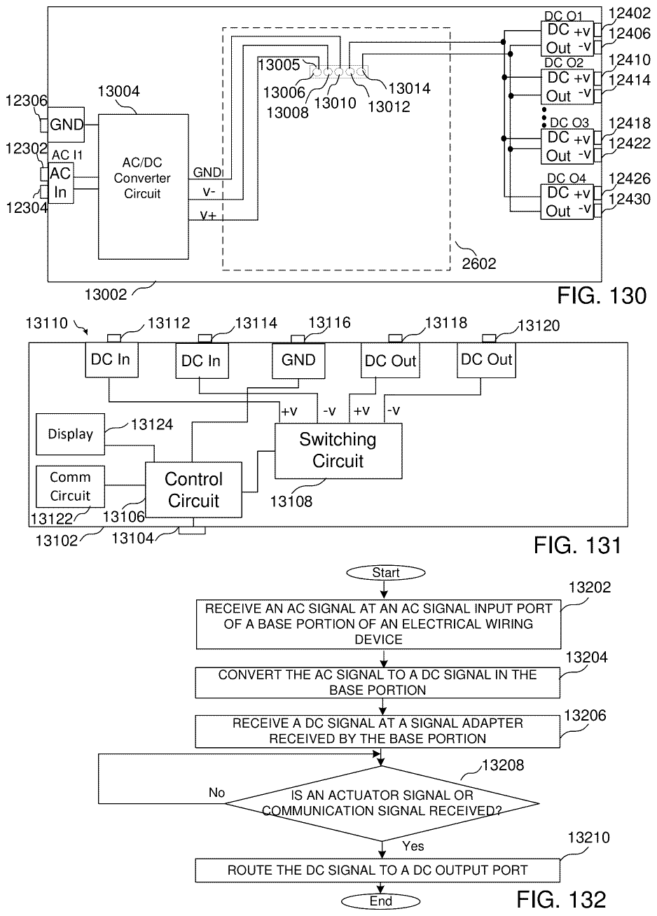

FIGS. 130-132 are also related to modular switches receiving DC inputs and generating DC outputs, where the modular arrangement comprises a full modular arrangement. However, unlike the implementation of FIGS. 127-129, the AC/DC converter circuit is provided in the base portion of the electrical wiring device. Turning first to FIG. 130 is a block diagram of a base portion of an electrical wiring device having an AC/DC converter circuit is shown. A base portion 13002 of an electrical wiring device comprises an AC/DC converter device 13004 and an electrical interface 13005 comprising a plurality of contact elements which might include a contact element 13006, a contact element 13008, a contact element 13010, a contact element 13012, and a contact element 13014.

Turning now to FIG. 131, a block diagram of a signal adapter adapted to be received by the base portion of the electrical wiring device of FIG. 130 is shown. The signal adapter 13102 comprises an actuator element 13104, a control circuit 13106, and a switching circuit 13108 as shown. The electrical interface 13110 may comprise a plurality of contact elements which may include a contact element 13112, a contact element 13114, a contact element 13116, a contact element 13118, and a contact element 13120. The signal adapter 13102 may also comprise a communication circuit 13122 and a display 13124.

Turning now to FIG. 132, a flow chart shows a method of controlling the application of a DC signal applied to a load by a power adapted received by a base portion having an AC/DC converter circuit. An AC signal is received at an AC signal input port of a base portion of an electrical wiring device at a block 13202. The AC signal is converted to a DC signal in the base portion at a block 13204. A DC signal is received at a signal adapter received by the base portion at a block 13206. It is then determined whether an actuator signal or communication signal is received at a block 13208. The DC signal is routed to a DC output port at a block 13210. The methods set forth in FIG. 132 may be implemented using the circuits and devices of at least FIGS. 130-131 for example as described above or other suitable circuits and devices.

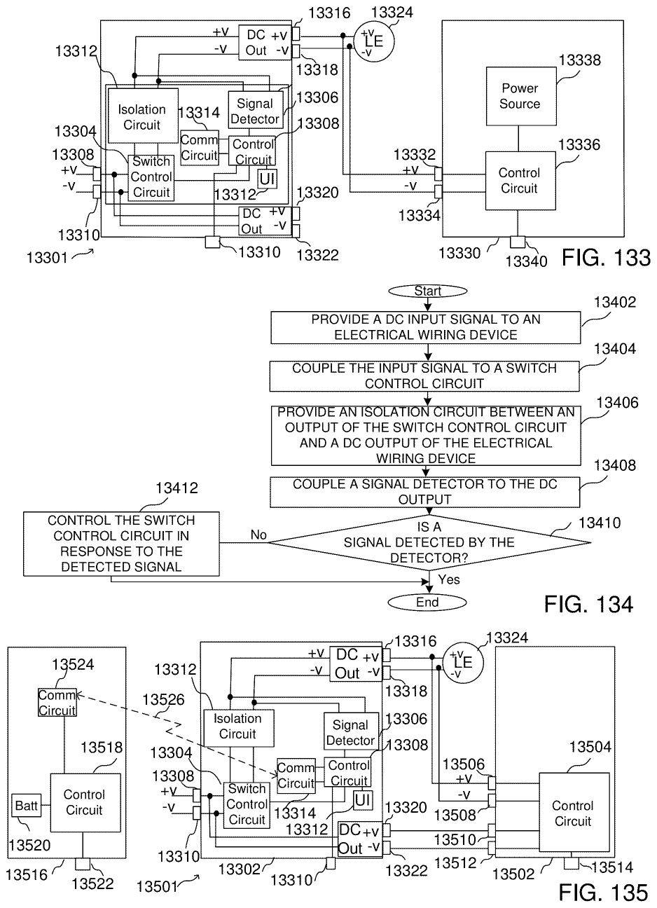

Turning now to FIGS. 133-134, other modular switches receiving a DC input and generating a DC output are shown. Turning first to FIG. 133, a system level diagram comprising a primary electrical wiring device coupled to control a load comprising a lighting element (LE) and a secondary wiring device adapted to communicate with the primary electrical wiring device over DC output signal lines of the primary electrical wiring device is shown. The system 13301 may comprise an electrical wiring device 13302, a switch control circuit 13304, a signal detector 13306, a control circuit 13308 as shown. An actuator element 13310 is provided to enable a changing of the status of the application of power to the load. The system 13301 may also comprise an isolation circuit 13312. A communication circuit 13314, which may be a wireless communication circuit for example, may also be implemented. electrical connector 13316. The system comprises a plurality of electrical connectors, including for example an electrical connector 13318, an electrical connector 13320, and an electrical connector 13322 as shown. A load (lighting element (LE)) 13324 of the system may be controlled by two switch actuators. That is, the system may also comprise a remote switch 13330 comprising an input 13332 and an input 13334. A control circuit 13336, a power source 13338, and an actuator element 13340 also enables the transmission of signals between the switches.

Turning now to FIG. 134, a flow chart shows a method of controlling the application of a DC signal to a load in response to a signal received over DC output signal lines. A DC input signal Provide to an electrical wiring device at a block 13402. The input signal is coupled to a switch control circuit at a block 13404. An isolation circuit Provide between an output of the switch control circuit and a DC output of the electrical wiring device at a block 13406. A signal detector is coupled to the DC output at a block 13408. It is determined whether a signal is detected by the detector at a block 13410. If not, the switch control circuit is controlled in response to the detected signal at a block 13412. The methods set forth in FIG. 134 may be implemented using the circuits and devices of at least FIG. 133 for example as described above or other suitable circuits and devices.

Turning now to FIGS. 135-137, other modular switching devices that are adapted to receive a DC input and generate a DC output are shown. Turing first to FIG. 135, a system level diagram comprising a primary electrical wiring device coupled to control a load and a secondary wiring device adapted to communicate with the primary electrical wiring device over a first set of DC output signal lines of the primary electrical wiring device and receive power over a second set of DC output signal lines is shown. The system 13501 of FIG. 135 comprises a control device 13502 and a control circuit 13504. The control device 13502 may comprise a plurality of electrical connectors, including for example an electrical connector 13506, an electrical connector 13508, an electrical connector 13510, and an electrical connector 13512. The control circuit 13504 is responsive to a switch element 13514. A remote switch device 13516 may comprise a control circuit 13518, a battery 13520, a switch actuator 13522, a communication circuit 13524, and wireless communication link 13526 as shown.

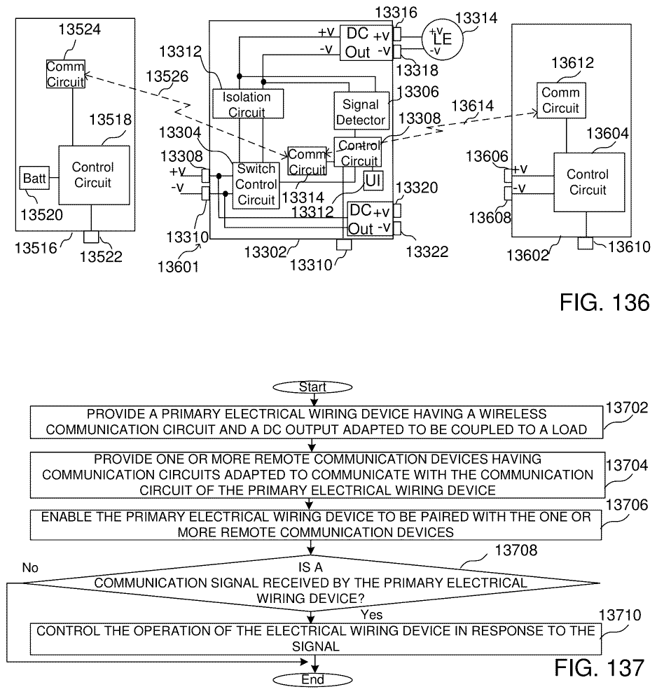

Turning now to FIG. 136, a system level diagram comprising a primary electrical wiring device coupled to control a load and a remote electrical wiring device powered by a DC power signal and adapted to communicate with the primary electrical wiring device by way of a wireless communication signal and a remote device powered by a battery. The system 13601 comprises a remote switch device 13602 having a control circuit 13604 and a plurality of electrical connectors that may include an electrical connector 13606, an electrical connector 13608, and an actuator element 13610. The remote switch device 13602 may comprise a communication circuit 13612 adapted to communicate by a wireless communication link 13614. The methods set forth in FIG. 137 may be implemented using the circuits and devices of FIGS. 135-136 as described above or other suitable circuits and devices.

Turning now to FIG. 137 is a flow chart showing a method of implementing an electrical wiring device adapted to communicate with one or more remote devices to control the application of DC power to a load is shown. A primary electrical wiring device having a wireless communication circuit and a DC output adapted to be coupled to a load is provided at a block 13702. One or more remote communication devices having communication circuits adapted to communicate with the communication circuit of the primary electrical wiring device is provided at a block 13704. The primary electrical wiring device is enabled to be paired with the one or more remote communication devices at a block 13706. It is then determined whether a communication signal is received by the primary electrical wiring device at a block 13708. The operation of the electrical wiring device is controlled in response to the signal at a block 13710. The method set forth in FIG. 137 may be implemented using the circuits and devices of at least FIGS. 135-136 for example as described above or other suitable circuits and devices.

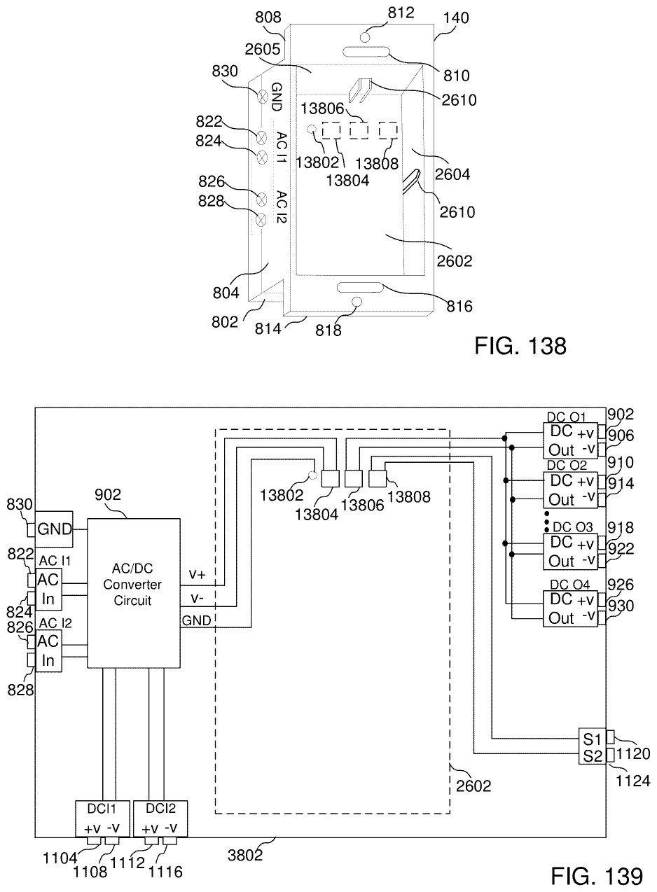

FIGS. 138-176 relate implementations that use inductive coupling between a base portion and a signal adapter of an electrical wiring device than physical contact elements. It should be understood that, while a single induction circuit may be shown in cases where multiple signals are transmitted, multiple induction circuits are implemented. Turning first to FIG. 138, a left-side perspective view of a base portion for receiving an DC/DC converter circuit or a signal adapter for switching a DC output signal to electrical connectors of a DC output and wireless signal transmission circuits is shown. The base portion of FIG. 138 comprises a ground contact element 13802, a plurality of induction circuits (shown in dashed lines for being inside of the base portion) that are adapted to transmit or receive DC signals, including for example an induction circuit 13804, an induction circuit 13806, and an induction circuit 13808 which are also shown in FIG. 139.

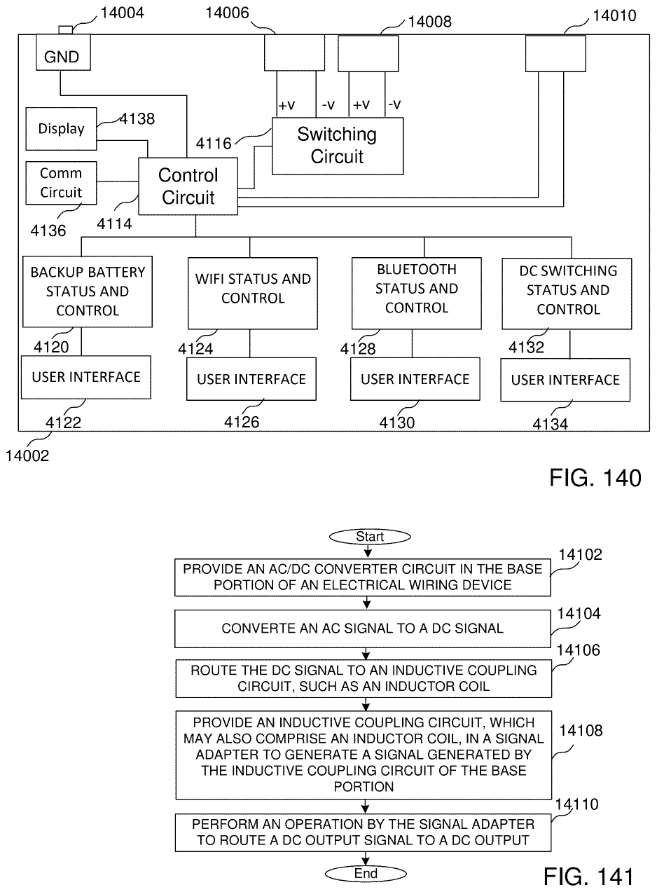

Turning now to FIG. 140, a block diagram of a signal adapter adapted to be received by the base portion of FIG. 139 and wireless signal transmission circuits is shown. Signal adapter 14002 may be implemented base portion as shown in FIG. 139. Signal adapter 14002 may comprise a ground contact element 14004, an induction circuit 14006, an induction circuit 14008 and an induction circuit 14010 for transmitting signals to the base portion of FIG. 139, and particularly electrical connectors 1120 and 1124.

Turning now to FIG. 141, a flow chart shows a method of routing a DC signal received by a base portion and routed to a DC output. An AC/DC converter circuit is provided in the base portion of an electrical wiring device at a block 14102. An AC signal is converted to a DC signal at a block 14104. The DC signal is routed to an inductive coupling circuit, such as an inductor coil, at a block 14106. An inductive coupling circuit, which may also comprise and inductor coil, is provided in a signal adapter to generate a signal generated by the inductive coupling circuit of the base portion at a block 14108. An operation is performed by the signal adapter to route a DC output signal to a DC output at a block 14110. The method of FIG. 141 may be implemented using the circuits and devices of FIGS. 138-140 for example, or other suitable circuits and devices.

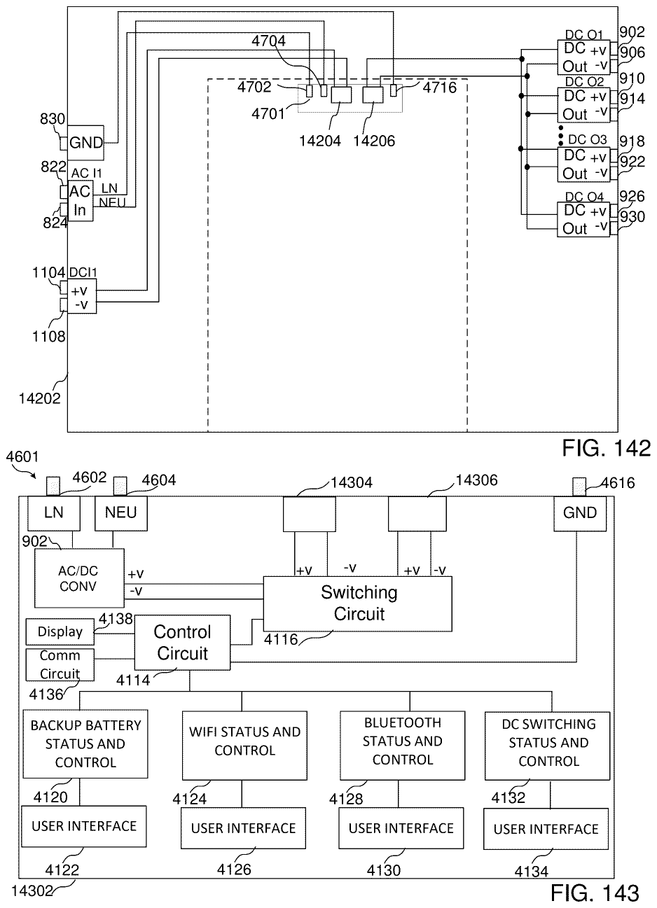

The implementations of FIGS. 142 and 143 relate to a base portion and signal adapter that communicate using inductive coupling circuits, where the base portion is adapted to receive an AC input signal. Turning first to FIG. 142, a block diagram of an electrical circuit of a base portion 14202 having an electrical interface comprising contact elements adapted to transmit AC signals and wireless signal transmission circuits is shown. The base portion comprises an induction circuit 14204 and an induction circuit 14206 as shown. A block diagram of a signal adapter 14302 shown in FIG. 143 is adapted to receive AC signals and wireless signal transmission circuits for receiving DC signals and to communicate with the base portion of FIG. 142 is shown. The signal adapter comprises an induction circuit 14304 and an induction circuit 14306 as shown.

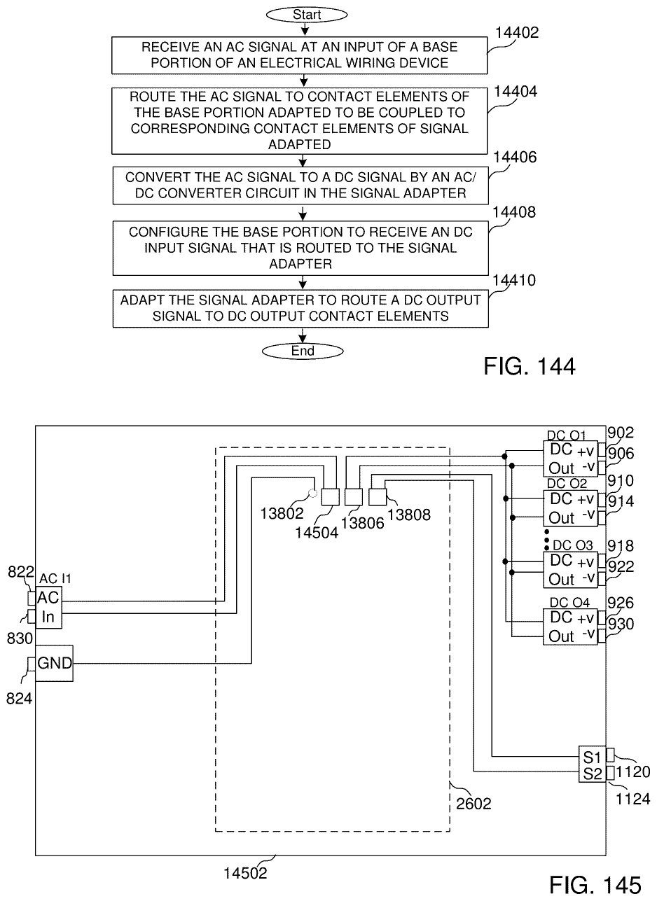

Turning now to FIG. 144, a flow chart shows a method of implementing a base portion adapted to receive both AC signals and DC signals. An AC signal is received at an input of a base portion of an electrical wiring device at a block 14402. The AC signal is routed to contact elements of the base portion adapted to be coupled to corresponding contact elements of signal adapted at a block 14404. The AC signal is converted to a DC signal by an AC/DC converter circuit in the signal adapter at a block 14406. The base portion is configured to receive an DC input signal that is routed to the signal adapter at a block 14408. The signal adapter is adapted to route a DC output signal to DC output contact elements at a block 14410. The method set forth in FIG. 144 may be implemented using the circuits and devices of at least FIGS. 142-143 for example as described above or using other suitable circuits and devices.

Turning now to FIG. 145 is a block diagram of an electrical circuit of a base portion 14502 adapted to receive AC input signals and provide DC signals to a signal adapter by way of a wireless signal transmission circuits is shown. The base portion. comprises an induction circuit 14504. That is, rather than implement a separate AC/DC conversion circuit in the signal adapter as shown in FIG. 143, the AC/DC conversion is performed by the induction circuit 14504 of the base portion 14502.

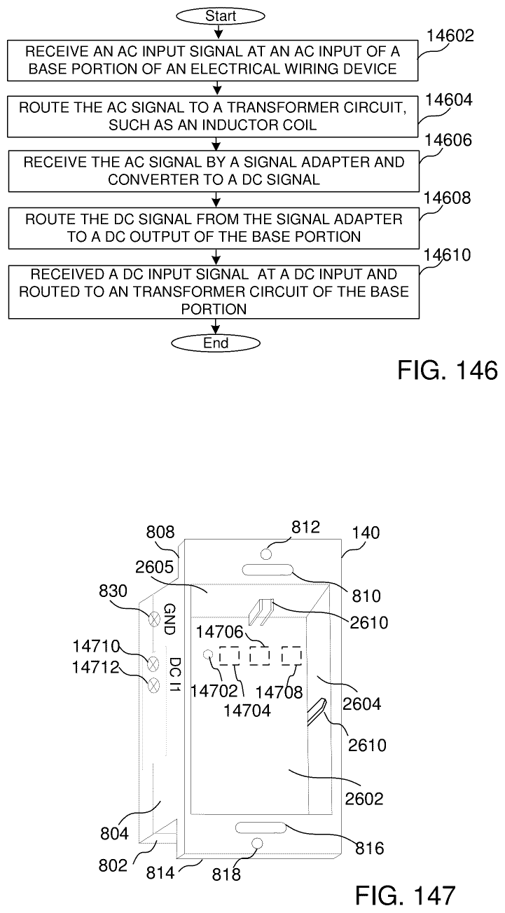

Turning now to FIG. 146, a flow chart shows a method of implementing a base portion that receives AC input signals and enable the transmission of power to a signal adapted by way of a wireless signal transmission circuit. An AC input signal is received at an AC input of a base portion of an electrical wiring device at a block 14602. The AC signal is routed to a transformer circuit, such as an inductor coil, at a block 14604. The AC signal is received by a signal adapter and converter to a DC signal at a block 14606. The DC signal is routed from the signal adapter to a DC output of the base portion at a block 14608. A DC input signal may be received at a DC input and routed to a transformer circuit of the base portion at a block 14610. The method set forth in FIG. 146 may be implemented using the circuits and devices of at least FIG. 145 for example as described above or using other suitable circuits and devices.

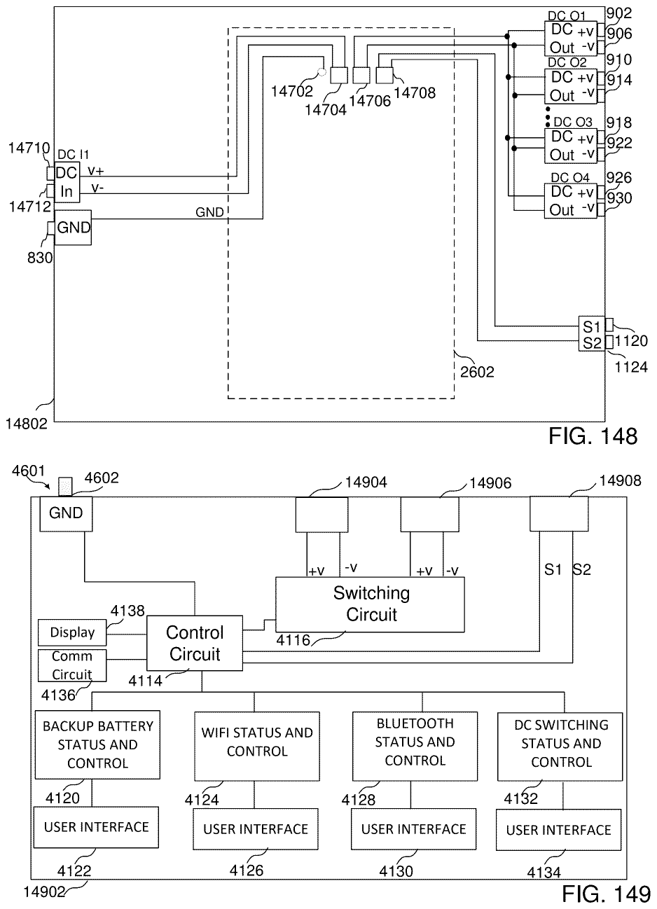

Turning now to FIG. 147, a perspective view of a base portion adapted to receive DC input signals and wireless signal transmission circuits for transmitting the DC input signals to a signal adapter is shown. The base portion of FIG. 147 comprises a ground contact 14702, an induction circuit 14704, an induction circuit 14706, and an induction circuit 14708 as shown, and may be implemented using the block diagram of the base portion 14802 as shown in FIG. 148 for receiving DC input signals and wireless signal transmission circuits for transmitting the DC input signals to a signal adapter using wireless signal transmission circuits. A contact element 14710 and a contact element 14712 are provided for receiving DC input signals (e.g., +v and −v). While the contact element 14710 and contact element 14712 are shown by way of example as screw terminals, it should be understood that they could be other types of contact elements, such as the contact elements and corresponding actuators as shown above or wires extending from the base portion.

Turning now to FIG. 149, a block diagram of a signal adapter 14902 adapted to receive DC signals from a base portion using wireless signal transmission circuits and transmit DC signals and communication signals to electrical connectors of a base portion and configured to communicate with the circuit of FIG. 146 is shown. Signal adapter 14902 comprises an induction circuit 14904, an induction circuit 14906, and an induction circuit 14908 as shown.

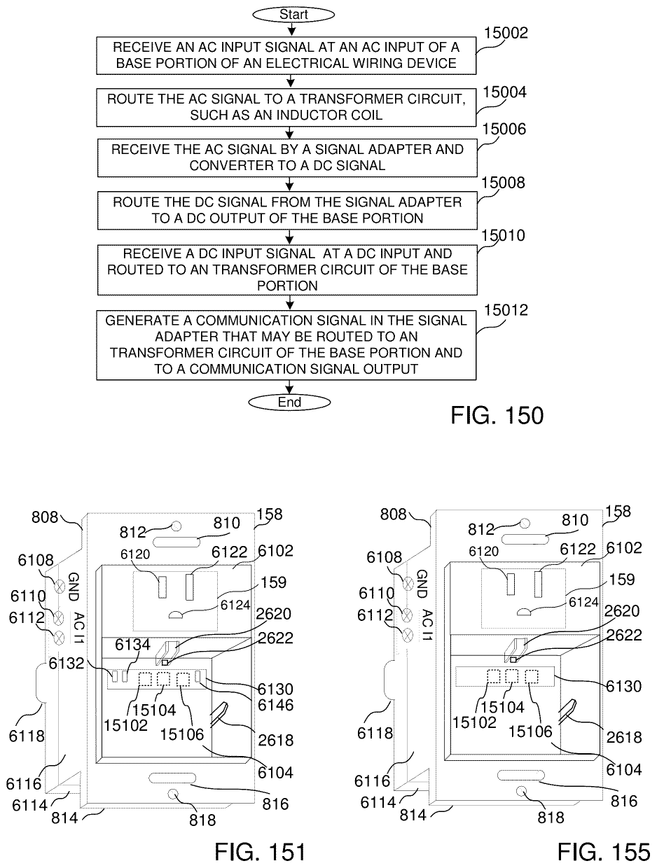

Turning now to FIG. 150, a flow chart shows a method of receiving DC signals from a base portion using wireless signal transmission circuits and transmitting DC signals and communication signals to electrical connectors of a base portion. An AC input signal is received at an AC input of a base portion of an electrical wiring device at a block 15002. The AC signal is routed to a transformer circuit, such as an inductor coil, at a block 15004. The AC signal is received by a signal adapter and converter to a DC signal at a block 15006. The DC signal is routed from the signal adapter to a DC output of the base portion at a block 15008. A DC input signal may be received at a DC input and routed to a transformer circuit of the base portion at a block 15010. A communication signal generated in the signal adapter may be routed to an transformer circuit of the base portion and to a communication signal output at a block 15012. The method set forth in FIG. 150 may be implemented using the circuits and devices of at least FIGS. 147-148 for example as described above or using other suitable circuits and devices.

FIGS. 151-158 are related to base portions having a receptacle, and having inductive coupling circuits for communicating power and communication signals between a base portion and a signal adapter. Turning first to FIG. 151, a perspective view of a base portion of an electrical wiring device having an outlet and wireless signal transmission circuits for wireless signal communication between the electrical wiring device and a signal adapter and contact elements for routing AC signals is shown. In addition to contact elements adapted to receive AC power signals, such as some of line neutral and ground, and induction circuits, such as an induction circuit 15102, an induction circuit 15104, and an induction circuit 15106 as shown.

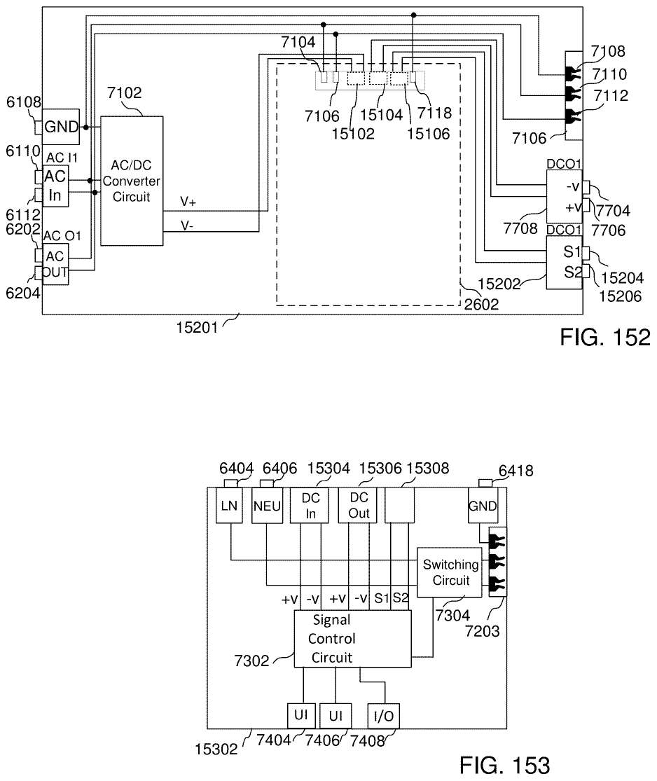

A block diagram of a circuit for a base portion 15201 of an electrical wiring device having an outlet and wireless signal transmission circuits is shown in FIG. 152, while a block diagram of signal adapter having wireless signal transmission circuits and contact elements for receiving AC signals and adapted to be electrically coupled to the base portion of FIG. 151 is shown in FIG. 153. The base portion may also comprise a signal output 15202 having a contact element 15204 and a contact element 15206 for transmitting signals, which may be designated signals S1 and S2 for example. The signal adapter 15302 may comprise an induction circuit 15304, an induction circuit 15306, an induction circuit 15308 as shown.

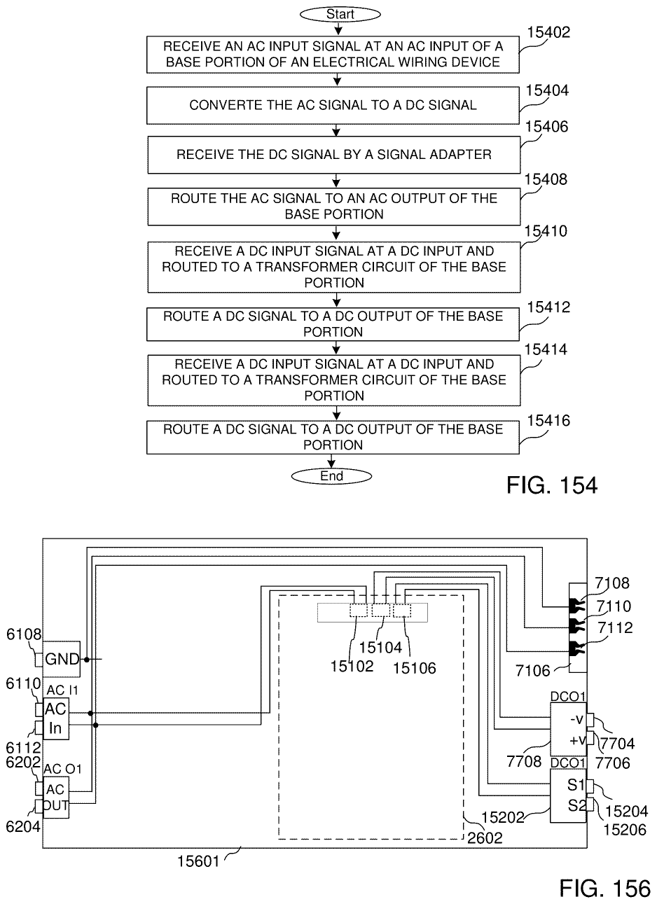

Turning now to FIG. 154, a flow chart shows a method of implementing a base portion of an electrical wiring device having an outlet and wireless signal transmission circuits. An AC input signal is received at an AC input of a base portion of an electrical wiring device at a block 15402. The AC signal is converted to a DC signal at a block 15404. The DC signal is received by a signal adapter at a block 15406. The AC signal is routed to an AC output of the base portion at a block 15408. A DC input signal may be received at a DC input and routed to a transformer circuit of the base portion at a block 15410. A DC signal is routed to a DC output of the base portion at a block 15412. A communication signal generated in the signal adapter may be routed to an transformer circuit of the base portion and to a communication signal output at a block 15414. The AC signal may also be routed to an AC output and contact elements of a receptacle at a block 15416. The method set forth in FIG. 154 may be implemented using the circuits and devices of at least FIGS. 151-154 for example as described above or using other suitable circuits and devices.

Turning now to FIG. 155, a block diagram of a base portion of an electrical wiring device having an outlet and wireless signal transmission circuits for wireless signal communication between the electrical wiring device and a signal adapter is shown. Rather than providing contact elements adapted to provide power to a signal adapter also having a receptacle, any signals are transmitted using inductive coupling. It should be understood that the inductive coupling circuits may transmit enough power to enable the use of a receptacle in the signal adapter (i.e., the signal adapter will having the necessary circuitry to convert the received signal to a 120V AC signal applied to a device plugged into the receptacle of the signal adapter). According to other implementations, the signals transferred between the base portion and the signal adapter enable the generation of a DC signal for implementing low voltage applications in the signal adapter.

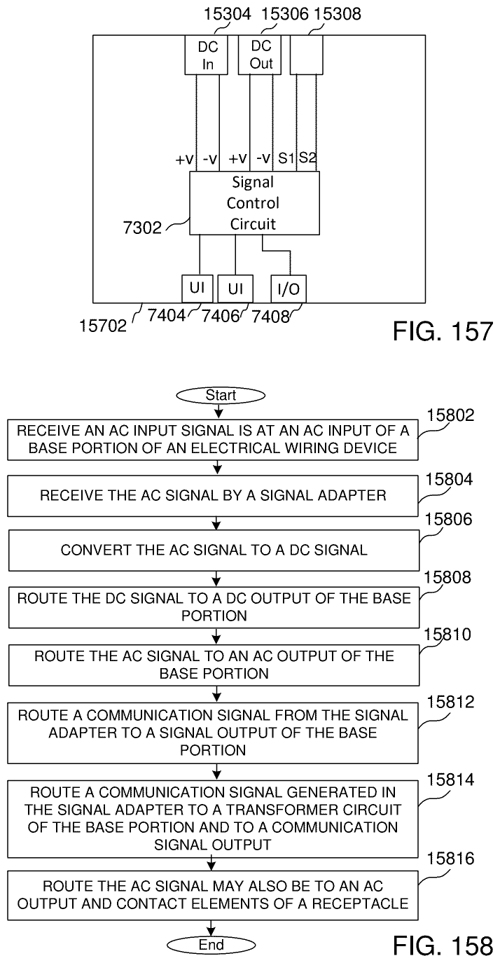

Turning now to FIG. 156, a block diagram of an electrical circuit having wireless signal transmission circuits for transmitting signals to a signal adapter is shown. In addition to a receptacle, a base portion 15601 comprises contact elements to route both AC signals and DC signals to other devices, as well as signals that may be communicated between a signal adapter and another device, such as another electrical wiring device. A block diagram of a signal adapter 15702 having wireless signal transmission circuits and adapted to be electrically coupled to the electrical circuit of the base portion of FIG. 156 is shown in FIG. 157.

Turning now to FIG. 158, a flow chart shows a method of implementing an electrical wiring device having a base portion and a signal adapted configured to transmit wireless signals. An AC input signal is received at an AC input of a base portion of an electrical wiring device at a block 15802. The AC signal is received by a signal adapter at a block 15804. The AC signal is converted to a DC signal at a block 15806. The DC signal is routed to a DC output of the base portion at a block 15808. The AC signal is routed to an AC output of the base portion at a block 15810. A communication signal is routed from the signal adapter to a signal output of the base portion at a block 15812. A communication signal generated in the signal adapter may be routed to a transformer circuit of the base portion and to a communication signal output at a block 15814. The AC signal may also be routed to an AC output and contact elements of a receptacle at a block 15816. The method set forth in FIG. 158 may be implemented using the circuits and devices of at least FIGS. 155-157 for example as described above or using other suitable circuits and devices.

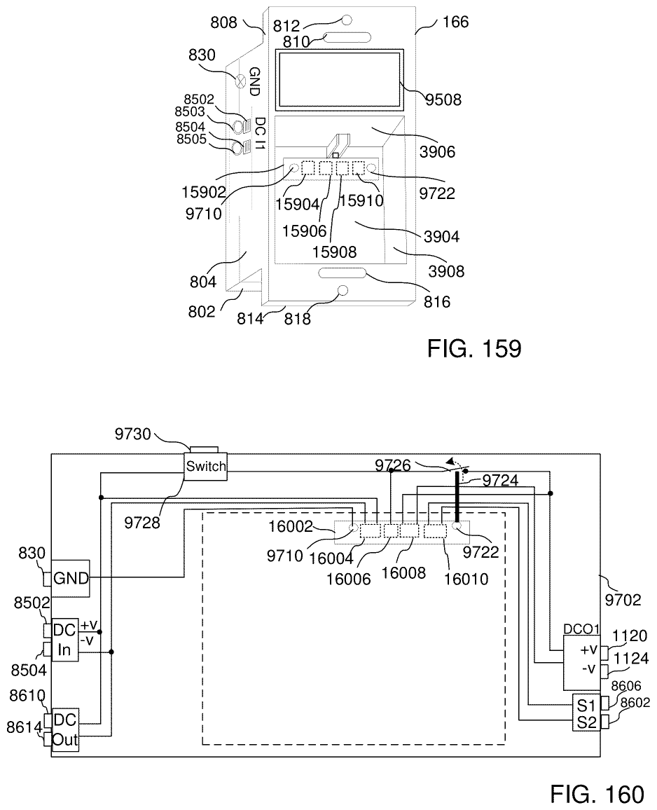

Turning now to FIG. 159, a perspective view of a base portion of an electrical wiring device adapted to receive a DC input signal and having a switch and wireless signal transmission circuits is shown. The base portion of FIG. 159 comprises an electrical interface 15902 which may comprise an induction circuit 15904, an induction circuit 15906, an induction circuit 15908, and an induction circuit 15910 as shown.

Turning now to FIG. 160, a block diagram of a circuit for implementing a base portion of an electrical wiring device adapted to receive a DC input signal and having a switch and wireless signal transmission circuit is shown. The circuit of FIG. 160 comprises an electrical interface 16002, an induction circuit 16004, an induction circuit 16006, an induction circuit 16008, and an induction circuit 16010 for transmitting signals as shown. The switching aspect of the circuit of FIG. 160 operates in a similar manner as described above in reference to FIG. 97 for example.

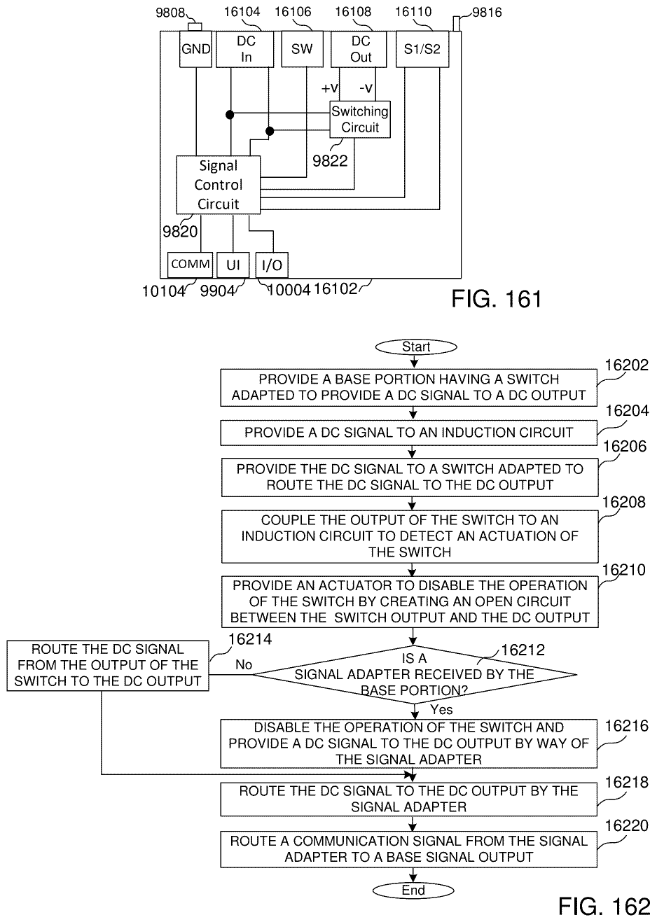

Turning now to FIG. 161, a block diagram of a signal adapter adapted to communicate DC signals using wireless signal transmission circuits and adapted to be coupled to the base portion of FIG. 159 is shown. Signal adapter 16102 of FIG. 161 comprises a plurality of induction circuits, which may include an induction circuit 16104, an induction circuit 16106, an induction circuit 16108, and an induction circuit 16110 for transmitting signals as shown.

Turning now to FIG. 162, a flow chart shows a method of implementing a base portion of an electrical wiring device adapted to receive a DC input signal and having a switch and wireless signal transmission circuits. A base portion having a switch adapted to provide a DC signal to a DC output is provided at a block 16202. A DC signal is provided to an induction circuit at a block 16204. The DC signal is also provided to a switch that is adapted to route the DC signal to the DC output at a block 16206. The output of the switch is coupled to an induction circuit to detect an actuation of the switch at a block 16208. An actuator is provided to disable the operation of the switch by creating an open circuit between the output of the switch and the DC output at a block 16210. It is determined if a signal adapter received by the base portion at a block 16212. If not, the DC signal is routed from the output of the switch to the DC output at a block 16214. If so, the operation of the switch is disabled and a DC signal is provided to the DC output by way of the signal adapter at a block 16216. The DC signal is routed to the DC output by the signal adapter at a block 16218. A communication signal is routed from the signal adapter to a signal output of the base portion at a block 16220. The method set forth in FIG. 162 may be implemented using the circuits and devices of at least FIGS. 159-161 for example as described above or using other suitable circuits and devices.

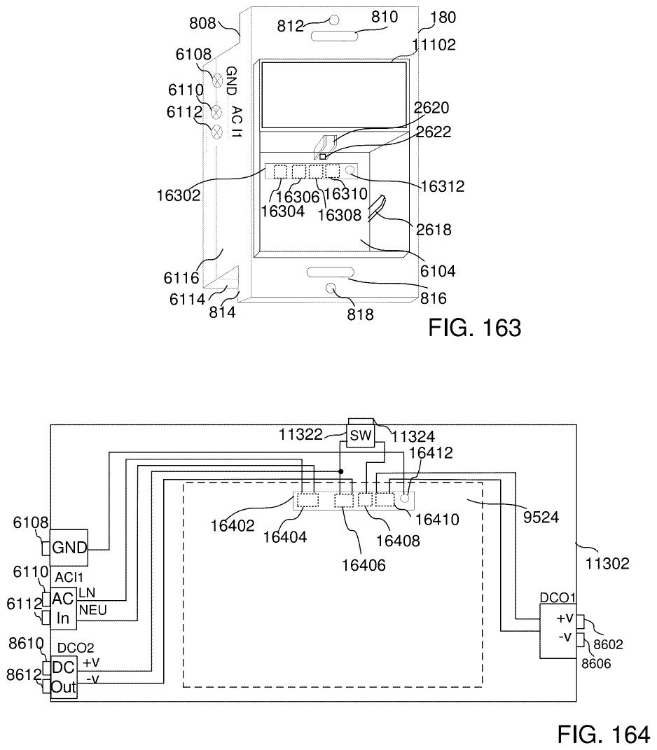

Turning now to FIG. 163, a perspective view of a base portion of an electrical wiring device adapted to receive an AC signal and having a switch and wireless signal transmission circuits is shown. The base portion of FIG. 163 may comprise an electrical interface 16302 having a plurality of induction circuits, including for example an induction circuit 16304, an induction circuit 16306, and an induction circuit 16308. induction circuit 16310. A ground contact element 16312 may also be provided.

Turning now to FIG. 164, a block diagram of a circuit for implementing a base portion 16402 of an electrical wiring device adapted to receive an AC signal and having a switch and wireless signal transmission circuits is shown. The base portion 16402 may comprise a plurality of induction circuits including for example an induction circuit 16404, an induction circuit 16406, an induction circuit 16408, and an induction circuit 16410. The base portion may also include a contact element 16412 as shown.

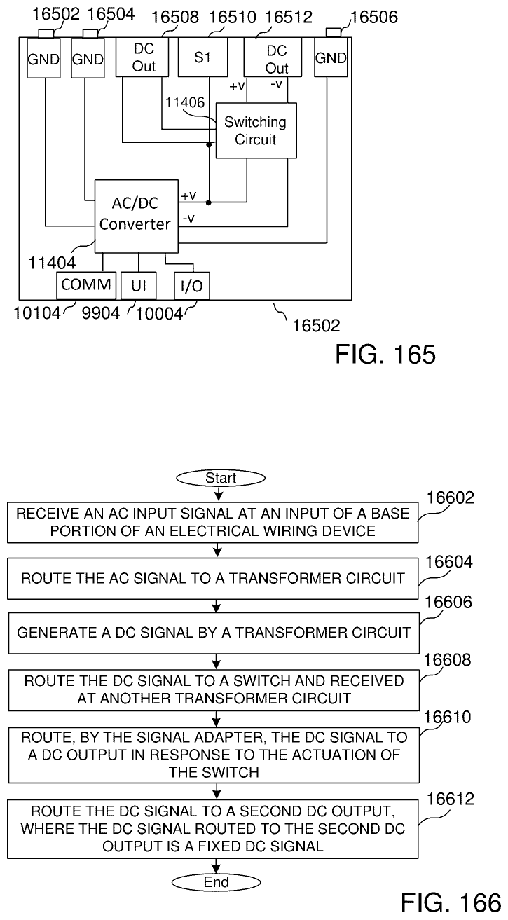

Turning now to FIG. 165, a block diagram of a signal adapter 16502 adapted to receive an AC signal and having wireless signal transmission circuits and adapted to be coupled to the base portion of FIG. 163 is shown. The signal adapter 16502 may comprise a plurality of contacts for receiving or transmitting the signals as shown, including for example a contact element 16504, a contact element 16506, a contact element 16508, a contact element 16510, and a contact element 16512.

Turning now to FIG. 166, a flow chart shows a method of implementing a base portion of an electrical wiring device adapted to receive an AC signal and having a switch and wireless signal transmission circuits. An AC input signal is received at an input of a base portion of an electrical wiring device at a block 16602. The AC signal is routed to a transformer circuit at a block 16604. A DC signal is generated by a transformer circuit at a block 16606. The DC signal is routed to a switch and received at another transformer circuit at a block 16608. The signal adapter routes the DC signal to a DC output in response to the actuation of the switch at a block 16610. The DC signal is routed to a second DC output at a block 16612, where the DC signal routed to the second DC output is a fixed DC signal. The method set forth in FIG. 166 may be implemented using the circuits and devices of at least FIGS. 163-166 for example as described above or using other suitable circuits and devices.

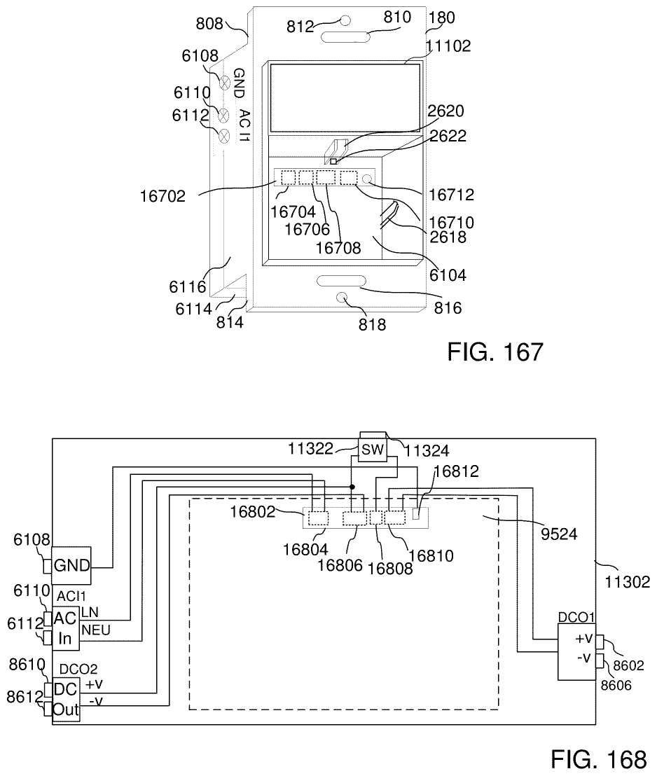

Turning now to FIG. 167, a perspective view of a base portion of an electrical wiring device having an AC/DC transformer and wireless signal transmission circuits is shown. The base portion comprises an electrical interface 16702 comprising a plurality of induction circuits, including for example an induction circuit 16704, an induction circuit 16706, an induction circuit 16708, and an induction circuit 16710. A contact element 16712 may be included for routing a ground signal to the signal adapter.

Turning now to FIG. 168, a block diagram of a circuit of a base portion of an electrical wiring device having a transformer adapted to receive an AC signal and wireless signal transmission circuits is shown. An electrical interface 16802 may comprise a plurality of induction circuits, including for example an induction circuit 16804, an induction circuit 16806, an induction circuit 16808, and induction circuit 16810, and an induction circuit 16812 as shown.

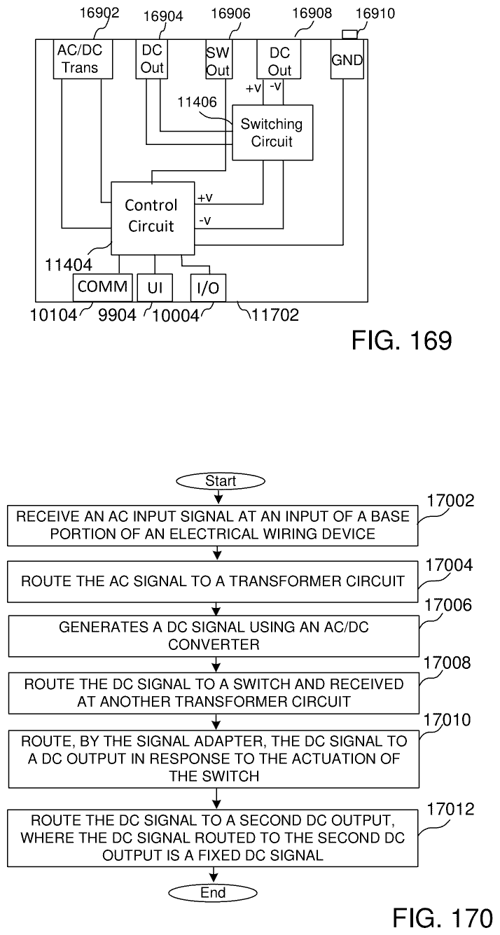

Turning now to FIG. 169, a block diagram of a signal adapter and wireless signal transmission circuits adapted to be coupled to the base portion of Fig. is shown. The signal adapter comprises an AC/DC transformer circuit 16902 associated with an induction circuit, and additional induction circuits for transmitting and receiving signals, including for example an induction circuit 16904, an induction circuit 16906, and an induction circuit 16908. A ground contact 16910 may also be provided.

Turning now to FIG. 170, a flow chart shows a method of a base portion of an electrical wiring device having a transformer adapted to receive an AC signal and wireless signal transmission circuits. An AC input signal is received at an input of a base portion of an electrical wiring device at a block 17002. The AC signal is routed to a transformer circuit at a block 17004. An AC/DC converter generates a DC signal at a block 17006. The DC signal is routed to a switch and received at another transformer circuit at a block 17008. The signal adapter routes the DC signal to a DC output in response to the actuation of the switch at a block 17010. The DC signal is routed to a second DC output at a block 17012, where the DC signal routed to the second DC output is a fixed DC signal. The method set forth in FIG. 170 may be implemented using the circuits and devices of at least FIGS. 167-169 for example as described above or using other suitable circuits and devices.

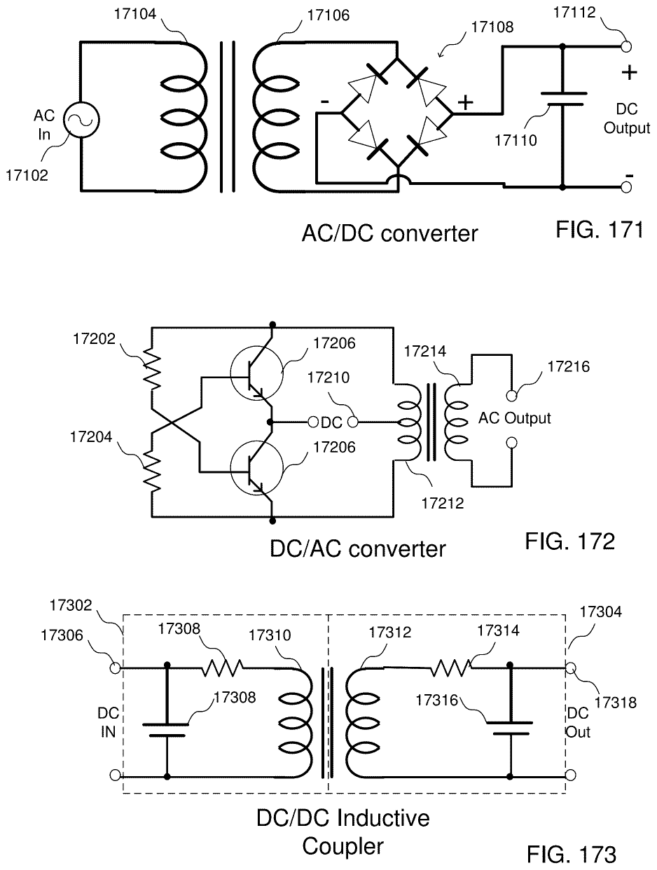

Turning now to FIG. 171, a block diagram of a circuit for converting an AC signal to a DC signal is shown. AC current source 17102. Inductor coil 17104. Inductor coil 17106. Bridge circuit 17108. capacitor 17110. DC output 17112.

Turning now to FIG. 172, a block diagram of a circuit for converting a DC signal to an AC signal is shown. The circuit of FIG. 172 comprises a resistor 17202, a resistor 17204, a transistor 17206, a transistor 17208, a DC signal 17210, an inductor coil 17212, an inductor coil 17214 coupled as shown, where an AC signal is generated at an AC output 17216.

Turning now to FIG. 173, a block diagram of a circuit for providing inductive coupling from a DC signal from a first device to a second device is shown. The circuit for inductive coupling comprises a first transformer circuit 17302, a second transformer circuit 17304, a DC input 17306, a capacitor 17308, a inductive coil 17310, a inductive coil 17312, a resistor 17314, and a capacitor 17316 configured as shown, where a DC output signal is generated at a DC output 17318.

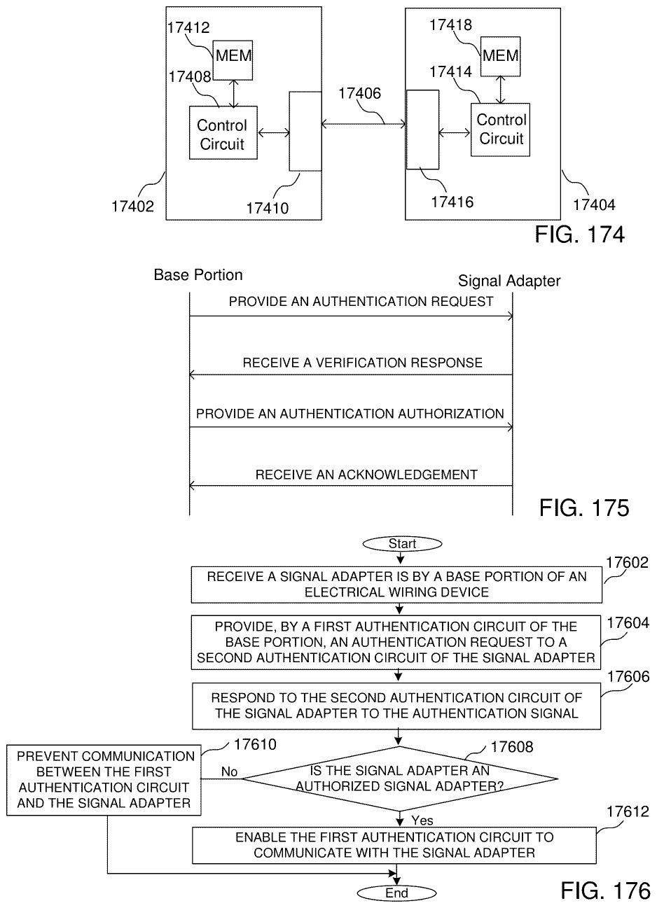

Turning now to FIG. 174, a block diagram of circuits for authenticating the transmission of signals between a first device and a second device is shown. The circuit comprises an authentication circuit 17402 and an authentication circuit 17404 that are coupled by a communication link 17406. The authentication circuit comprises a control circuit 17408, a signal interface 17410, and a memory 17412, while the authentication circuit 17404 comprises a control circuit 17414, a signal interface 17416, and a memory 17418 as shown. The authentication circuits may implement an authentication protocol to allow a base portion to communicate with a signal adapter. An example of signal transmission associated with an authentication protocol is described in reference to FIG. 175.

Turning now to FIG. 175, a signaling diagram showing the transmission of signals between devices is shown. For example, the base portion and the signal adapter may exchange a number of signals, including for example a “PROVIDE AN AUTHENTICATION REQUEST” signal, a “RECEIVE A VERIFICATION RESPONSE” signal, a “PROVIDE AN AUTHENTICATION AUTHORIZATION” signal, and a “RECEIVE AN ACKNOWLEDGEMENT” signal.

Turning now to FIG. 176, a flow chart shows the authentication of signals transferred between a base portion and a signal adapter of an electrical wiring device. A signal adapter is received by a base portion of an electrical wiring device at a block 17602. A first authentication circuit of the base portion provides an authentication signal to a second authentication circuit of the signal adapter at a block 17604. The second authentication circuit of the signal adapter responds to the authentication signal at a block 17606. It is determined if the signal adapted is an authorized signal adapter at a block 17608. If not, the first authentication circuit prevents communication with the signal adapter at a block 17610. If so, the first authentication circuit enables communication with the signal adapter at a block 17612. The method set forth in FIG. 176 may be implemented using the circuits and devices of at least FIG. 174 as described for example as described above or using other suitable circuits and devices.

Turning now to FIG. 177, a front perspective view of an electrical wiring device is shown. The electrical wiring device of FIG. 177 may comprise a plurality of electrical connectors, including for example an electrical connector 17702, an electrical connector 17704, an electrical connector 17706, an electrical connector 17708 and a corresponding connector actuator 17710. electrical connector 17712 and a corresponding connector actuator 17714, an electrical connector 17716 and a corresponding connector actuator 17718.

Turning now to FIG. 178, a rear perspective view of the electrical wiring device of FIG. 177 and having control actuators for controlling the application of a DC output signal to lighting elements is shown. The electrical wiring device comprises an output power selection interface 17802 having an actuator element 17804 and a lighting load setting interface 17806 having an actuator element 17808. The lighting load setting interface enables the selection of a correlated color temperature (CCT) value which controls the application of DC power signals to LEDs of a lighting element to enable the tuning of the light that is emitted by the lighting element. CCT describes the color tone of white light, measured in Kelvin (K). Lower values (2700K-3000K) create generally warm light, Neutral white (3500K-4500K) are often used in offices and kitchens, while higher values (5000K-6500K) produce more daylight-like tones. Lighting elements comprising different LED circuits and actuator for adjusting a CCT setting allows dynamic adjustment across a range, including fixed preset options (e.g., 2700K, 3000K, 3500K, 4000K, and 5000K as shown). Mixed LED elements may be used to deliver flexible lighting. As will be described in more detail below, when you select a color temperature using a switch, dip switch, remote control, or smart app, the controller adjusts the output levels of each chip group. For example, if you choose 3000K, only the warm white chips will activate. If you select 4000K, the system might blend both warm and cool chips to create a neutral tone.

While both are shown, it should be understood that either the output power selection actuator and corresponding circuit or the CCT setting actuator and corresponding circuit may be implemented alone. It should also be understood that the CCT setting actuator may effectively be used to control output power. Lighting elements that are responsive to setting of a CCT setting actuator generally comprise more than one group of LED lighting elements (i.e., a lighting element having two or more groups of LED elements, where one group of LED elements may receive one controllable DC power voltage (e.g., +va) and another group of LED elements may receive another controllable DC power voltage (e.g., +vb), where the LEDs of the different groups may have different light output specifications). While some LED lighting elements only comprise a single group of LED lighting elements that receive power from one voltage (i.e., a +v signal), it should be understood that the adjustment of the CCT setting that controls two output power signals (i.e., +va and +vb) could be to control whatever power is provided to LED lighting element (i.e., the +v power signal line). According to some implementations, the CCT Setting interface may comprise a “bulb” setting, where full power would be provided to the lighting element (i.e., the bulb). That is, when a user selects a bulb, the user selects the wattage of the bulb. It should also be understood that a dimming function may be used when a CCT setting interface is provided. That is, even when a user selects a certain CCT setting level, the user may still adjust the output power of the light using a dimming circuit, such as in a dimming circuit of a signal adapter, as will described in more detail below. According to some implementations, the output power selection interface 17802 having an actuator element 17804 and a lighting load setting interface 17806 having an actuator element 17808 may be implemented on the lighting element itself, such as on a light bulb or a housing of a LED puck light.

Turning now to FIG. 179, a block diagram of an electrical wiring device, such as the electrical wiring device of FIG. 177 is shown. The electrical wiring device 17901 may comprise a plurality of electrical connectors including for example an electrical connector 17902, an electrical connector 17904, an electrical connector 17906, and an electrical connector 17906. The electrical wiring device 17901 may also comprise a control circuit 17907 and a switching circuit 17908 adapted to control the application of DC power signals to a load, such as a lighting element. The electrical wiring device 17901 may also comprise a communication circuit 17910 coupled to the control circuit to provide power control signals and other information to the control circuit. A power control circuit 17912, which is responsive to the actuator element 17804, enables controlling the voltages and/or currents provided to a lighting element by way of the DC output contact of the DC power output interface DC 01. A lighting load driver circuit 17914, which is responsive to the actuator element 17808, is adapted to separately control the output voltage +va and +vb at the electrical connectors 17918 and 17920 to provide the desired lighting output as described above. DC output port 17916 as shown comprises an electrical connector 17918, an electrical connector 17920, and a electrical connector 17922. It should be understood that the lighting load driver circuit 17914 could be implemented without the power control circuit 17912 as set forth above.

Turning now to FIG. 180, a flow chart shows a method of implementing an electrical wiring device, such as the electrical wiring device of FIG. 177. An ac input single is received an ac input of an electrical wiring device at a block 18002. The AC signal is converted to a DC signal comprising +va, +vb and −v signals at a block 18004. The DC signals is controlled to generate a selected output power for the electrical wiring device at a block 18006. The +va and +vb signals are controlled to implement a selected light setting at a block 18008. It is determined whether a selected output power or selected light setting changed at a block 18010. If the selected output power level is changed, a power control circuit will change an output power of the DC power signals provided to a lighting element. If the selected light setting is changed, a CCT circuit will change one or both of the output power signals +va and vb provided to a lighting element.

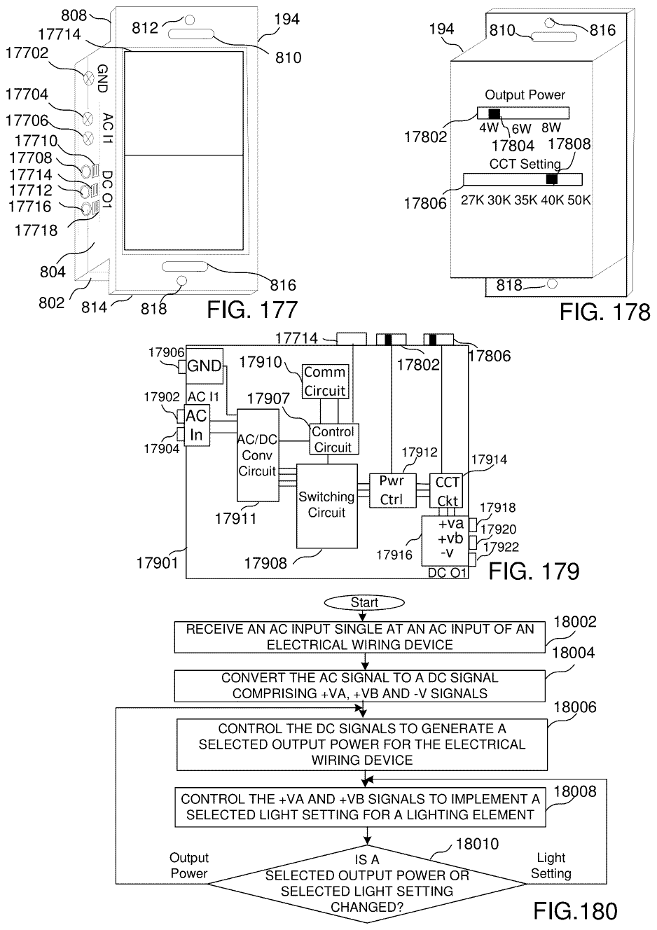

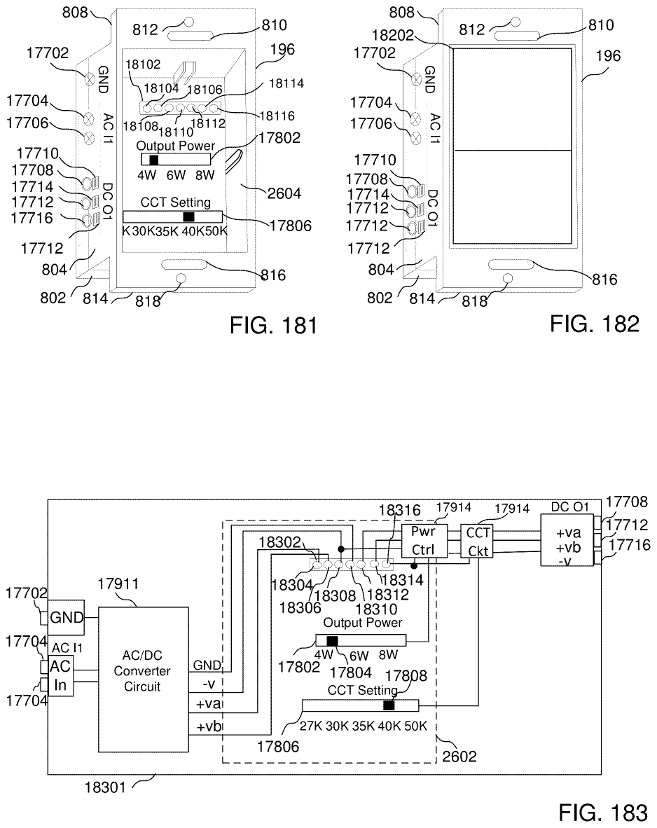

While an output power setting and a CCT setting may be controlled on a rear surface of an electrical wiring device as shown for example in FIG. 178 for example, an output power setting and a CCT setting may also be controlled on a surface of an electrical wiring device, such as on a surface of a base portion as shown for example in FIG. 181 or on a surface of a signal adapter as shown for example in FIG. 194. Turning first to FIG. 181, a perspective view of a base portion of an electrical wiring device adapted to receive a signal adapter and having control actuators for controlling the application of a DC output signal to lighting elements is shown. According to some implementations, the base portion may comprise the output power selection interface 17802 having the actuator element 17804 and the lighting load setting interface 17806 having the actuator element 17808. The base portion of FIG. 181 may comprise a plurality of openings 18102 for receiving contact elements of a signal adapter, including for example an opening 18104, an opening 18106, an opening 18108, an opening 18110, an opening 18112, an opening 18114, and an opening 18116. The perspective view of the base portion of an electrical wiring device of FIG. 181 shown in FIG. 182 shows the signal adapter comprising a switch actuator 18202.

Turning now to FIG. 183, a block diagram of a base portion of an electrical wiring device, such as the base portion of FIG. 181 is shown. The base portion 18301 comprises the AC/DC converter circuit 17911, the power control circuit 17912 and corresponding output power selection interface 17802, and lighting load driver circuit 17914 and the corresponding lighting load setting interface 17806. The base portion comprises an electrical interface 18302 comprising a contact element 18304, a contact element 18306, a contact element 18308, a contact element 18310, a contact element 18312, a contact element 18314, and a contact element 18316. The contact elements are adapted to receive signals from the AC/DC converter circuit 17911 and output signals to the power control circuit and lighting load driver circuit as shown. It should be understood that the base portion 18301 could be implemented without the output power control circuit or without the lighting load setting circuit.

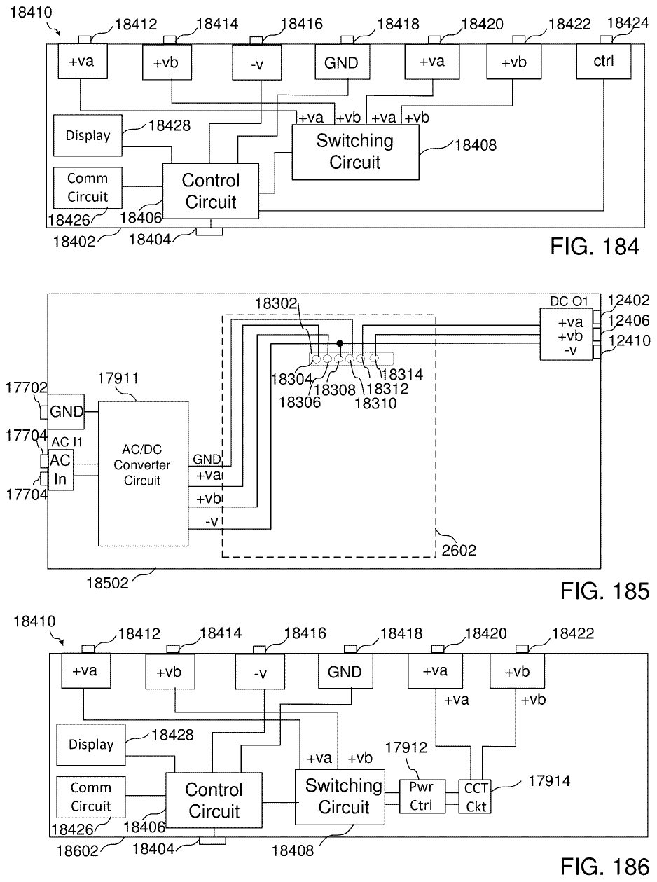

Turning now to FIG. 184, a block diagram of a signal adapter, such as a signal adapter adapted to be coupled to the base portion of FIG. 181 is shown. The signal adapter 18402 comprises a switch actuator element 18404 coupled to a control circuit 18406 switching circuit 18408. The signal adapter 18402 also comprises a plurality of contact elements 18410, which may comprise a contact element 18412, a contact element 18414, a contact element 18416, a contact element 18418, a contact element 18420, a contact element 18422, and a contact element 18424 as shown. The switching circuit 18408 may also be coupled to a communication circuit 18426 and a display 18428.

FIGS. 185 and 186 are directed to a base portion and a corresponding signal adapter that enable the control of a power output and or the lighting load setting on the signal adapter. The block diagram of a base portion 18502 of an electrical wiring device is similar to the base portion of FIG. 183, except that the power control circuit 17912 and the lighting load driver circuit 17914 are in the signal adapter 18602, as shown in FIG. 186.

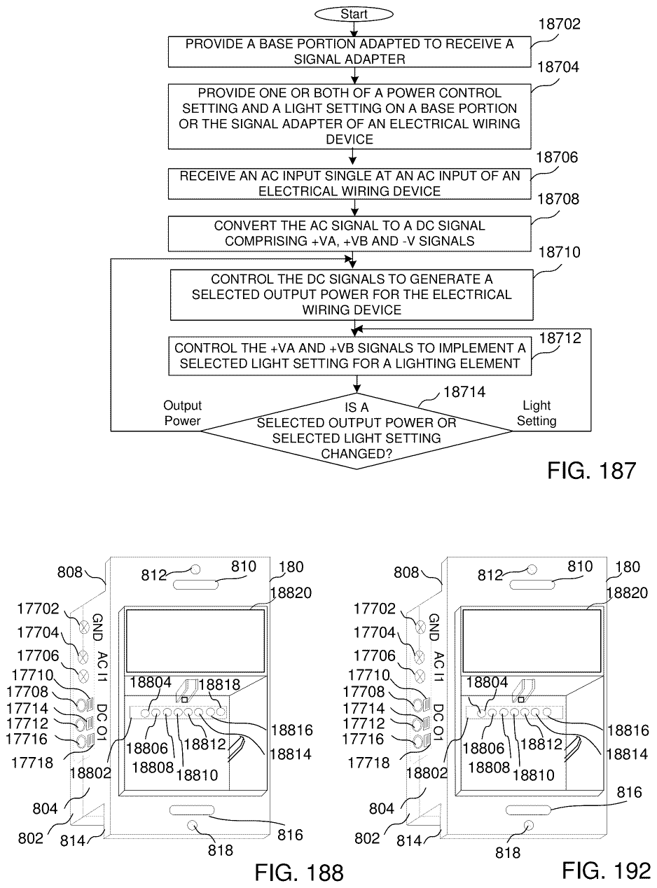

Turning now to FIG. 187, a flow chart shows a method of implementing an electrical wiring device, such as an electrical wiring having the circuits and elements of FIGS. 181-186. A base portion adapted to receive a signal adapter is provided at a block 18702. One or both of a power control setting and a light setting are provided on a base portion or the signal adapter of an electrical wiring device at a block 18704. An ac input single is received an ac input of an electrical wiring device at a block 18706. The ac signal is converted to a dc signal comprising +va, +vb and −v signals at a block 18708. The de signals is controlled to generate a selected output power for the electrical wiring device at a block 18710. The +va and +vb signals are controlled to implement a selected light setting at a block 18712. It is determined whether a selected output power or selected light setting changed at a block 18714. If the selected output power level is changed, a power control circuit will change an output power of the DC power signals provided to a lighting element. If the selected light setting is changed, a CCT circuit will change one or both of the output power signals +va and +vb provided to a lighting element.

FIGS. 188-195 are directed to embodiments of modular base portion and signal adapter implemented in a partial partition arrangement is shown, where the power control circuit 17912 and the lighting load driver circuit 17914 are implemented in the power adapter in some implementations and the power control circuit 17912 and the lighting load driver circuit 17914 are implemented in the signal adapter in other arrangements. Turning first to FIG. 188, a perspective view of a base portion of an electrical wiring device is shown. The base portion of FIG. 188 comprises an electrical interface 18802 comprising a plurality of openings, including an opening 18804, an opening 18806, an opening 18808, an opening 18810, an opening 18812, an opening 18814, an opening 18816, and an opening 18818 for receiving corresponding contact elements of the signal adapter. The base portion may also comprise a switch actuator element 18820 adapted to control the application of DC power to a load as described above.

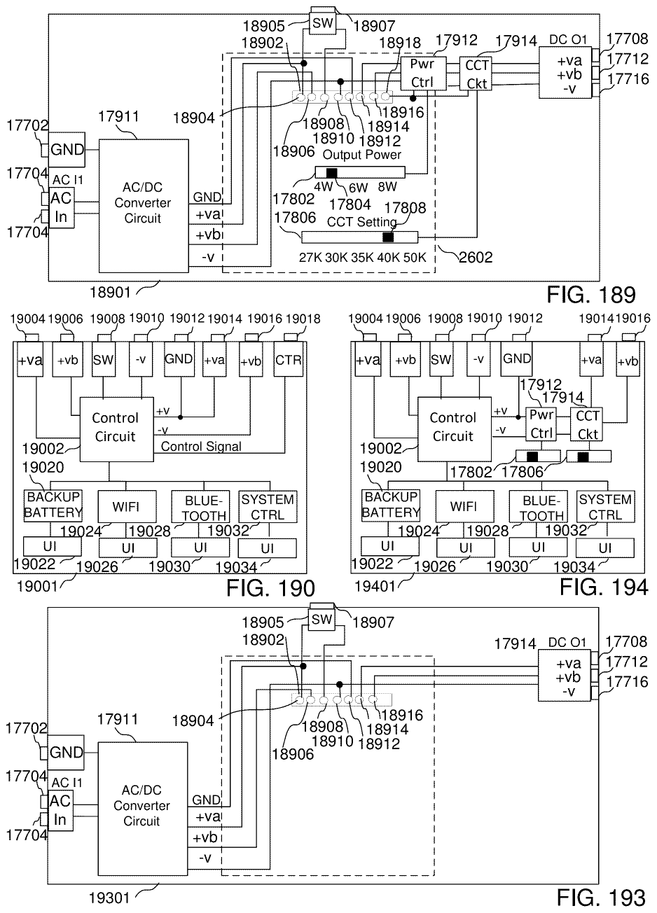

Turning now to Fig. FIG. 189, a block diagram of a base portion of an electrical wiring device, such as the base portion of FIG. 188 is shown. The base portion 18901 comprises an electrical interface 18902 having a plurality of contact element 18904 including for example a contact element 18906, a contact element 18908, a contact element 18910, a contact element 18912, a contact element 18914, a contact element 18916, and a contact element 18918. The base portion also comprises a switch 18905 having a switch actuator 18907 configured to transmit a signal indicating a toggling of the switch. According to some implementations, the toggling could be a passing of a DC reference signal, such as +v signal for example. That is, the switch 18905 is coupled to receive the +va signal and route pass or route the +va signal to the contact element 18908.

Turning now to Fig. FIG. 190, a block diagram of a signal adapter adapted to be attached to a base portion of an electrical wiring device, such as the base portion of FIG. 188 is shown. The signal adapter 19001 comprises a control circuit 19002 coupled to a plurality of contact elements, include for example a contact element 19004, a contact element 19006, a contact element 19008, a contact element 19010, a contact element 19012, a contact element 19014, a contact element 19016, and a contact element 19018. The control circuit is adapted to receive a switching signal by way of the contact element 19008 and control the application of power to a load, such as a lighting element. The signal adapter may also comprise a backup battery circuit 19020 and corresponding user interface 19022, a WIFI circuit 19024 and corresponding user interface 19026, a Bluetooth circuit 19028 and corresponding user interface 19030, and a system control circuit 19032 and corresponding user interface 19034 as shown.

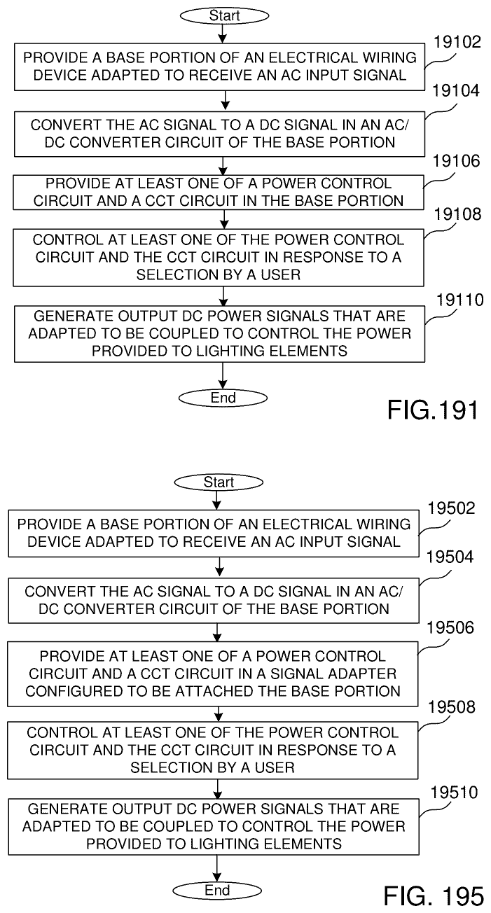

Turning now to FIG. 191, a flow chart shows a method of implementing an electrical wiring device, such as an electrical wiring having the circuits and elements of FIGS. 181-186. A base portion of an electrical wiring device adapted to receive an AC input signal is provided at a block 19102. The AC signal is converted to a DC signal in an AC/DC converter circuit of the base portion at a block 19104. At least one of a power control circuit and a CCT circuit is provided in the base portion at a block 19106. At least one of the power control circuit and the CCT circuit are controlled in response to a selection by a user at a block 19108. Output DC power signals that are adapted to be coupled to control the power provided to lighting elements are generated at a block 19110.

Turning now to FIG. 192, a perspective view of a base portion of an electrical wiring device adapted to receive a signal adapter having one or both of the power control circuit 17912 and the lighting load driver circuit 17914. That is, unlike the base portion of FIG. 189 which comprises the power control circuit 17912 and the lighting load driver circuit 17914, the base portion 19301 does not comprise the power control circuit 17912 and the lighting load driver circuit 17914, but rather the power control circuit 17912 and the lighting load driver circuit 17914 are implemented in the signal adapter of FIG. 194 as shown.

Turning now to FIG. 195, a flow chart shows a method of implementing circuits and components of an electrical wiring device, such as the circuits and components of FIGS. 192-194. A base portion of an electrical wiring device adapted to receive an AC input signal is provided at a block 19502. The AC signal is converted to a DC signal in an AC/DC converter circuit of the base portion at a block 19504. At least one of a power control circuit and a CCT circuit is provided in a signal adapter configured to be attached to the base portion at a block 19506. At least one of the power control circuit and the CCT circuit are controlled in response to a selection by a user at a block 19508. Output DC power signals that are adapted to be coupled to control the power provided to lighting elements are generated at a block 19510.

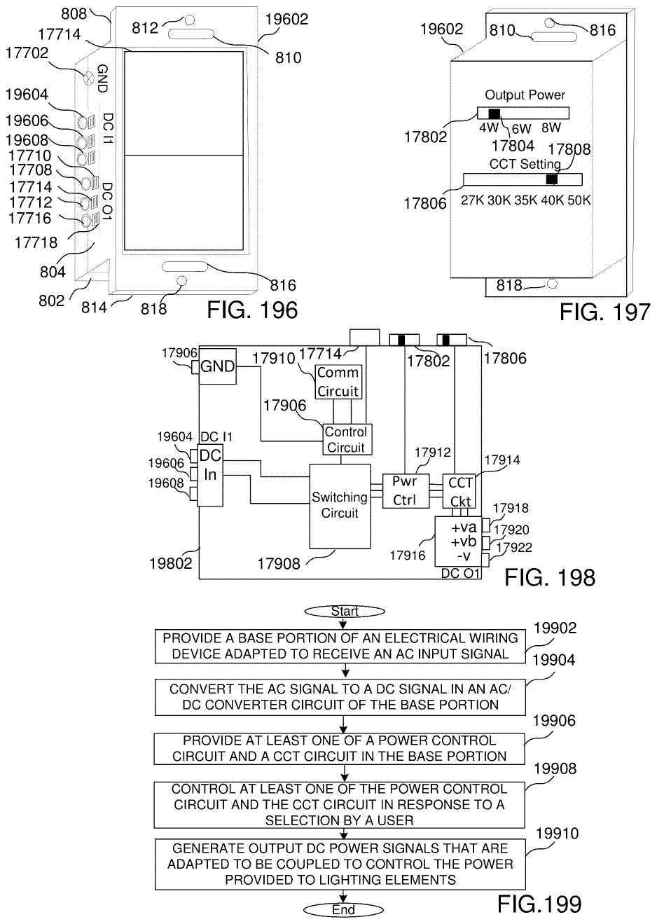

Turning now to FIG. 196, a perspective view of an electrical wiring device is shown. electrical wiring device 19602. The electrical wiring device of FIG. 196 comprises electrical connectors including an electrical connector 19604, an electrical connector 19606, and an electrical connector 19608 as shown. A perspective view of the back of the electrical wiring device of FIG. 196 is shown in FIG. 197, where the control actuators for controlling the application of a DC output signal to lighting elements is shown. A block diagram of an electrical wiring device 19802, such as the electrical wiring device of FIG. 196, is shown in FIG. 198.

Turning now to FIG. 199, a flow chart shows a method of implementing an electrical wiring device, such as the circuits and devices of FIGS. 196-198. An electrical wiring device adapted to receive an AC input signal is provided at a block 19902. The AC signal is converted to a DC signal in an AC/DC converter circuit of the base portion at a block 19904. At least one of a power control circuit and a CCT circuit is provided on the electrical wiring device at a block 19906. At least one of the power control circuit and the CCT circuit are controlled in response to a selection by a user at a block 19908. Output DC power signals that are adapted to be coupled to control the power provided to lighting elements are generated at a block 19910.

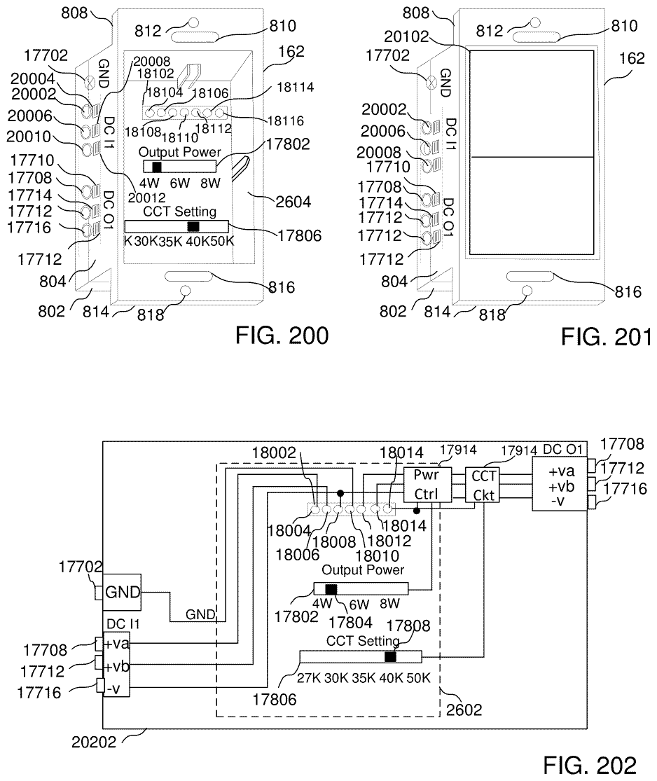

FIGS. 200 to 205 are directed to an embodiment where the signal adapter would occupy the entire opening of a wall plate for example. Turning first to FIG. 200, a perspective view of a base portion of an electrical wiring device adapted to receive a DC input signal and having control actuators for controlling the application of a DC output signal to lighting elements is shown. The base portion comprises DC electrical connectors and corresponding actuator elements, including for example an electrical connector 20002 and a corresponding actuator element 20004, and electrical connector 20006 and a corresponding actuator element 20008, and an electrical connector 20010 and a corresponding actuator element 20012.

Turning now to FIG. 201, a perspective view of an electrical wiring device having a signal adapter comprising a switch actuator and couped to a base portion, such as the base portion of FIG. 200 is shown, and comprises a switch actuator element 20102.

Turning now to FIG. 202, a block diagram of a base portion 20202 adapted to receive a DC input signal, such as the base portion of FIG. 200 is shown.

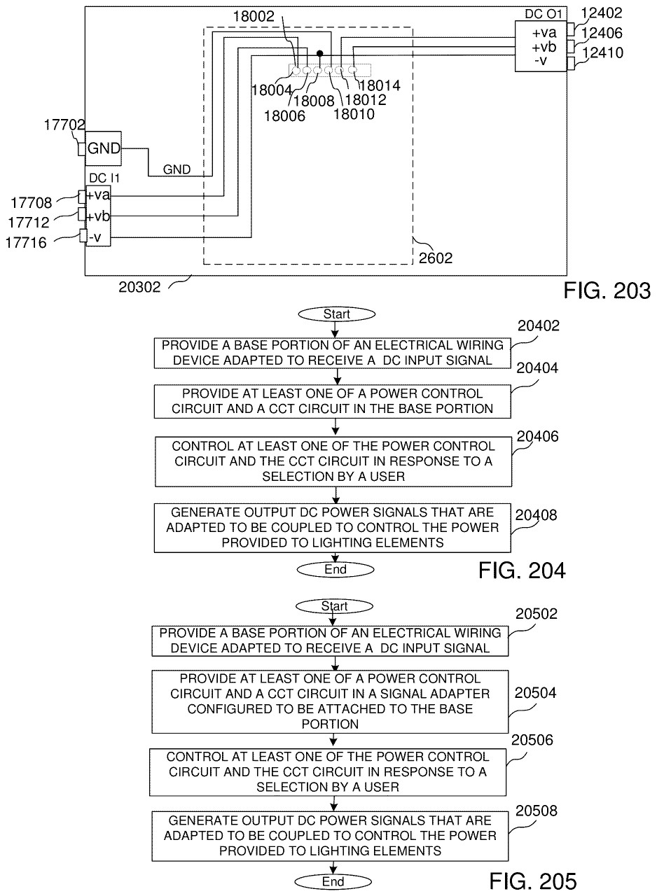

Turning now to FIG. 203, another block diagram of a base portion 20302 adapted to receive a DC input signal, such as the base portion of FIG. 200, where a signal adapter may receive a signal adapter having control actuators for controlling the application of a DC output signal to lighting elements, such as the signal adapter of FIG. 194 for example is shown.

Turning now to FIG. 204, a flow chart shows a method of implementing an electrical wiring device, such as the circuits and devices of FIG. 2001-202. A base portion of an electrical wiring device adapted to receive a DC input signal is provided at a block 20402. At least one of a power control circuit and a CCT circuit is provided in the base portion at a block 20404. At least one of the power control circuit and the CCT circuit are controlled in response to a selection by a user at a block 20406. Output DC power signals that are adapted to be coupled to control the power provided to lighting elements are generated at a block 20408.

Turning now to FIG. 205, a flow chart shows a method of implementing an electrical wiring device, such as the circuits and devices associated with the base portion of FIG. 203. A base portion of an electrical wiring device adapted to receive a DC input signal is provided at a block 20502. At least one of a power control circuit and a CCT circuit is provided in a signal adapter configured to be attached to the base portion at a block 20504. At least one of the power control circuit and the CCT circuit are controlled in response to a selection by a user at a block 20506. Output DC power signals that are adapted to be coupled to control the power provided to lighting elements are generated at a block 20508.

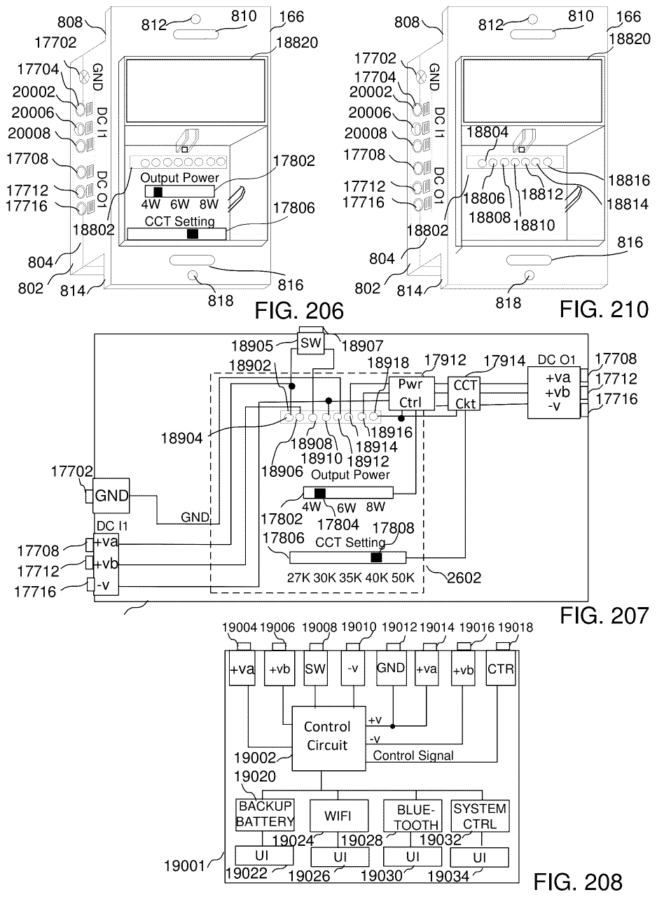

FIGS. 206-213 comprise base portions of an electrical wiring device having a partial partition (i.e., the signal adapter only occupies a portion of the area available as defined by an opening in a wall plate), where some implementations include signal control actuators in the base and others include signal actuators associated with the signal adapter. Turning first to FIG. 206, a perspective view of a base portion adapted to receive DC input signals comprising +va, +vb and −v inputs signals and having control actuators for controlling the application of a DC output signal to lighting elements is shown.

Turning now to FIG. 207, a block diagram of a base portion adapted to receive DC input signals comprising +va, +vb and −v inputs signals and having control actuators for controlling the application of a DC output signal to lighting elements, such as the base portion of FIG. 206 is shown.

Turning now to FIG. 208, a block diagram of a signal adapter adapted to be received by a base portion, such as the base portion of FIGS. 206 and 207 is shown.

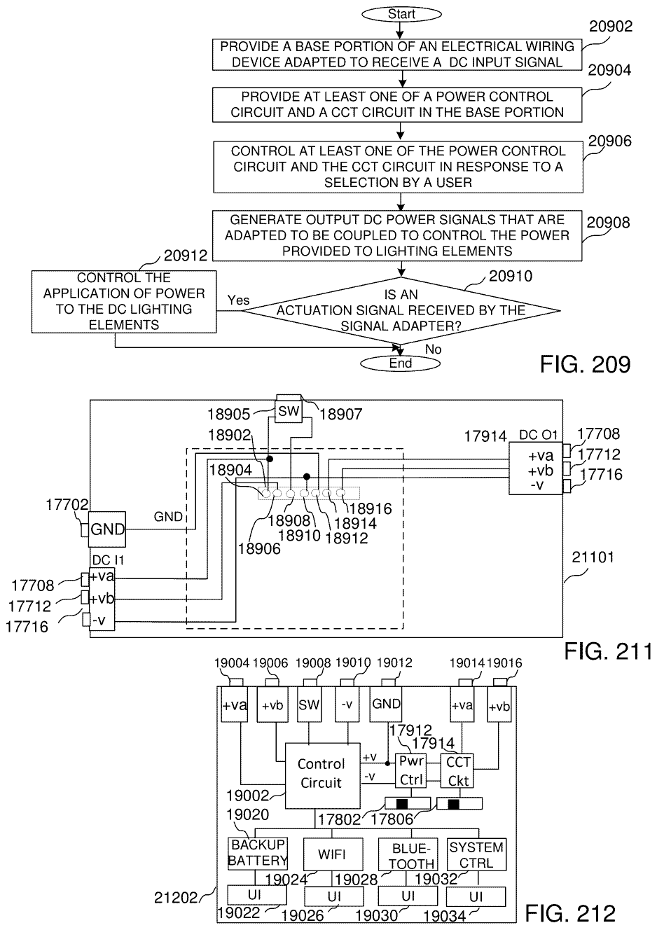

Turning now to FIG. 209, a flow chart shows a method of implementing an electrical wiring device, such as the circuits and elements of the electrical wiring device described in FIGS. 206-208. A base portion of an electrical wiring device adapted to receive a DC input signal is provided at a block 20902. At least one of a power control circuit and a CCT circuit is provided in the base portion at a block 20904. At least one of the power control circuit and the CCT circuit are controlled in response to a selection by a user at a block 20906. Output DC power signals that are adapted to be coupled to control the power provided to lighting elements are generated at a block 20908. It is determined if an actuation signal is received by the signal adapter at a block 20910. If so, the application of power to the DC lighting elements is controlled at a block 20912.

Turning now to FIG. 210, another perspective view of a base portion adapted to receive DC input signals comprising +va, +vb and −v inputs signals and having control actuators for controlling the application of a DC output signal to lighting elements is shown.

Turning now to FIG. 211, a block diagram of a base portion 21101 adapted to receive DC input signals comprising +va, +vb and −v inputs signals is shown.

Turning now to FIG. 212, a block diagram of a signal adapter 21202 adapted to be received by the base portion of FIG. 211 and having control actuators for controlling the application of a DC output signal to lighting elements is shown.

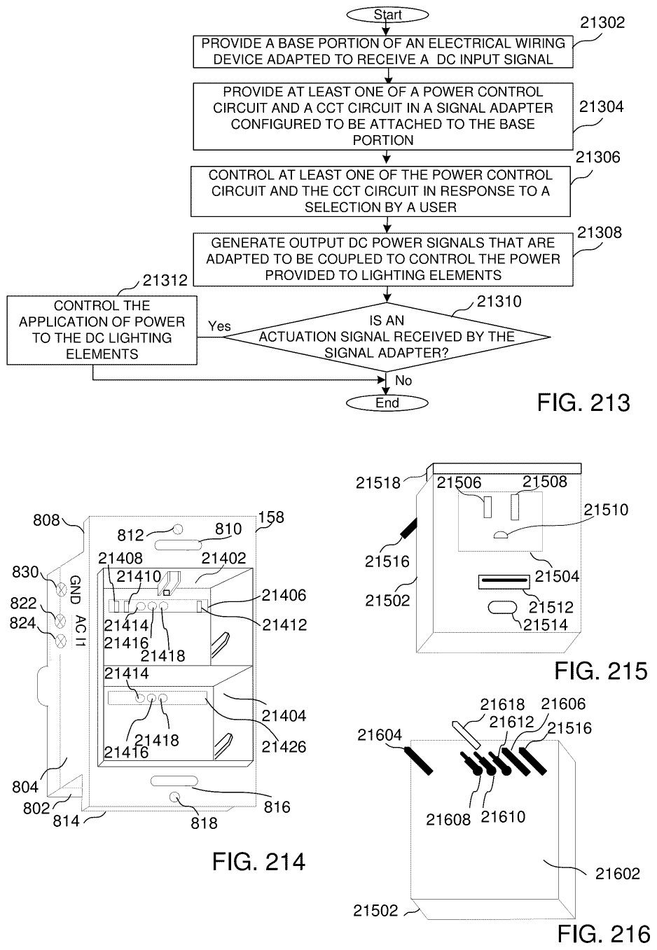

Turning now to FIG. 213, a flow chart shows a method of implementing the circuits and devices of an electrical wiring device, such as the circuits and devices of FIGS. 210-212. A base portion of an electrical wiring device adapted to receive a DC input signal is provided at a block 21302. At least one of a power control circuit and a CCT circuit is provided in a signal adapter configured to be attached to the base portion at a block 21304. At least one of the power control circuit and the CCT circuit are controlled in response to a selection by a user at a block 21306. Output DC power signals that are adapted to be coupled to control the power provided to lighting elements are generated at a block 21308. It is determined if an actuation signal is received by the signal adapter at a block 21310. If so, the application of power to the DC lighting elements is controlled at a block 21312.

Turning now to FIG. 214, a perspective view of a base portion of an electrical wiring device adapted to receive a signal adapter having a receptacle and a second signal adapter having a DC circuit is shown. The electrical wiring device comprises a first portion 21402 adapted to receive a first signal adapter and a second portion 21404 adapted to receive a second signal adapter. The first portion 21402 comprises an electrical interface 21406 having an opening 21408, an opening 21410, an opening 21412, an opening 21413, an opening 21414, an opening 21416, an opening 21418, an opening 21420, and an opening 21422 that expose contact elements and are adapted to receive corresponding contact elements of a signal adapter. Openings 21408, 21410, and 21410 may expose contact elements adapted to receive AC signals, and therefore may be covered with a tamper resistant element. The remaining openings may expose contact elements adapted to receive DC signals. An electrical interface 21426 associated with the second portion 21404 may comprise only an opening 21414, an opening 21416, an opening 21418, and an opening 21420 as shown, and therefore may only be adapted to receive a signal adapted having corresponding contact elements to be received by the openings of the electrical interface 21426. According to other implementations, the electrical interface 21426 may comprise the same openings as the electrical interface 21406 and therefore be able to receive a signal adapter having contact elements.

Turning now to FIG. 215, a front perspective view of a signal adapter having a receptacle and USB electrical connectors is shown. The signal adapter 21502 comprises a receptacle 21504 having an opening 21506 adapted to expose a contact element associated with the line signal, an opening 21508 adapted to expose a contact element associated with a neutral signal, and an opening 21510 adapted to expose a contact element associated with a ground signal. One or more electrical interfaces accessible by a user of the signal adapter may be provided to enable the charging of a device, such as a mobile device, or transmitting data. By way of example, a USB charging interface 21512 comprising a USB-A type interface and a USB charging interface 21514 comprising a USB-C type interface may be provided. A contact element 21516 extending from the rear is shown and will be described in more detail in reference to FIG. 216. An attachment element 21518, which may be used to secure the signal adapter to the base portion of the electrical wiring device, may also be provided.

Turning now to FIG. 216, a block diagram of a rear perspective view of the signal adapter of FIG. 215 is shown. More particularly, a rear surface 21602 of the signal adapter 21502 is shown, where a contact element 21604, a contact element 21606, a contact element 21608, a contact element 21610, a contact element 21612, a contact element 21614, and a contact element 21616 are provided. According to some implementations, the contact element 21604, contact element 21606, and contact element 21516 may be adapted to receive an AC signal such as a line voltage signal, while contact element 21608, contact element 21610, contact element 21612, contact element 21614, and contact element 21616 may be adapted to receive a DC signal, such as a +v signal as described above. The signal adapter 21502 may comprise an actuator 21618 adapted to engage with a tamper resistant element of a base portion, such as the base portion of FIG. 214. It should be understood that a receptacle of a signal adapter may also comprise a tamper resistant element, such as the tamper resistant element described in reference to FIGS. 32-35.

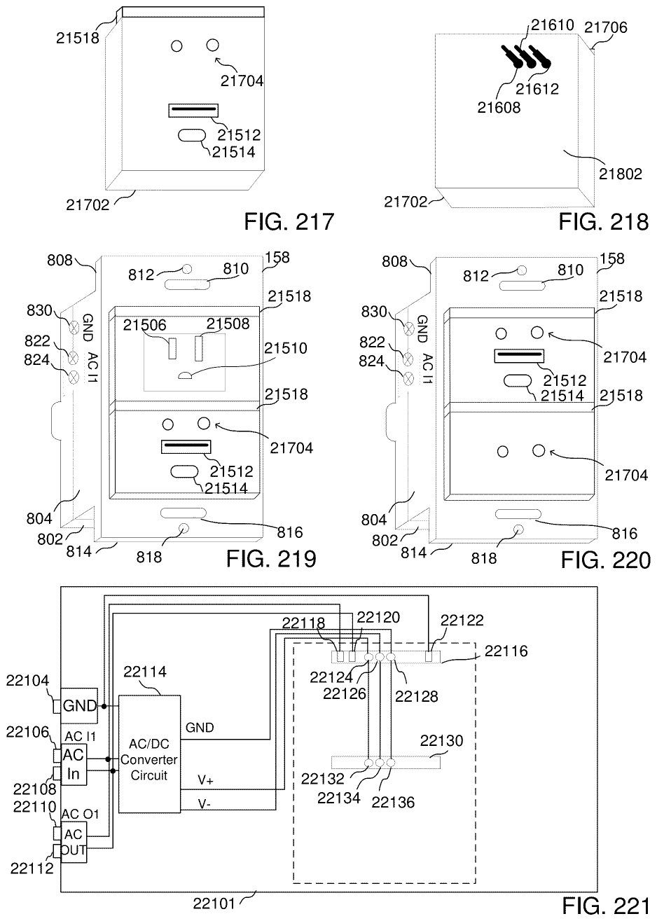

Turning now to FIG. 217, a perspective view of a front of a signal adapter having a DC receptacle interface and USB connectors is shown. The signal adapter 21702 comprises a DC receptacle 21704 adapted to provide a DC signal (e.g., +v) to a device having a corresponding plug to be attached to the DC receptacle 21704. According to some implementations, the DC receptacle 21704 may comprise an arrangement of contact elements that receive corresponding contact elements of a plug of an appliance or a lamp adapted to receive DC power for example. According to some implementations, the two contact elements of the DC receptacle interface may comprise different sizes or shapes of contact elements. Although only two contact elements are shown, for example for +V and −V signals, it should be understood that a ground contact element could be provided on the DC receptacle interface for receiving a corresponding ground contact element of a plug of an appliance or a lamp adapted to receive DC power. As shown in the perspective view of FIG. 218, a perspective view of a rear portion 21802 of a signal adapter of FIG. 217, where the contact elements 21608, 21610, and 21612 extend from the read surface, is shown.

Examples of base portions receiving different signal adapters are shown in FIGS. 219 and 220. Turning first to FIG. 219, a perspective view of an electrical wiring device having an AC/DC converter circuit and an electrical receptacle and the signal adapter of FIG. 217 is attached is shown. That is, an AC receptacle is shown in the top portion of the base portion and a DC receptacle having USB electrical interfaces is shown in the bottom portion of the base portion. As shown in FIG. 220, an electrical wiring device having an AC/DC converter circuit has a signal adapter having a DC electrical receptacle and USB electrical interfaces in the top portion and a signal adapter having a DC electrical receptacle. While the example of FIGS. 219 and 220 are provided to show different arrangements, it should be understood that other arrangements of signal adapters could be employed.

Turning now to FIG. 221, a block diagram of circuit of a base portion having an electrical interface adapted to receive a signal adapter having an AC receptacle and a second electrical interface adapted to receive a signal adapter having DC circuit is shown. A base portion 22101 comprises an electrical connector 22104 adapted to receive a ground signal, an electrical connector 22106 and an electrical connector 22108 adapter to receive an AC input signal (e.g., line voltage and neutral signals), and an electrical connector 22110 and an electrical connector 22112 adapted to provide an AC output signal. An AC/DC converter circuit 22114 is adapted to receive the AC input signal and generate a DC output signa; (+v and −v). The base portion also comprises an electrical interface 22116 associated with a top portion, which comprises a contact element 22118, a contact element 22120, and a contact element 22122, is provided. The electrical interface 22116 also comprises a contact element 22124, a contact element 22126, a contact element 22128 adapted to receive DC input signals and a ground signal as shown. The DC contact elements of the electrical interface 22116 are coupled to corresponding DC contact element of an electrical interface 22130, and more particularly a contact element 22132, a contact element 22134, a contact element 22136 as shown.

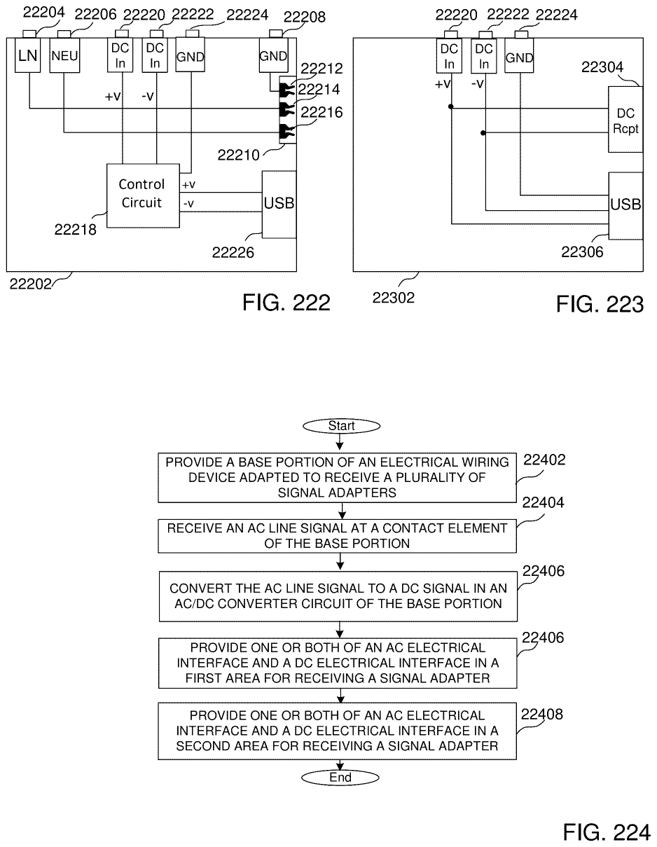

Turning now to FIG. 222, a block diagram of a signal adapter having a receptacle and a USB electrical interface is shown. More particularly, the signal adapter comprises a plurality of contact elements adapted to be electrically connected to corresponding contact elements of a base portion, such as the base portion of FIG. 221. The signal adapter includes a contact element 2220 adapted to receive a line voltage signal, a contact element 22204, a contact element 22206 adapted to receive a neutral signal, and a contact element 22208 adapted to receive a ground signal, which may be an AC ground signal. The signal adapter as shown comprises an electrical interface 22210 adapted to receive prongs of a plug and comprising a contact element 22212 adapted to receive the AC ground signal from the corresponding contact element of the base portion, a contact element 22214 adapted to receive a line voltage signal and contact element 22216 adapted to receive the neutral signal.

The signal adapter of FIG. 222 also comprises a control circuit 22218 coupled to a contact element 22220 adapted to receive a first DC input signal (+v) signal, a contact element 22222 adapted to receive a second DC input signal (−v), and a contact element 22224 adapted to receive a ground signal, which may be a DC ground signal. The control circuit 22218 may be coupled to a USB electrical interface 22226, which may be a charging circuit or used for data transfer for example according to any of the USB standards.

Rather than having an AC receptacle, the signal adapter of FIG. 223 has DC circuits but no AC circuits as shown. That is, the signal adapter 22302 comprises a DC receptacle 22304 and a USB electrical interface 22306 as shown, and may be implemented as shown for example in FIGS. 219 and 220.

Turning now to FIG. 224, a flow chart shows a method of implementing a base portion of an electrical wiring device adapted to receive multiple signal adapters. A base portion of an electrical wiring device adapted to receive a plurality of signal adapters is provided at a block 22402. An AC line signal is received at a contact element of the base portion at a block 22402. The AC line signal is converted to a DC signal in an AC/DC converter circuit of the electrical wiring device at a block 22402. One or both of an AC electrical interface and a DC electrical interface is provided in a first area for receiving a signal adapter at a block 22402. One or both of an AC electrical interface and a DC electrical interface is provided in a second area for receiving a signal adapter at a block 22402. The method of FIG. 224 may be implemented using the circuits and devices of FIGS. 214-219 for example, or other suitable circuits or devices.

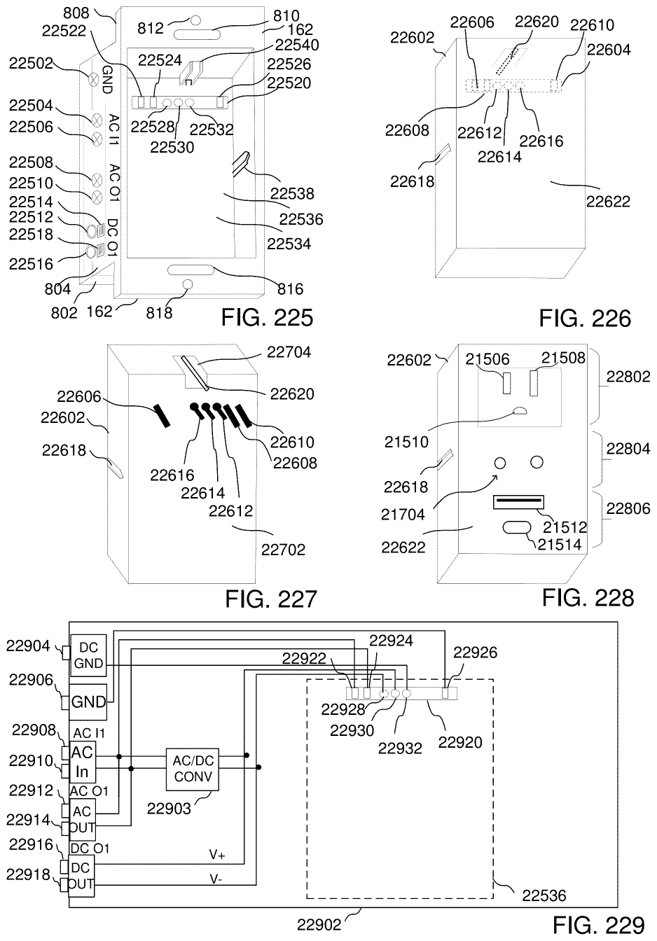

Turning now to FIG. 225, a perspective view of a base portion having an electrical interface for receiving contact elements for receiving AC signals and contact elements for receiving DC signals is shown. The base portion of FIG. 225 comprises an electrical connector 22502 adapter to receive a ground signal, an electrical connector 22504 and an electrical connector 22506 adapted to receive an AC input signal (e.g., line and neutral), and an electrical connector 22508 and an electrical connector 22510 to provide an AC output signal. The base portion may also comprise a DC output port comprising an electrical connector 22512 and a corresponding actuator element 22514 for retaining a wire and an electrical connector 22516 and a corresponding actuator element 22518 for retaining a wire. The DC output port may be used to route a DC reference voltage (e.g., +v, −v) to another device, such as another electrical wiring device for example.

The base portion may also comprise an electrical interface 22520 having openings leading to contact elements adapted to be coupled corresponding contact elements of a signal adapter as will be described in reference to FIG. 229. The electrical interface 22520 may comprise an opening 22522 associated with a contact element coupled to receive a line signal, an opening 22524 associated with a contact element coupled to receive a neutral signal, an opening 22526 associated with a contact element coupled to receive a ground signal, an opening 22528 associated with a contact element coupled to receive a first DC reference voltage signal, an opening 22530 associated with a contact element coupled to receive a second DC reference voltage signal, an opening 22532 associated with a contact element coupled to receive a ground signal, such as a DC ground signal. The base portion may also comprise an open region 22534 having a rear portion 22536 having the plurality of openings and alignment elements 22538.

Turning now to FIG. 226, a front perspective view of a signal adapter 22602 configured to be received by the base portion of FIG. 225 is shown. The base portion comprises an electrical interface 22604 comprising a plurality of contact elements including a contact element 22606, a contact element 22608, and a contact element 22610 adapted to receive one of a ground signal, a neutral signal, and a line voltage signal from the base portion. The electrical interface also includes a contact element 22612, a contact element 22614, and a contact element 22616. As will be described in more detail in reference to FIG. 229, the contact element 22612 is adapted to receive a −v signal, the contact element 22614 is adapted to receive a +v signal, and the contact element 22616 is adapted to receive a DC ground signal. The signal adapter also comprises an alignment element 22618 adapted to make with a corresponding alignment element 22538 and an actuator element 22620 adapted to engage a tamper resistant element as described above. A front surface 22622 may comprise one or more user interface elements or electrical interface elements.

Turning now to FIG. 227, a rear perspective view of a signal adapter configured to be received by the base portion of FIG. 225 is shown. The contact elements are shown extending from a rear surface 22702, where an open area 22704 provides an area for the actuator element 22620.

Turning now to FIG. 228, a front perspective view of another signal adapter configured to be received by the base portion of FIG. 225 is shown. According to the implementation of FIG. 228, a region 22802 comprises an AC receptacle, a region 22804 comprises a DC receptacle, and a region 22806 comprises low-voltage electrical connectors, shown here by way of example as a USB-A connector and a USB-C connector. While three regions are shown, it should be understood that a fewer or greater number regions could be implemented.

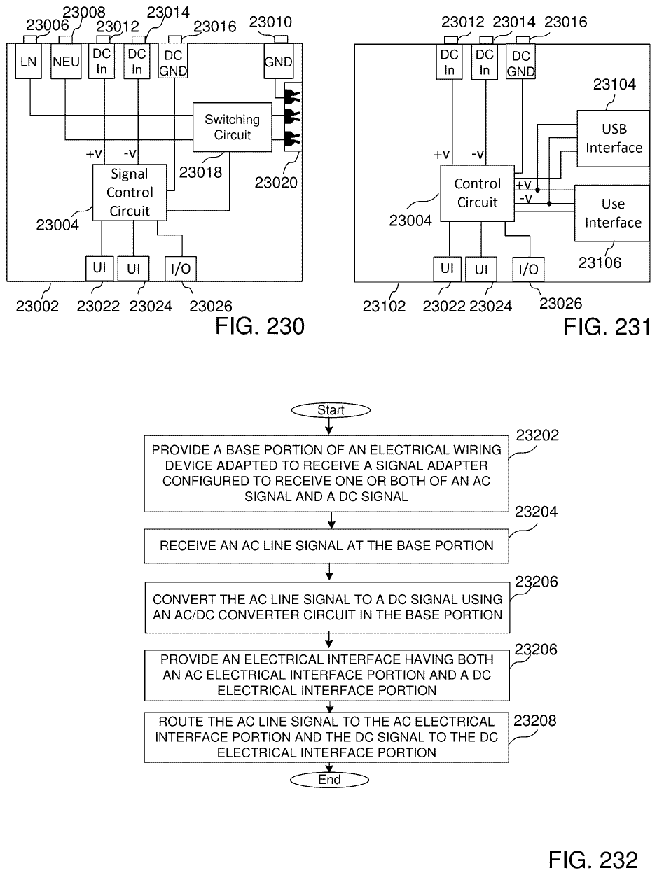

Turning now to FIG. 229, a block diagram of a circuit adapted to be implemented in the base portion of FIG. 225 is shown. The circuit 22902 comprises an AC/DC circuit adapted to receive an AC input signal and generate a DC reference signal (e.g., +v and −v) that may be routed to an electrical interface adapted to make an electrical connection with the signal adapter. The DC references signal may also be routed to a DC output, where the DC output signal can be routed to a base portion of another electrical wiring device. The circuit also comprises an electrical connector 22904 adapted to receive a DC ground signal, an electrical connector 22906 adapted to receive an AC ground signal, an electrical connector 22908 and an electrical connector 22910 adapted to receive an AC input signal comprising for example a line signal and a neutral signal, an electrical connector 22912 and an electrical connector 22914 adapted to adapted to output an AC signal comprising for example a line signal and a neutral signal, and an electrical connector 22916 and an electrical connector 22918 adapted to generate a DC signal (e.g., +v and −v). An electrical interface 22920 comprises a contact element 22922 adapted to receive the contact element 22606 of the signal adapter, a contact element 22924 adapted to receive the contact element 22608 of the signal adapter, a contact element 22926 adapted to receive the contact element 22610 of the signal adapter, a contact element 22928 adapted to receive the contact element 22612 of the signal adapter, a contact element 22930 adapted to receive the contact element 22614 of the signal adapter, a contact element 22932 adapted to receive the contact element 22616 of the signal adapter. Example block diagrams of signal adapters will be described in reference to FIGS. 230 and 231.

Turning first to FIG. 230, a block diagram of a circuit adapted to be implemented in a base portion, such as the base portion of FIG. 225 is shown. The circuit 23002 associated with a signal adapter comprises a signal control circuit 23004 electrically coupled to a plurality of contact elements, including a contact element 23006 adapted to receive the line voltage signal, a contact element 23008 adapted to receive the neutral voltage signal, a contact element 23010 adapted to receive the DC ground signal, a contact element 23012 adapted to receive the first DC signal, a contact element 23014 adapted to receive a first DC input signal, and a contact element 23016 adapted to receive the a second DC input signal. The circuit may also comprise a switching circuit 23018 coupled to electrical interface 23020 comprising contacts of an AC receptacle adapted to receive a plug. The circuit may also comprise one or more user interface (UI) elements or input/output (I/O) elements, shown by way of example as a user interface 23022, a user interface 223024, and a input/output 23026.

Turning now to FIG. 231, a block diagram of another circuit adapted to be implemented in a base portion, such as the base portion of FIG. 225 is shown. signal adapter 23102. user interface 23104. user interface 23106.

Turning now to FIG. 232, a flow chart shows a method of implementing an electrical wiring device having a base portion comprising an electrical interface for receiving contact elements for receiving AC signals and contact elements for receiving DC signal. A base portion of an electrical wiring device adapted to receive a signal adapter configured to receive one or both of an AC signal and a DC signal is provided at a block 23202. An AC line signal received at the base portion at a block 23204. The AC line signal is converted to a DC signal using an AC/DC converter circuit in the electrical wiring device at a block 23206. An electrical interface having both an AC electrical interface portion and a DC electrical interface portion is provided at a block 23208. The AC line signal is routed to the AC electrical interface portion and the DC signal is routed to the DC electrical interface portion at a block 23210. The method of FIG. 232 may be implemented using the devices and circuits described in FIGS. 225-231 for example, or some other suitable devices and circuits.

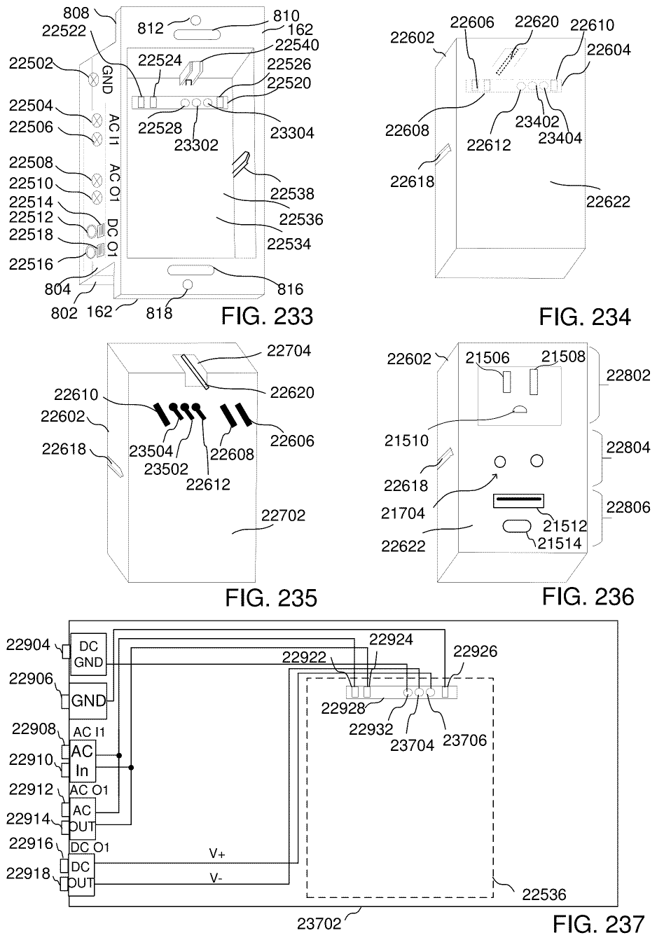

Turning now to FIG. 233, a perspective view of another electrical wiring device having a base portion comprising an electrical interface for receiving contact elements for receiving AC signals and contact elements for receiving DC signals. The implementation of FIG. 233 is similar to the implementation of FIG. 225. However, rather than generated DC reference signals in the base portion, the DC signal is generated within the signal adapter and may be routed to the base portion, such as by way of contact elements behind an opening 23302 and an opening 23304, and more particularly by way of contact element 23402 and 23404 of a signal adapter described in reference to the signal adapter of FIG. 234. A rear perspective view of a signal adapter configured to be received by the base portion of FIG. 233 is shown in FIG. 235. An example of a front surface of a signal adapter configured to be received by the base portion of FIG. 233 is shown in FIG. 236.

Turning now to FIG. 237, a block diagram of a circuit adapted to be implemented in the base portion of FIG. 233 is shown. The circuit comprises a contact element 23702 adapted to receive the DC ground signal by way of the electrical connector 22904, and generates a DC signal (e.g., −v) at a contact element 23704 and a DC signal (e.g., +v) a contact element 23706, where the DC signals generated in the signal adapter may be routed to the electrical connector 22916 and electrical connector 22918 as shown.

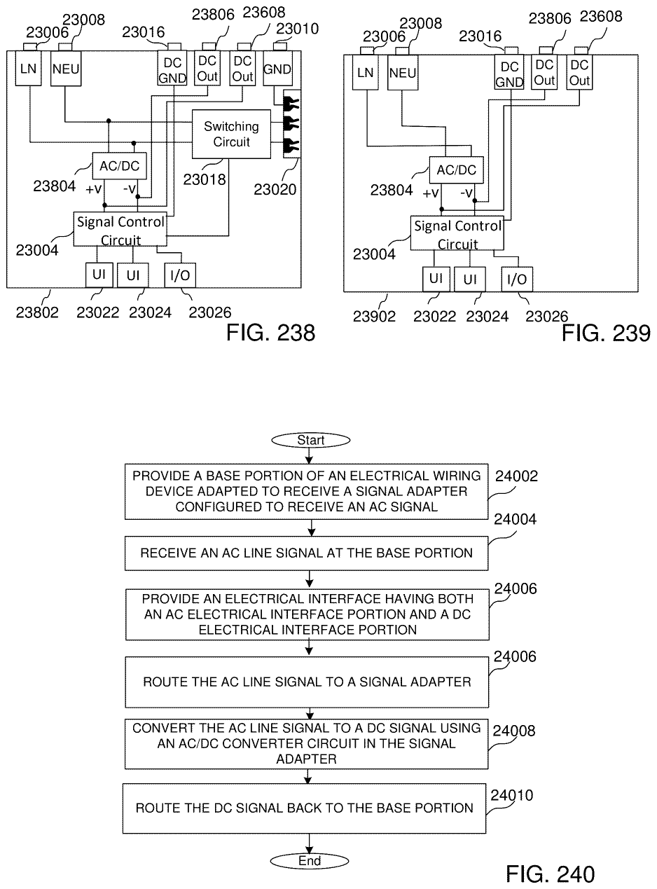

Turning now to FIG. 238, a block diagram of a circuit adapted to be implemented in a base portion, such as the base portion of FIG. 233 is shown. The circuit 23802 comprises an AC/DC converter circuit 23804 adapted to generate the DC signals that are routed to the contact element 23806 and contact element 23608 as shown. That is, the DC signals generated at the contact element 23806 and contact element 23608 are provided to the corresponding contact element 23704 and contact element 23705 of FIG. 237, where the DC signals can be routed to other electrical wiring devices by way of the electrical connector 22916 and electrical connector 22918.

Turning now to FIG. 239, a block diagram of another circuit adapted to be implemented in a base portion, such as the base portion of FIG. 233 is shown. More particularly, a signal adapter 23902 may be implemented without the electrical interface 23030 comprising contacts of an electrical receptacle.

Turning now to FIG. 240, a flow chart shows a method of implementing an electrical wiring device having a base portion comprising an electrical interface for receiving contact elements for receiving AC signals and contact elements for receiving DC signals. A base portion of an electrical wiring device adapted is provided to receive a signal adapter configured to receive an AC signal at a block 24002. An AC line signal is received at the base portion at a block 24004. An electrical interface having both an AC electrical interface portion and a DC electrical interface portion is provided at a block 24006. The AC line signal is routed to a signal adapter at a block 24008. The AC line signal is converted to a DC signal using an AC/DC converter circuit in the signal adapter at a block 24012. The DC signal is routed back to the base portion at a block 24012. The method of FIG. 240 may be implemented using the circuits of FIGS. 233-239, or some other suitable circuit.

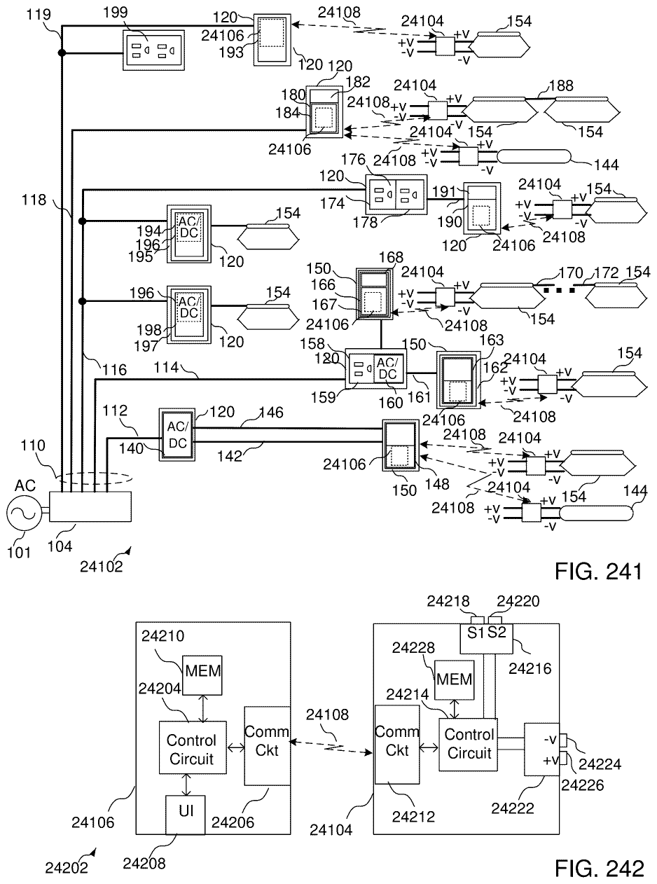

Turning now to FIG. 241, a block diagram of a system of implementing electrical wiring devices using one or both of both AC and DC currents is shown. That is, the system of FIG. 241 shows the use of wireless signals between a base portion or a signal adapter having a wireless communication circuit with a corresponding wireless communication circuit in a lighting element, such a bulb, light fixture, puck light or group of light fixtures or puck likes. According to some implementations, the wireless communication circuit may be in the lighting element itself or in a junction box associated with the lighting element. More particularly, the system 24102 of FIG. 241 comprises a communication device 24104 associated with a lighting device 154 and power control circuit comprising a wireless communication circuit adapted to establish a communication link 24108 between the wireless communication circuit of the base portion or signal adapter coupled to the base portion and the wireless communication circuit of the lighting element. According to some implementations, the base portion and/or signal adapter controls the application of power to the lighting element according to various lighting control functions, such as timing functions, motion detection functions, and diming functions for example.

Turning now to FIG. 242, a diagram showing a signaling arrangement 24202 that could be implemented in the system of FIG. 241 is shown. The signaling arrangement 24202 may comprise one or more communication device 24106 having a control circuit 24204 having a communication circuit 24206 coupled to a user interface 24208. The communication device 24106 may comprise a memory 24210 adapted to store code and other information for operating the control circuit. The signaling arrangement 24202 may also comprise a power control device 24204 having a communication circuit 24212 adapted to communication with the communication circuit 24206 of the communication device 24106. The power control device may also comprise a control circuit 24214 adapted to control the application of DC outputs signals by way of an electrical interface 24216 having a contact element 24218 and a contact element 24220 for receiving control signals, such as signals for controlling the application of power to a load, as shown. The power control device may also comprise electrical interface 24222 by way of an electrical interface 24216 having a contact element 24224 and a contact element 24226 as shown. The power control device may also comprise memory 24228 adapted to store code and other information for operating the power control device.

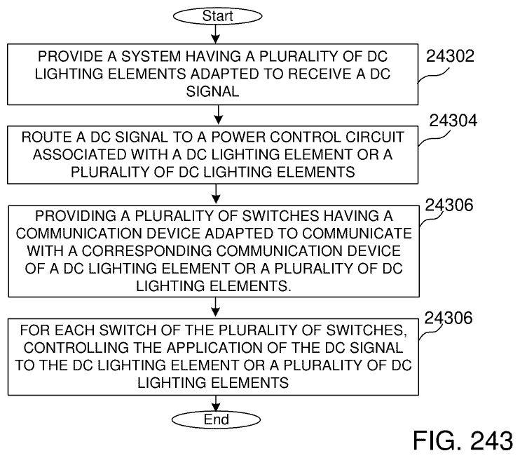

Turning now to FIG. 243, a flow chart shows a method of implementing a system having a plurality of DC lighting elements. A system having a plurality of DC lighting elements adapted to receive a DC signal is provided at a block 24302. A DC signal is routed to a power control circuit associated with a DC lighting element or a plurality of DC lighting elements at a block 24304. A plurality of switches having a communication device adapted to communicate with a corresponding communication device of a DC lighting element or a plurality of DC lighting elements is provided at a block 24306. The application of the DC signal to the DC lighting element or a plurality of DC lighting elements is controlled, for each switch of the plurality of switches, at a block 24308. The method of FIG. 234 may be implemented using the systems and signaling arrangements described in reference to FIGS. 240 and 241 for example, or other suitable systems and signaling arrangements.

What Applicant claims is:

1. An electrical wiring device adapted to receive an input power signal and generate an output power signal, the electrical wiring device comprising:
a base portion adapted to generate a DC signal for providing power to a load; and
a signal adapter removably attached to the base portion;
wherein the electrical wiring device is adapted to control the application of DC power to the load.

2. The electrical wiring device of claim 1, wherein the base portion comprises a switch for controlling the application of power to the load.

3. The electrical wiring device of claim 1, wherein the base portion comprises an outlet adapted to receive prongs of a plug.

4. The electrical wiring device of claim 1, wherein the signal adapter comprises a communication circuit adapted to receive a signal for controlling the application of power to a load.

5. The electrical wiring device of claim 1, wherein the signal adapter comprises a sensor.

6. The electrical wiring device of claim 1, wherein the signal adapter comprises an outlet.

7. The electrical wiring device of claim 1, wherein the base portion comprises an electrical interface for communication of DC signals between the base portion and the signal adapter.

8. An electrical wiring device adapted to receive an input power signal and generate an output power signal, the electrical wiring device comprising:
a base portion comprises an outlet for receiving prongs of a plug;
a signal adapter removably attached to the base portion; and
an electrical interface for communication of AC signals and DC signals between the base portion and the signal adapter.

9. The electrical wiring device of claim 8, wherein the electrical wiring device comprises an in-wall electrical wiring device.

10. The electrical wiring device of claim 8, wherein the signal adapter comprises an outlet adapted to receive prongs of a plug.

11. The electrical wiring device of claim 10, wherein the signal adapter having an outlet comprises a communication circuit adapted to receive control signals controlling the application of power applied to a device associated with the prongs of a plug.

12. The electrical wiring device of claim 8, wherein the signal adapter comprises a sensor.

13. The electrical wiring device of claim 8, wherein the signal adapter comprises a communication circuit adapted to receive a signal for controlling the application of power to a load.

14. A method of implementing an electrical wiring device adapted to receive an input power signal and generate an output power signal, the method comprising:
generating, by a base portion, a DC signal for providing power to a load;
receiving a signal adapter that is removably attached to the base portion; and
controlling the application of DC power to the load.

15. The method of claim 14, further comprising providing a switch associated with the base portion for controlling the application of power to the load.

16. The method of claim 14, further comprising providing an outlet adapted to receive prongs of a plug in the base portion.

17. The method of claim 14, further comprising proving a communication circuit adapted to receive a signal for controlling the application of power to a load in the signal adapter.

18. The method of claim 14, further comprising providing a sensor in the signal adapter.

19. The method of claim 14, further comprising providing an outlet in the signal adapter.

20. The method of claim 14, further comprising providing an electrical interface for communication DC signals between the base portion and the signal adapter.
